(19) United States
(12) Patent Application Publication
(10) Pub. No.: US 2025/0314498 A1
(43) Pub. Date: Oct. 9, 2025

(54) SYSTEMS AND METHODS FOR GROUP NAVIGATION

(71) Applicant: ON THE WAY LLC, Irving, TX (US)

(72) Inventors: Niraj Bhatia, Irving, TX (US); Jacob Pena, Irving, TX (US); Anita Srivastava, Irving, TX (US); Arjun Srivastava, Irving, TX (US)

(73) Assignee: ON THE WAY LLC, Irving, TX (US)

(21) Appl. No.: 19/171,153

(22) Filed: Apr. 4, 2025

Related U.S. Application Data
(60) Provisional application No. 63/575,511, filed on Apr. 5, 2024.

(51) Int. Cl. G01C 21/34; G06F 21/62

(52) U.S. Cl. CPC G01C 21/3438; G06F 21/6254

(57) ABSTRACT

A system for linking devices and protecting data during group navigation is presented. One method may include one or more steps including receiving a link up request; establishing one or more data channels with the inviter device; providing the link up request to a plurality of invitee devices; in response to receiving a first acceptance of the link up request from a first invitee device of the plurality of invitee devices, linking the inviter device and the first invitee device; collecting, via the one or more data channels, environmental data from one or more of the plurality of invitee devices; and executing an action based at least in part on the environmental data from the one or more of the plurality of invitee devices.

### CROSS-REFERENCE TO RELATED PATENT APPLICATIONS

This application claims the benefit of and the priority to U.S. Provisional Patent Application No. 63/575,511, filed Apr. 5, 2024, the entire disclosure of which is incorporated by reference herein for all purposes.

### BACKGROUND

In a computer networked environment such as the internet, entities such as people or companies access content for display in mobile applications. People and companies that provide the content may desire to curate the content for display in the mobile applications.

### SUMMARY

In some aspects, the techniques described herein relate to a computer-implemented method for playing media during a trip while using a navigation system, the computer-implemented method including: receiving, by one or more processors, route parameters and playback parameters, wherein: the route parameters include a location information of a navigation route and a method of travel for the navigation route; and the playback parameters include one or more media attribute preferences and one or more playback rate thresholds, the one or more playback rate thresholds corresponding to a media playback speed; predicting, by the one or more processors, a predicted travel duration for the navigation route based on one or more of the route parameters; accessing, by the one or more processors, one or more media sources; identifying, by the one or more processors, from the one or more media sources, a plurality of media having one or more media attributes matching the one or more media attribute preferences; generating, by the one or more processors, from the plurality of media, a list of media having a playback duration satisfying a trip listen duration, wherein the trip listen duration correlates to the predicted travel duration; presenting, by the one or more processors, for display, the list of media; receiving, by the one or more processors, a selection of a media from the list of media; and in response to receiving the selection of the media from the list of media, activating, by the one or more processors, an audio source of a user device or an external device to output the media from the list of media.

In some aspects, the techniques described herein relate to a computer-implemented method, wherein the predicted travel duration is further based on real-time route information including at least one of traffic data, construction data, and toll data.

In some aspects, the techniques described herein relate to a computer-implemented method, wherein the one or more processors are located on the user device, on a remote server, or distributed across multiple devices.

In some aspects, the techniques described herein relate to a computer-implemented method, wherein the one or more playback rate thresholds correspond to a playback speed multiplier, wherein the playback speed multiplier is a multiplier to increase or decrease a playback speed of media, and wherein the location information includes at least one of an initiation location, a destination location, and an interim location.

In some aspects, the techniques described herein relate to a computer-implemented method, wherein the playback duration for one or more of the media of the list of media is one of a range or set time and determined by decreasing a non-adjusted playback duration of the media by increasing a playback rate for one or more of the media in the list of media to one of the one or more playback rate thresholds, wherein the non-adjusted playback duration corresponds to the playback duration of the media at a non-adjusted playback rate.

In some aspects, the techniques described herein relate to a computer-implemented method, further including: adjusting, by the one or more processors, the playback rate from the non-adjusted playback rate of the media of the list of media to an adjusted playback rate, wherein the adjusted playback rate is equal to or less than a playback rate threshold of the media and causes a corresponding playback duration of the media of the list of media to be equal to or less than the trip listen duration.

In some aspects, the techniques described herein relate to a computer-implemented method, further including: updating, by the one or more processors, the predicted travel duration during travel from an initiation location to a destination location; and adjusting, by the one or more processors, a playback rate of the media of the list of media to an adjusted playback rate based, at least in part, on the updated predicted travel duration, wherein the adjusted playback rate is less than a playback rate threshold of the media.

In some aspects, the techniques described herein relate to a computer-implemented method, further including: receiving, by the one or more processors, a request to change the media based on an updated predicted travel duration, wherein the predicted travel duration is periodically updated during travel from the initiation location to the destination location.

In some aspects, the techniques described herein relate to a computer-implemented method, further including: receiving, by the one or more processors, a plurality of playback durations based on at least one of a plurality of route parameters and a plurality of playback parameters, the plurality of route parameters and the plurality of playback parameters associated with a plurality of user devices; generating, by the one or more processors, from the plurality of media, the list of media with an associated playback duration within a second playback range, wherein the second playback range correlates to the trip listen duration and the associated playback duration is a second playback duration of media at a playback rate threshold; and generating, by the one or more processors, instructions to display on the user device the list of media.

In some aspects, the techniques described herein relate to a computer-implemented method, further including; transmitting, by the one or more processors, the instructions to display on the user device the list of media to at least one user device associated with at least one user of the plurality of user devices.

In some aspects, the techniques described herein relate to a computer-implemented method, further including: in response to at least receiving the selection of the media from the list of media, activating, transmitting, by the one or more processors to one of more of the plurality of user devices, instructions to output the media.

In some aspects, the techniques described herein relate to a computer-implemented method, wherein the one or more media attribute preferences are associated with one or more of a media history of a user, an initiation location, a destination location, an interim destination, or a user input received by the one or more processors.

In some aspects, the techniques described herein relate to a computer-implemented method, wherein the initiation location is a current location of a user or a user-selected location.

In some aspects, the techniques described herein relate to a computer-implemented method, wherein the playback duration is associated with a predetermined segment of media including one or more predetermined segments or portions.

In some aspects, the techniques described herein relate to a computer-implemented method, wherein the media is at least one of a podcast, a song, a music video, a movie, an audiobook, a spoken word file, a text-to-speech transcription, a voice recording, a voicemail, a lecture, a training video, a seminar, a presentation, a news broadcast, a sports commentary, a sporting event, a talk show, a predicted phone call, a live performance, or a radio broadcast.

In some aspects, the techniques described herein relate to a computer-implemented method for playing directed media during a trip while using a navigation system, the computer-implemented method including: receiving, by one or more processors, route parameters and playback parameters, wherein: the route parameters include a location information of a navigation route and a method of travel for the navigation route; and the playback parameters include one or more media attribute preferences and one or more playback rate thresholds, the one or more playback rate thresholds corresponding to a media playback speed; predicting, by the one or more processors, a predicted travel duration for the navigation route based on one or more of the route parameters; accessing, by the one or more processors, one or more media sources; identifying, by the one or more processors, from the one or more media sources, a plurality of media having one or more media attributes matching the one or more media attribute preferences; generating, by the one or more processors, from the plurality of media, a list of media having a playback duration satisfying a trip listen duration, wherein the trip listen duration correlates to the predicted travel duration; presenting, by the one or more processors, for display, the list of media; receiving, by the one or more processors, a selection of a media from the list of media; in response to receiving the selection of the media from the list of media, activating, by the one or more processors, an audio source of a user device or an external device to output the media from the list of media; receiving, by the one or more processors, the directed media, wherein the directed media is associated with a location within a range of the navigation route; and in response to receiving the directed media, activating, by the one or more processors, the audio source of the user device or the external device to output the directed media.

In some aspects, the techniques described herein relate to a computer-implemented method, wherein the range is one or more of a time or distance.

In some aspects, the techniques described herein relate to a computer-implemented method, wherein the location information includes at least one of an initiation location, a destination location, and an interim location.

In some aspects, the techniques described herein relate to a computer-implemented method, wherein the directed media is a content related to one or more of the initiation location, the destination location, the interim location, a first event occurring at the destination location of the navigation route, and a second event occurring at the location along the navigation route.

In some aspects, the techniques described herein relate to a computer-implemented method for playing media during a trip while using a navigation system with group navigation, the computer-implemented method including: receiving, by one or more processors, route parameters and playback parameters of a plurality of users, wherein: the route parameters include a location information of a navigation route and a method of travel for the navigation route; and the playback parameters include one or more media attribute preferences and one or more playback rate thresholds, the one or more playback rate thresholds corresponding to a media playback speed; predicting, by the one or more processors, a predicted travel duration for the navigation route of at least one user of the plurality of users based on one or more of the route parameters of the at least one user; accessing, by the one or more processors, one or more media sources; identifying, by the one or more processors, from the one or more media sources, a plurality of media having one or more media attributes matching the one or more media attribute preferences; generating, by the one or more processors, from the plurality of media, a list of media having a playback duration satisfying a trip listen duration, wherein the trip listen duration correlates to the predicted travel duration; presenting, by the one or more processors, for display, the list of media; receiving, by the one or more processors, a selection of a media from the list of media; and in response to receiving the selection of the media from the list of media, transmitting, by the one or more processors, the media to one or more of the plurality of users.

In some aspects, the techniques described herein relate to a computer-implemented method for linking devices and protecting data during group navigation, the computer-implemented method including: receiving, by one or more processors from an inviter device, a link up request associated with a link up location; establishing, by the one or more processors, one or more data channels with the inviter device; providing, by the one or more processors, the link up request to a plurality of invitee devices, the link up request including the link up location; in response to receiving a first acceptance of the link up request from a first invitee device of the plurality of invitee devices, linking, by the one or more processors, the inviter device and the first invitee device; in response to receiving a second acceptance of the link up request from a second invitee device of the plurality of invitee devices, linking, by the one or more processors, the inviter device and the second invitee device; collecting, by the one or more processors via the one or more data channels, environmental data from one or more of the plurality of invitee devices; and executing, by the one or more processors, an action based at least in part on the environmental data from the one or more of the plurality of invitee devices.

In some aspects, the techniques described herein relate to a computer-implemented method for linking devices and protecting data during group navigation, further including: receiving, by the one or more processors from the inviter device, a privacy request to anonymize invitee data of at least one of the first invitee device or the second invitee device such that personally identifiable information of the first invitee device or the second invitee device are anonymized.

In some aspects, the techniques described herein relate to a computer-implemented method for linking devices and protecting data during group navigation, further including: receiving, by the one or more processors, a first location of the first invitee device and a second location of the second invitee device; and presenting, by the one or more processors, for display on the inviter device as a graphical user interface, at least one of the first location of the first invitee device, the second location of the second invitee device, a historical location trend of one or more of the plurality of invitee devices, or a predicted location of one or more of the plurality of invitee devices.

In some aspects, the techniques described herein relate to a computer-implemented method for linking devices and protecting data during group navigation, further including: receiving, by the one or more processors, an indication of an event within a threshold range of the first invitee device and the second invitee device; and transmitting, by the one or more processors, a recommendation associated with the event to one or more of the first invitee device or the second invitee device.

In some aspects, the techniques described herein relate to a computer-implemented method for linking devices and protecting data during group navigation, further including: in response at least to the second invitee device being associated with the first invitee device, presenting, by the one or more processors, for display on the first invitee device, a location of the second invitee device based at least on the environmental data.

In some aspects, the techniques described herein relate to a computer-implemented method for linking devices and protecting data during group navigation method, wherein the action includes: transmitting, by the one or more processors to the first invitee device and the second invitee device, instructions to display on a user device, an emergency evacuation route based at least in part on the environmental data.

In some aspects, the techniques described herein relate to a computer-implemented method for linking devices and protecting data during group navigation method, further including: providing, by the one or more processors, the link up request to the first invitee device based at least in part on a first location of the first invitee device satisfying a geographical threshold.

In some aspects, the techniques described herein relate to a computer-implemented method for linking devices and protecting data during group navigation method, wherein the action includes: based at least in part on the environmental data, transmitting, by the one or more processors, an electronic message to the first invitee device, wherein the electronic message includes content configured to facilitate an adjustment of a navigation flow of the plurality of invitee devices within a geographical range.

In some aspects, the techniques described herein relate to a computer-implemented method for linking devices and protecting data during group navigation method, wherein the content includes one or more of an offer, a notification, or a navigational route.

In some aspects, the techniques described herein relate to a computer-implemented method for linking devices and protecting data during group navigation, the computer-implemented method including: receiving, by one or more processors from an inviter device, a link up request associated with a link up location; establishing, by the one or more processors, one or more data channels with the inviter device; providing, by the one or more processors via one or more data channels, the link up request to a plurality of invitee devices, the link up request including the link up location; in response to receiving a first acceptance of the link up request from a first invitee device of the plurality of invitee devices, linking, by the one or more processors, the inviter device and the first invitee device; generating and presenting, by the one or more processors to the first invitee device via a first graphical user interface (GUI) of an application, a first proposed route to the link up location, wherein the first proposed route is based on a first geographic location of the first invitee device; in response to receiving a second acceptance of the link up request from a second invitee device of the plurality of invitee devices, linking, by the one or more processors, the inviter device and the second invitee device; generating and presenting, by the one or more processors to the second invitee device via a second GUI of the application, a second proposed route to the link up location, wherein the second proposed route is based on a second geographic location of the second invitee device; collecting, by the one or more processors, environmental data of the plurality of invitee devices; and executing, by the one or more processors, an action based at least in part on the environmental data from the plurality of invitee devices.

In some aspects, the techniques described herein relate to a computer-implemented method for linking devices and protecting data during group navigation, further including: providing, by the one or more processors, a first location of the first invitee device and a second location of the second invitee device to the inviter device based on the environmental data via a third GUI of the application.

In some aspects, the techniques described herein relate to a computer-implemented method for linking devices and protecting data during group navigation, further including: receiving, by the one or more processors from the inviter device, a privacy request to anonymize invitee data of the first invitee device or the second invitee device such that personally identifiable information of the first invitee device or the second invitee device are anonymized.

In some aspects, the techniques described herein relate to a computer-implemented method for linking devices and protecting data during group navigation, further including: transmitting, by the one or more processors to one or more of the first invitee device or the second invitee device, an electronic message associated with a geographical location within a range of the first proposed route or the second proposed route, based at least in part on the environmental data.

In some aspects, the techniques described herein relate to a computer-implemented method for linking devices and protecting data during group navigation, wherein the electronic message includes directed content sponsored by an entity, wherein the entity is associated with the inviter device.

In some aspects, the techniques described herein relate to a computer-implemented method for linking devices and protecting data during group navigation, further including: receiving, by the one or more processors, navigation data associated with one or more of the first proposed route or the second proposed route, wherein the navigation data includes at least traffic data; updating, by the one or more processors, one or more of the first proposed route or the second proposed route based at least in part on the navigation data; transmitting, by the one or more processors, the updated first proposed route to the first invitee device or the updated second proposed route to the second invitee device; predicting, by the one or more processors, an estimated arrival time to the link up location of one or more of the first invitee device or the second invitee device based at least in part on the updated first proposed route or the updated second proposed route; and generating, by the one or more processors, a recommendation receivable by the inviter device to delay an event associated with the link up location based at least in part on the estimated arrival time to the link up location of the one or more of the first invitee device or the second invitee device.

In some aspects, the techniques described herein relate to a computer-implemented method for linking devices and protecting data during group navigation, the computer-implemented method including: receiving, by one or more processors from an organizer device, a link up request associated with a link up location; establishing, by the one or more processors, one or more data channels with the organizer device; providing, by the one or more processors, the link up request to each of a plurality of invitee devices, the link up request including the link up location; in response to receiving a first acceptance of the link up request from a first invitee device of the plurality of invitee devices, linking, by the one or more processors, the organizer device and the first invitee device; generating and presenting, by the one or more processors to the first invitee device via a first graphical user interface (GUI) of an application, a first proposed route to the link up location, wherein the first proposed route is based on a first geographic location of the first invitee device; in response to receiving a second acceptance of the link up request from a second invitee device of the plurality of invitee devices, linking, by the one or more processors, the organizer device and the second invitee device; generating and presenting, by the one or more processors to the second invitee device via a second GUI of the application, a second proposed route to the link up location, wherein the second proposed route is based on a second geographic location of the second invitee device; collecting, by the one or more processors, environmental data of one or more of the organizer device and one or more of the plurality of invitee devices; and executing, by the one or more processors, an action based at least in part on the environmental data of the one or more of the organizer device and one or more of the plurality of invitee devices.

In some aspects, the techniques described herein relate to a computer-implemented method for linking devices and protecting data during group navigation, further including: predicting, by the one or more processors, an estimated arrival time to the link up location of one or more of the organizer device, the first invitee device, or the second invitee device based at least in part on the environmental data; transmitting, by the one or more processors, to at least one of the organizer device, the first invitee device, or the second invitee device, the estimated arrival time; and in response to at least the estimated arrival time satisfying a threshold, automatically updating, by the one or more processors, a reservation based at least on the estimated arrival time.

In some aspects, the techniques described herein relate to a computer-implemented method for linking devices and protecting data during group navigation, further including: receiving, by the one or more processors, historical environmental data of the plurality of invitee devices; generating, by the one or more processors, a recommendation for the plurality of invitee devices based at least in part on the historical environmental data and the link up location; and transmitting, by the one or more processors, the recommendation to at least one of the organizer device or one or more of the plurality of invitee devices.

In some aspects, the techniques described herein relate to a computer-implemented method for linking devices and protecting data during group navigation, further including: receiving, by the one or more processors from the at least one of the plurality of invitee devices, an acceptance of the recommendation; updating, by the one or more processors, at least one of the first proposed route or the second proposed route to include navigation to a location associated with the recommendation; and transmitting, by the one or more processors, the updated first proposed route to the first invitee device or the updated second proposed route to the second invitee device.

In some aspects, the techniques described herein relate to a computer-implemented method for linking devices and protecting data during group navigation, further including: predicting, by the one or more processors, the first proposed route at a link up time based at least in part on historical traffic conditions, wherein the link up request is scheduled for the link up time

### BRIEF DESCRIPTION OF THE DRAWINGS

FIG. 1 is a block diagram depicting an implementation of a system for linking devices and protecting data, according to some embodiments.

FIG. 2 is a flowchart for a computer-implemented method for linking devices and protecting data, according to some embodiments.

FIG. 3 is a flowchart for a computer-implemented method for linking devices and protecting data, according to some embodiments.

FIGS. 4A-4K are example illustrations of a graphical user interface, according to some embodiments.

FIGS. 5A-5C are example illustrations of a graphical user interface, according to some embodiments.

FIG. 6 is an example illustration of protecting data associated with link ups, according to some embodiments.

FIGS. 7A-7B are example illustrations of a graphical user interface, according to some embodiments.

FIG. 8 is a flowchart for a computer-implemented method for recommending and playing media based on a predicted travel duration, according to some embodiments.

FIGS. 9A-9B are example illustrations of graphical user interfaces, according to some embodiments.

FIG. 10 is an example illustration of a graphical user interface, according to some embodiments.

FIGS. 11A-11B are example illustrations of a graphical user interface, according to some embodiments.

FIG. 12 is an example illustration of a graphical user interface, according to some embodiments.

FIGS. 13A-13B are example timelines of audio playback in relation to a trip listen duration, according to some embodiments.

FIG. 14 is a flowchart for a computer-implemented method for linking devices and protecting data during group navigation, according to some embodiments.

FIG. 15 is a block diagram illustrating an example computing system suitable for use in the various arrangements described herein, according to some embodiments.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

The present disclosure is directed to systems and methods for protecting data and linking devices. Protecting data and linking devices provide improvements in privacy of consumer data specific to an individual while the graphical user interface (GUI), including performing a link up request, provide additional improvement to mapping systems that can link devices while protecting data. This approach allows data/mapping systems and architectures to maintain the privacy of consumer data while providing linking capabilities between multiple devices such that overall design of the data/mapping systems and architectures are improved. Thus, aspects of the present disclosure address problems in data protection by designing and providing a linking system that may obfuscate or withhold consumer data while allowing multiple consumer to link up.

Additionally, various aspects of the methods and systems described herein are directed to recommending and playing media, including audio and/or audiovisual media at adjusted playback rates based on predicted travel durations along a navigation route. Adjusting playback rates of audiovisual media provides improved methods of consuming media during travel by increasing the completion rate of audiovisual media in a single traveling block, thus increasing enjoyment, retention, understanding, and value (e.g., monetary) of the reproduced audiovisual media. Additionally, aspects of the present disclosure provide various technical improvements to audiovisual playback technology and media sharing technology. Traditional approaches to audiovisual media playback involve reproducing the content at a single, default playback rate (e.g., speed), leading to uncompleted consumption of media during travel when the duration of the media exceeds the duration of travel. Aspects of the present disclosure allow for automatic adjustment of playback rates of outputted audiovisual media based on dynamic navigation conditions such that media may be completely consumed during travel, even when a default playback duration of the media exceeds the travel duration or a trip listen duration. Additional aspects of the present disclosure provide users with targeted media recommendations based on predicted travel durations. Additionally, the present disclosure allows for improved sharing of audiovisual content to parties within a group by disclosing methods and systems that can provide multiple users within a group with a single audiovisual media to consume during travel to a common destination while ensuring that each of the users is able to completely consume the audiovisual media during their respective navigations to the common destination.

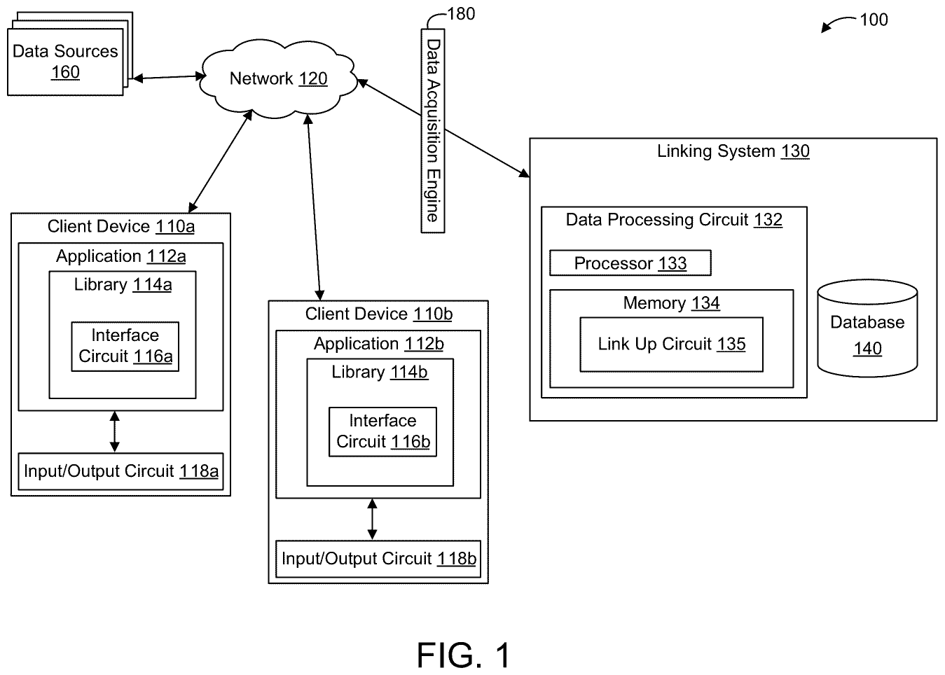

Referring now to FIG. 1, a block diagram depicting an implementation of a system 100 for linking devices and protecting data, according to some embodiments. System 100 includes client devices 110a and 110b (collectively referred to herein as “client device 110”), linking system 130, data sources 160, and data acquisition engine 180. In various implementations, components of system 100 communicate over network 120. Network 120 may include computer networks such as the Internet, local, wide, metro or other area networks, intranets, satellite networks, other computer networks such as voice or data mobile phone communication networks, combinations thereof, or any other type of electronic communications network. In various implementations, network 120 facilitates secure communication between components of system 100. As a non-limiting example, network 120 may implement transport layer security (TLS), secure sockets layer (SSL), hypertext transfer protocol secure (HTTPS), and/or any other secure communication protocol.

In general, the client devices 110 can execute a software application (such as application 112, e.g., a web browser, an installed application, or other application) to retrieve content from other computing systems and devices over network 120. Such an application may be configured to retrieve interfaces from the linking system 130 (e.g., navigation interface for navigating to a link up). In one implementation, the client device 110 may execute a web browser application, which provides the interface (e.g., from link up circuit 135) on a viewport of the client device 110. The web browser application that provides the interface may operate by receiving input of a uniform resource locator (URL), such as a web address, from an input device (such as input/output circuit 118, e.g., a pointing device, a keyboard, a touch screen, or another form of input device). In response, one or more processors of the client device 110 executing the instructions from the web browser application may request data from another device connected to the network 120 referred to by the URL address (e.g., the linking system 130). The other device may then provide webpage data and/or other data to the client device 110, which causes the interface to be presented by the viewport of the client device 110. Accordingly, the browser window presents the interface to facilitate user interaction with the interface.

In another implementation, the client device 110 may execute a mobile application, which provides the interface (e.g., from link up circuit 135) on a viewport of the client device 110. The mobile application that provides the interface may operate by receiving input selecting the mobile application (e.g., to open the application) on the viewport of the client device, from an input device (such as input/output circuit 118). In response, one or more processors of the client device 110 executing the instructions from the mobile application may request data from another device connected to the network 120 referred to by the URL address (e.g., the linking system 130). The other device may then provide application data and/or other data to the client device 110, which causes the interface to be presented by the viewport of the client device 110. Accordingly, the mobile application presents the interface to facilitate user interaction with the interface.

Client device 110 (sometimes referred to herein as a “mobile device”) may be any computing device such as, for example, a mobile computing device, smartphone, tablet, smart watch, smart sensor, or any other device configured to facilitate receiving, displaying, and interacting with content (e.g., web pages, mobile applications, etc.). Client device 110 may include an application 112 (shown as application 112a and 112b) to receive and display content and to receive user interaction with the content. For example, application 112 may be a web browser. Additionally, or alternatively, application 112 may be a mobile application associated with a specific entity. Client device 110 may also include an input/output circuit 118 for communicating data over network 120 (e.g., receive and transmit to linking system 130).

In various implementations, application 112 interacts with a linking system 130 to receive and provide environmental data (sometimes referred to as “activity data”), application content, network content, and online content. For example, application 112 may receive an information resource from the linking system 130. The information resources may include web-based content (e.g., web page) or application-based content (e.g., application installed on the client device 110). The information resources may include instructions (e.g., scripts, executable code, etc.) that when interpreted by application 112 cause application 112 to display a graphical user interface (GUI) such as an interactable web page and/or an interactive mobile application to a user. In various implementations, application 112 can include one or more application interfaces for presenting an application (e.g., mobile application, web-based application, virtual reality/augmented reality application, smart TV application and so on).

Application 112 is shown to include library 114 (shown as library 114a and 114b) having an interface circuit 116 (shown as interface circuit 116a and 116b). The library 114 may include a collection of interfacing tools contained in a package (e.g., application programming interface (API), web service, debugger, passthrough network interface, etc.). For example, library 114 may include an application programming interface (API) or a plurality of APIs. In another example, library 114 may include a web service. In yet another example, the library 114 may be an interfacing kit that includes an API, a debugger, and web services, and so on. In some implementations, library 114 includes one or more libraries having reusable functions that interface with a particular system software (e.g., iOS, Android, Linux, etc.). Library 114 may facilitate embedding functionality in application 112. For example, a link up participant may use library 114 to automatically transmit real-time location information (or near real-time location information, or last location information) of the client device 110 whenever a link up is in progress using the application 112. As a further example, library 114 may include a function configured to collect and report device analytics and a user may insert the function into the instructions of application 112 to cause the function to be called during specific actions of application 112 (e.g., during a link up as described in detail below). In some implementations, interface circuit 116 functionalities are provided by library 114.

Interface circuit 116 can be configured to provide one or more interfaces. In various implementations, the interfaces can be presented on an application interface of application 112 presented in the viewport of client device 110. The interfaces (e.g., user interfaces including graphical user interfaces (GUIs), head-up displays (HUDs), textual user interface (TUI), etc.) provided by the interface circuit 116 can include various functionality, such as enabling a user to create link up requests, accept link up requests, monitoring participates (invitee and inviter) of a link up request, access link up marketplaces, configure stops and incentives for the link up, communicate with others on a link up, configure settings (e.g., profile and privacy), etc. The interface circuit 116 can further generate navigation interfaces of real-time data (or delayed data from near real-time or periodic data receival) associated with location of the client device 110 and other devices, current geographic location, a proposed route or current route (e.g., proposed route that was accepted), one or more stops on the current route, any changes to the link up.

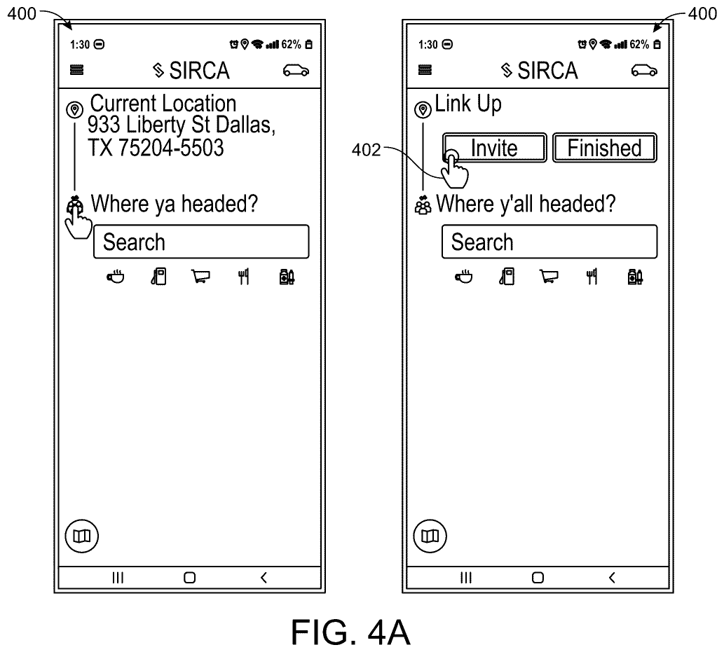

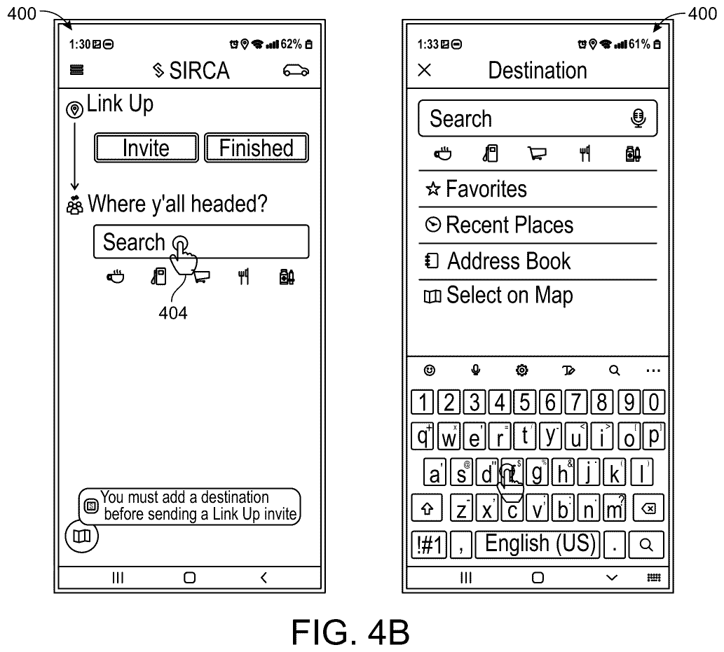

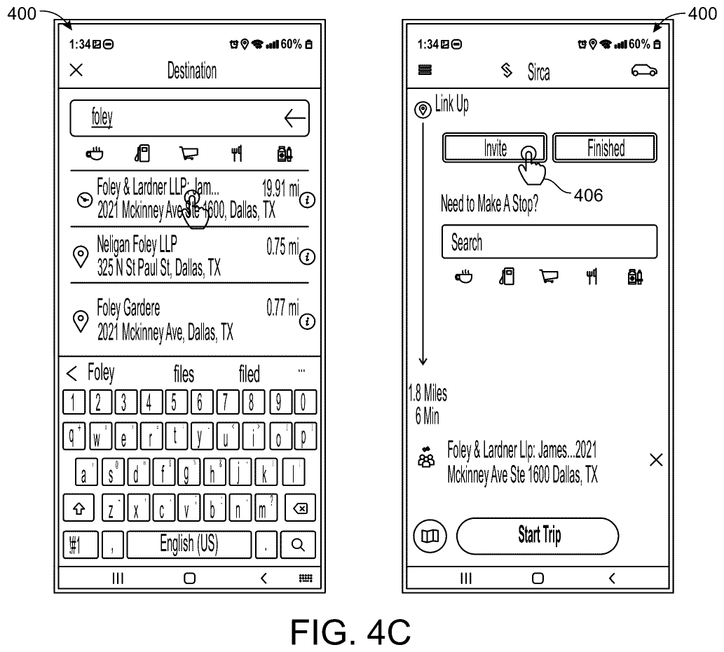

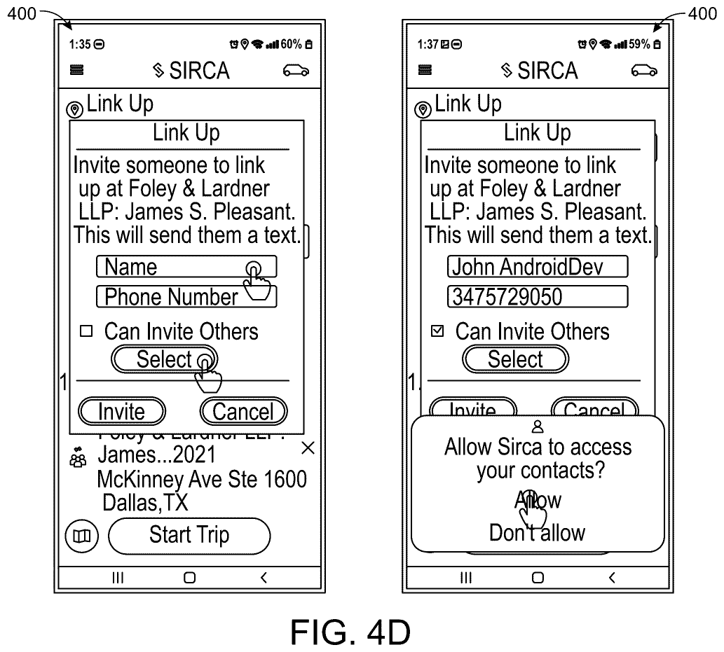

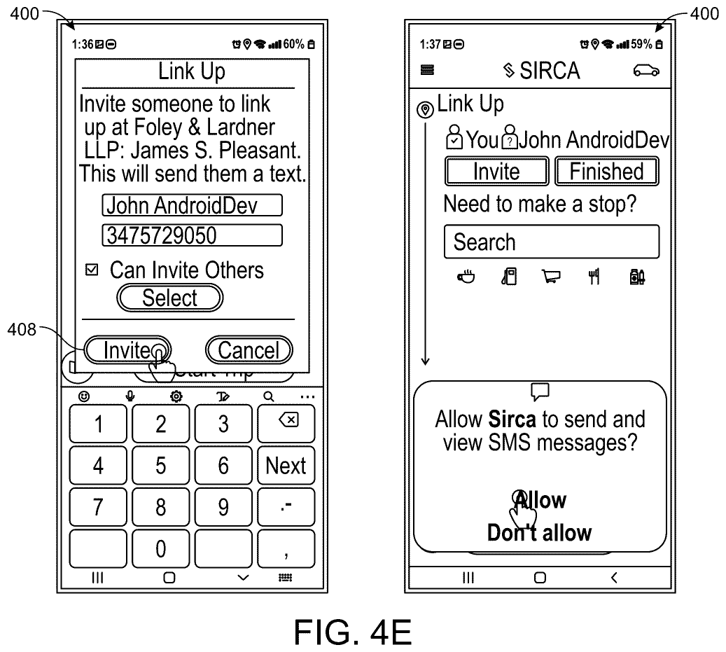

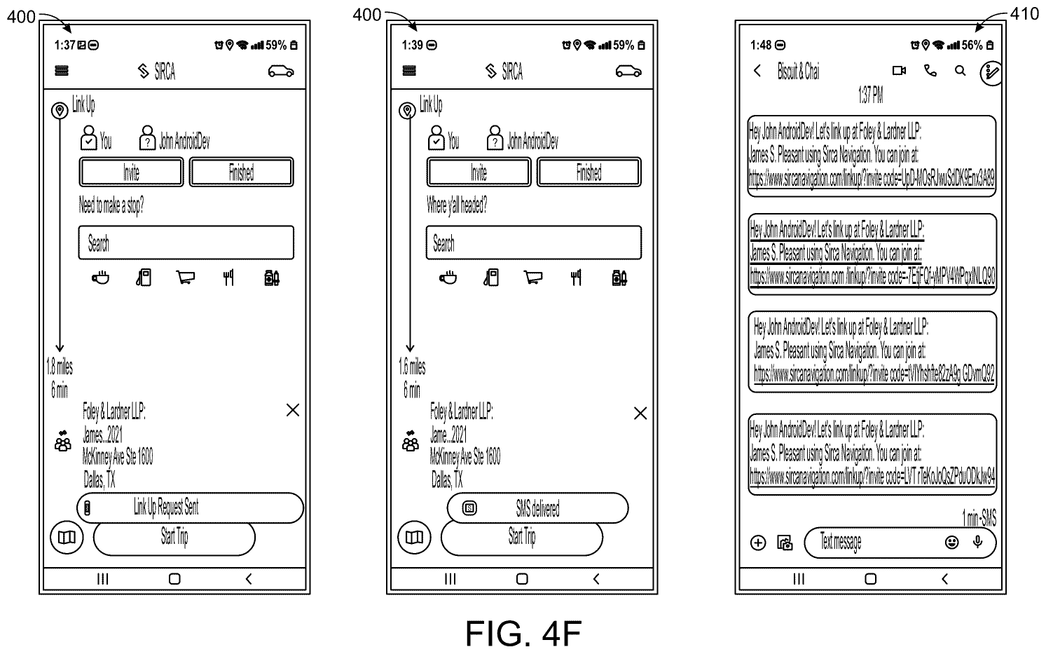

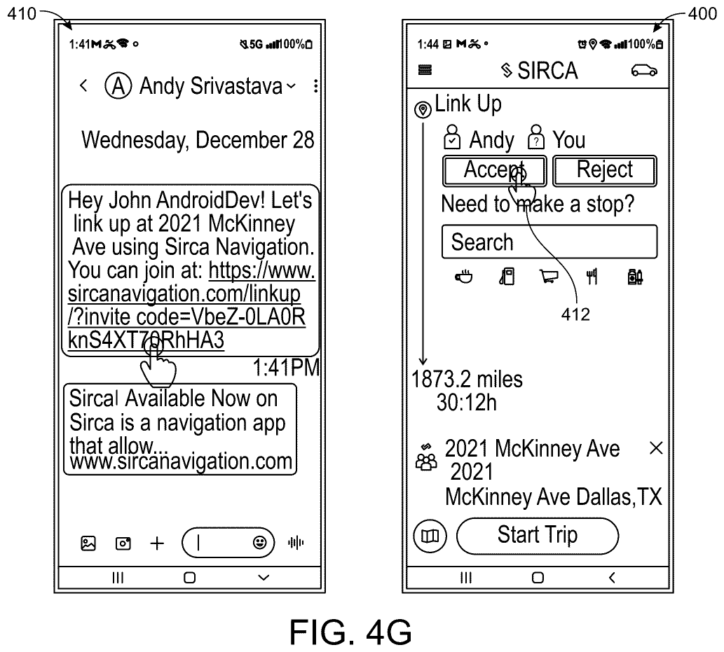

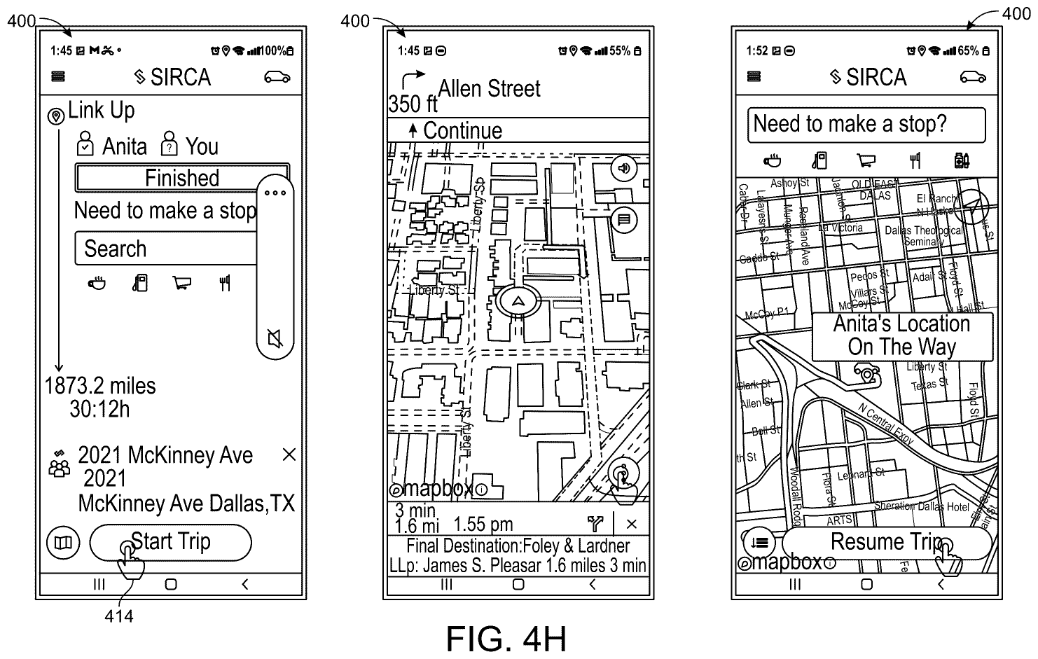

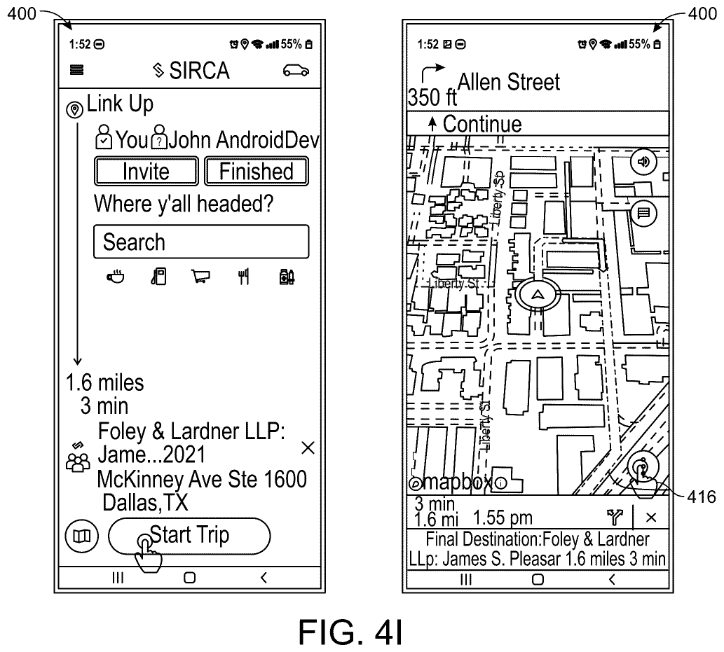

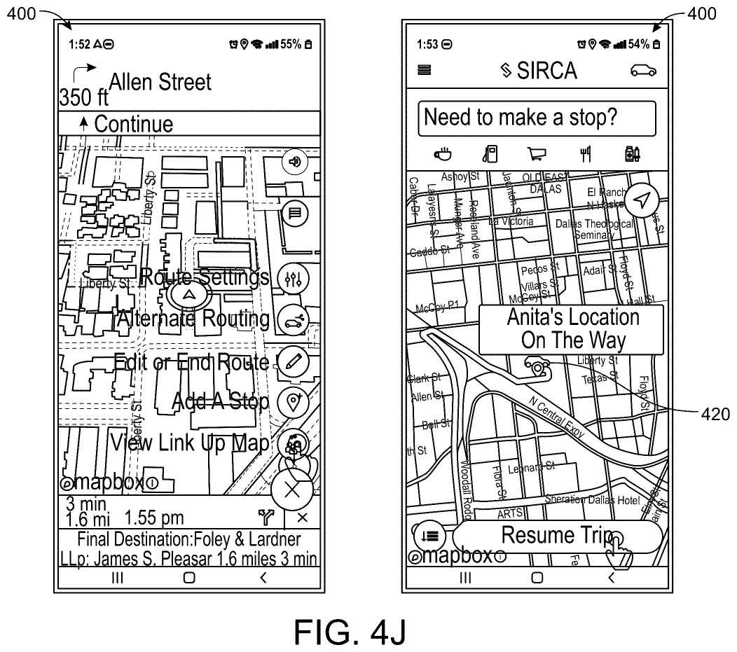

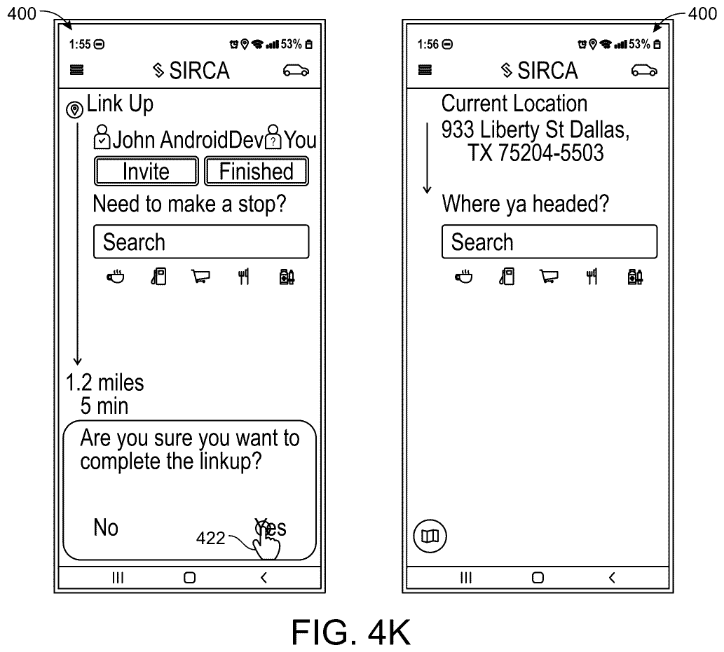

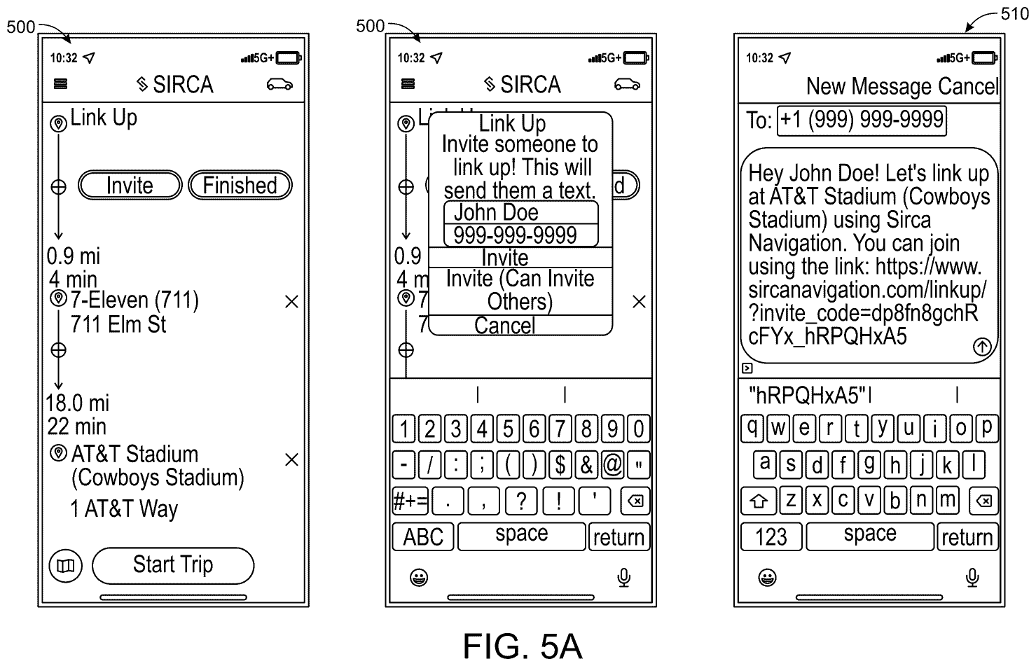

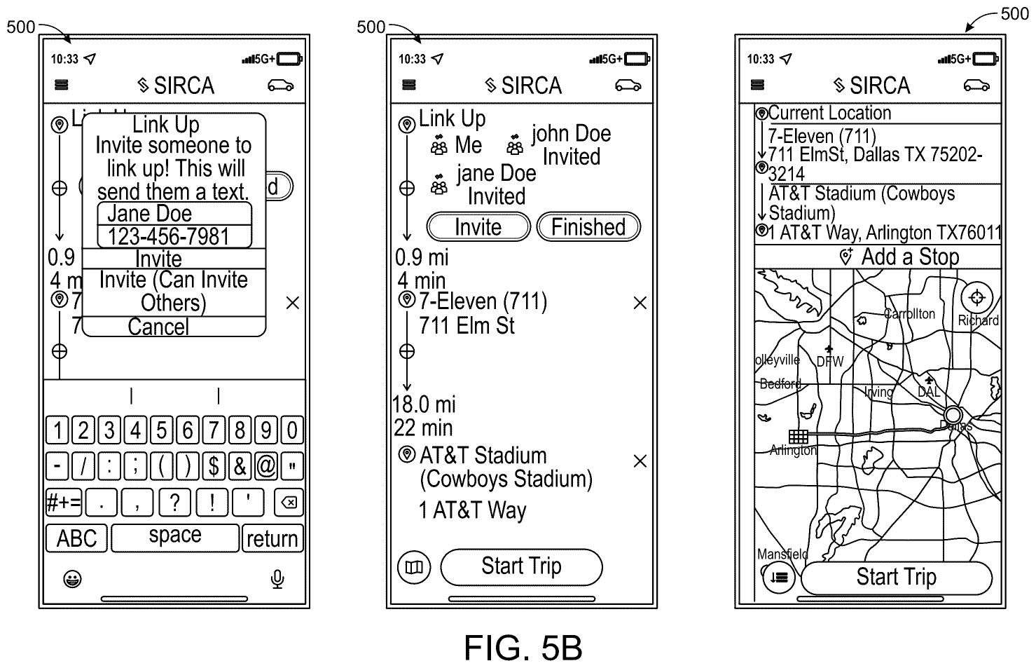

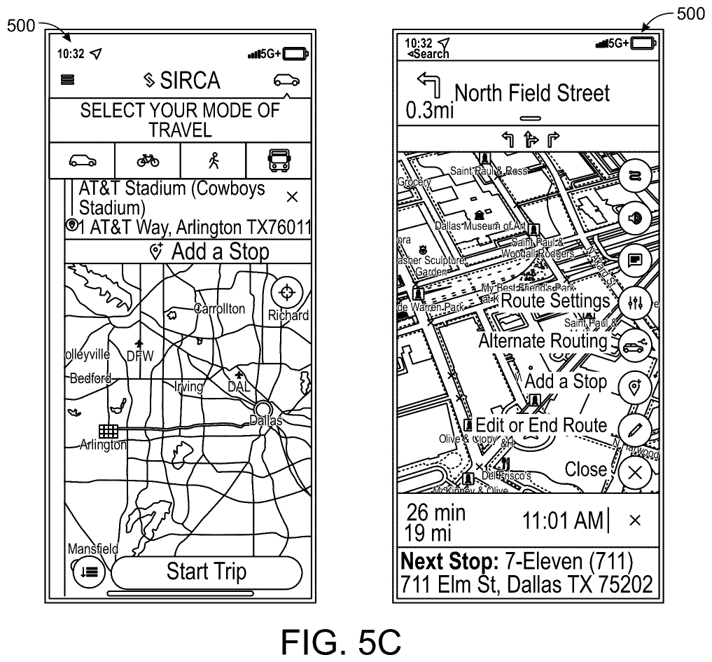

In another example implementation, the application 112 executed by the client device 110 can cause an application to the display the interfaces on the client device 110. For example, the user may open or access (e.g., via the network 120) a mobile application stored on the client device 110 structured to host the interfaces. In various implementations, interface can include infrastructure such as, but not limited to, host devices (e.g., computing device) and a collection of files defining the interface and stored on the host devices (e.g., in database 140). The mobile application operates by receiving a selection of the application (e.g., icon) on the viewport of the client device 110. In response, the interface circuit 116 executing the interface in the mobile application may request data such as from content (e.g., link up information, settings, current link ups, public link ups, previous link ups, future link ups, privacy settings, other interfaces, etc.) from database 140. The mobile application may include other functionalities, such as navigational controls (e.g., backward and forward buttons, home buttons). In some implementations, the interface circuit 116 can include both a client-side interface and a server-side interface. For example, a client-side interface can be written in one or more general purpose programming and can be executed by client device 110. The server-side interface can be written, for example, in one or more general purpose programming languages and can be executed by the linking system 130. Additional details of the interface are described in detail with reference to FIGS. 4A-4K and 5A-5C.

Interface circuit 116 may detect events within application 112. In various implementations, interface circuit 116 may be configured to trigger other functionality based on detecting specific events (e.g., link up request acceptance, in-app purchases, configuring privacy settings, opening the application for the first time, spending a certain amount of time interacting with an application, selecting a public link up, etc.). For example, interface circuit 116 may trigger a pop-up window (overlayed on an interface) upon selecting an actionable object (e.g., button, drop-down, input field, etc.) within an interface. In various implementations, library 114 includes a function that is embedded in application 112 to trigger interface circuit 116. For example, a user may include a function of library 114 in a transaction confirmation functionality of application 112 that causes interface circuit 116 to track and transmit the location of the user device to the linking system 130. It should be understood that events may include any action for a user within an application and are not limited to the examples expressly contemplated herein. In various implementations, interface circuit 116 is configured to differentiate between different types of events. For example, interface circuit 116 may trigger a first set of actions based on a first type of detected event (e.g., selecting a link up icon) and may trigger a second set of actions based on a second type of detected event (e.g., completion of a link up). In various implementations, interface circuit 116 is configured to collect event logs associated with the detected event and/or events and transmit the collected event logs to link up circuit 135.

In various implementations, the interface circuit 116 can collect events logs based on a designated session. In one example, the designated session may be active from when application 112 is opened/selected to when application 112 is closed/exited. In another example, the designated session may be active based on a user requesting a session to start and a session to end. Each session, the interface circuit 116 can collect event logs while the session is active. Once completed, the event logs may be provided to any system described herein. During the session, the event logs may trace each event in the session such that the events are organized in ascending and/or descending order. In some implementations, the events may be organized utilizing various other techniques (e.g., by event type, by timestamp, by malfunctions, etc.).

In various implementations, the interface circuit 116 of the client device 110 (or third party device) may start collecting event logs when application 112 is opened (e.g., selected by the user via an input/output circuit 118 of the client device 110), thus starting a session. In some implementations, once the application is closed by the user the interface circuit 116 may stop collecting event logs, thus ending the session. In various implementations, the user may force clear event logs or force reset application 112 such that the current session may reset, thus ending a particular session and starting a new session. Additional details regarding the interface circuit 116 functionalities, and the interfaces presented within a viewport of client device 110 are described in additional details with reference to FIGS. 4A-5C.

The input/output circuit 118 is structured to send and receive communications over network 120 (e.g., with linking system 130 and/or other client devices 110). The input/output circuit 118 is structured to exchange data (e.g., environmental data, activity data, interface information, interactions), communications, instructions, etc. with an input/output component of the linking system 130, other client devices, and/or data sources 160. In one implementation, the input/output circuit 118 includes communication circuitry for facilitating the exchange of data, values, messages, and the like between the input/output circuit 118 and the linking system 130. In yet another implementation, the input/output circuit 118 includes machine-readable media for facilitating the exchange of information between the client device 110 and the linking system 130. In yet another embodiment, the input/output circuit 118 includes any combination of hardware components, communication circuitry, and machine-readable media.

In some embodiments, the input/output circuit 118 includes suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or other user interaction purposes. As such, the input/output circuit 118 may provide an interface for the user to interact with various applications (e.g., application 112) stored on the client device 110. For example, the input/output circuit 118 includes a keyboard, a keypad, a mouse, joystick, a touch screen, a microphone, a haptic sensor, a car sensor, an IoT sensor, a biometric sensor, an accelerometer sensor, a virtual reality headset, smart glasses, smart headsets, and the like. As another example, input/output circuit 118, may include, but is not limited to, a television monitor, a computer monitor, a printer, a facsimile, a speaker, and so on. As used herein, virtual reality, augmented reality, and mixed reality may each be used interchangeably yet refer to any kind of extended reality, including virtual reality, augmented reality, and mixed reality.

In some implementations, input/output circuit 118 of the client device 110 can receive user input from a user (e.g., via sensors, or any other input/output devices/ports described herein). A user input can be a plurality of inputs, including by not limited to, a gesture (e.g., a flick of client device 110, a shake of client device 110, a user-defined custom gesture (e.g., utilizing an API), biological data (e.g., stress level, heart rate, hand geometry, facial geometry, psyche, and so on) and/or behavioral data (e.g., haptic feedback, gesture, speech pattern, movement pattern (e.g., hand, food, arm, facial, iris, and so on), or combination thereof, etc. In some embodiments, one or more user inputs can be utilized to perform various actions on client device 110. For example, a user that performs a gesture may invoke a link up request or end a link up session (e.g., indicating completion or indicating cancelation.

Input/output circuit 118 may exchange and transmit data information, via network 120, to all the devices described herein. In various implementations, input/output circuit 118 transmits data via network 120. Input/output circuit 118 may confirm the transmission of data. For example, input/output circuit 118 may transmit requests and/or information to linking system 130 based on selecting one or more selectable (or actionable) items within the interfaces described herein. In another example, input/output circuit 118 may transmit requests and/or information to another client device operated by another user (e.g., another invitee, inviter). In various implementations, input/output circuit 118 can transmit data periodically. For example, input/output circuit 118 may transmit data at a predefined time. As another example, input/output circuit 118 may transmit data on an interval (e.g., every 10 seconds, every ten minutes, every ten hours, etc.).

Linking system 130 may receive event logs from library 114 and facilitate performing analysis on received data to generate information. For example, linking system 130 may receive a data bundle including event logs from library 114 and securely correlate the received data with data stored in database 140 to generate information. In this example, the data bundle may include one or more enrollment datasets and one or more data sharing levels of the enrolled mobile devices of the one or more enrollment datasets. Alternatively, or in combination, in this example, the data bundle may include one or more invitees to a link up request and one or more data sharing levels of the invitees and/or inviter of the link up request. As another example, linking system 130 may receive first data associated with positions and real-time (or near real-time) information of the invitees and inviter of an on-going or pending link up from library 114 and second data associated with metadata of the link up request including a link up location, and data sharing levels, and correlate the first and second data.

In various embodiments, linking system 130 generates aggregate information. For example, linking system 130 may determine how many users arrived at the link up location after interacting with the mobile application and accepting the link up request. The aggregate information may describe a number or grouping of link up requests (e.g., scheduled or pending link up requests). Additionally, or alternatively, the aggregate information may describe an individual link up request interaction (e.g., experience of the user during the link up including, but not limited to, traffic the user experienced, the route the user took, if the user made an intermediate stop, when the user arrived, current location of the user, etc.). Aggregate information may include a unique identifier. In some implementations, the identifier identifies a link up request. In some implementations, the aggregate information describes one or more interactions associated with a link up request. For example, aggregate information may include a time, date, and/or link up location of the link up request. The link up request described by an anonymous link up data (e.g., where the invitee does not share their information with anyone else on the link up request) may include when the link up was accepted, how long it took for the user to accept the link up upon receiving a notification, if the user selected an intermediate stop, other navigation performed in the mobile application (e.g., selecting/clicking a selectable element, hovering over a selectable element, and/or other interactions with a selectable element).

Linking system 130 may be a server, distributed processing cluster, cloud processing system, or any other computing device. Linking system 130 may include or execute at least one computer program or at least one script. In some implementations, linking system 130 includes combinations of software and hardware, such as one or more processors configured to execute one or more scripts.

Linking system 130 is shown to include database 140 and data processing circuit 132. Database 140 may store received data. For example, database 140 may store, but is not limited to, link up request information including ongoing real-time information (e.g., current location of users, or near real-time location of the user, or previous recorded location of the user), scheduled or pending link up information, metadata of one or more link up requests, sharing levels, predetermined link ups and public link ups, link up marketplace code bundles, software development kits (SDKs) and application programming interfaces (APIs), graphical user interface code bundles (e.g., to implement the mobile application). In some implementations, database 140 stores identifiers. For example, database 140 may store logs (e.g., event logs of previous, current, and future link ups) and supplemental data sharing an intermediary identifier. The identifier may be used later for correlation of anonymous link up data. Database 140 may include one or more storage mediums. The storage mediums may include but are not limited to magnetic storage, optical storage, flash storage, and/or RAM. Linking system 130 may implement or facilitate various APIs to perform database functions (i.e., managing data stored in database 140). The APIs can be but are not limited to SQL, ODBC, JDBC, NOSQL and/or any other data storage and manipulation API.

Data processing circuit 132 includes processor 133 and memory 134. Memory 134 may have instructions stored thereon that, when executed by processor 133, cause data processing circuit 132 to perform the various operations described herein. The operations described herein may be implemented using software, hardware, or a combination thereof. Processor 133 may include a microprocessor, ASIC, FPGA, etc., or combinations thereof. In many implementations, processor 133 may be a multi-core processor or an array of processors. Memory 134 may include, but is not limited to, electronic, optical, magnetic, or any other storage devices capable of providing processor 133 with program instructions. Memory 134 may include a floppy disk, CD-ROM, DVD, magnetic disk, memory chip, ROM, RAM, EEPROM, EPROM, flash memory, optical media, or any other suitable memory from which processor 133 can read instructions. The instructions may include code from any suitable computer programming language such as, but not limited to, C, C++, C#, Java, JavaScript, Perl, HTML, XML, Python and Visual Basic.

Memory 134 may include link up circuit 135. In broad view, the link up circuit 135 may receive data and produce information regarding the data. In some implementations, the link up circuit 135 can receive a link up request (e.g., from an inviter device) and provide the link up request to each of a plurality of invitee devices. For example, a user of library 114b may register a user account with a client device such that the client device can execute the library 114b and execute link up requests. Registering a client device can include, but not limited to, providing various identifying information (e.g., device name, geolocation, identifier, etc.), platform designations (e.g., iOS, Android, WebOS, BlackBerry OS, etc.), user actions (e.g., activation gesture, haptic, biometric, etc.), authentication information (e.g., username, password, two-step criteria, security questions, address information, etc.). Once the link up circuit 135 approves or receives a registration request, the information associated with the request may be stored in database 140. Additionally, a notification may be transmitted to the client device indicating the client device is registered and can utilize link up features associated with one or more applications.

In some implementations, the link up circuit 135 can facilitate and manage link up requests including, but not limited to, communicating with the inviter and invitees of the link up, accessing the client devices of the inviter and invitees for real-time (or near real-time) information, modify a link up for one or more of the inviter or invitees (e.g., add an intermediate stop), control data sharing based on data sharing levels set by the inviter and invitees, determine unprotected and protected data and control access to the protected data, scheduling link ups, accessing social media data and other third-party data to schedule link ups and update ongoing or pending link ups, providing the graphical user interfaces of applications, determining and generating routes, and any other information used prior to, during, or after a link up.

In various implementations, link up circuit 135 performs statistical operations on received data to produce statistical measurements describing the received data. For example, link up circuit 135 may determine acceptance and promptness (e.g., if they arrive on time and at the right location) of invitees and inviters associated with a link up request. In some implementations, link up circuit 135 generates demographic information (e.g., user distributions, etc.), geographic results (e.g., location distributions, etc.), and/or audiences (e.g., a target group of users based on one or more parameters, for example users who purchased more than a threshold amount, etc.). For example, for a public link up (e.g., football tailgate, concert, any other event) the generated demographic information can be used to determine who should be invited to the public link up. In some implementations, link up circuit 135 correlates link up logs with supplemental data. For example, link up circuit 135 may correlate link up logs associated with a link up with supplemental data associated with a social media data using an intermediate identifier to determine potential upcoming link ups with potential invitees. In various implementations, link up circuit 135 generates information. The information may include link up metadata, data describing an operation of application 112, interactions of invitees with application 112, and/or the like.

In addition, the statistical operations performed by the link up circuit 135 can produce usage metrics of client devices (e.g., client device 110) and library 114. Some usage metrics can include, but are not limited to, device registration metrics, feedback metrics (e.g., what percentage of users submitted feedback), content network testing metrics (e.g., what percentage of users performed a link up, etc. The statistical operations performed by the link up circuit 135 can also produce impact metrics of client devices (e.g., client device 110) and library 114. Some impact metrics can include, but are not limited to, acceptance rate of a link up request specific to an inviter or invitee, popular or common link up locations, popular or common intermediate stops, acceptance and cancelation prior to completion rate, completion rate of a link up request specific to an inviter or invitee, etc.

In various implementations, the usage metrics and impacts metrics can be calculated based on performing various statistical operations and analysis. The usage metrics and impacts metrics can further be prioritized based on various factors (e.g., geographic area, inviter, language preference, new or existing users, and so on). In some implementations, received data and previously collected data stored in database 140 (e.g., link up logs, previous, current, pending and schedule link ups) can be used to train a machine-learning model. That is, predictions regarding link up locations, intermediate stops, and link up invitees could be based on artificial intelligence (AI) or a machine-learning model (MLM). For example, a first MLM may be trained to identify particular link up locations within a particular geographic area and output a prediction. In this example, a second MLM may be trained to identify invitees based on previous link ups. In various implementations, machine learning algorithms can include, but are not limited to, a neural network, convolutional neural network, recurrent neural network, linear regression model, and sparse vector machine). The various computing systems/devices described herein can input various data (e.g., event logs, debugging information and so on) into the machine learning model, and receive an output from the model indicating a particular action to perform.

The data sources 160 can provide data to the linking system 130. In some arrangements, the data sources 160 can be structured to collect data from other devices on network 120 (e.g., client devices 110a and 110b) and relay the collected data to the linking system 130. In one example, a user and/or entity may have a server and database (e.g., proxy, enterprise resource planning (ERP) system) that stores link up information associated with the user and/or entity (e.g., historical information, default information, social media information including pictures and locations of the user, public link up information). In this example, the linking system 130 may request data associated with specific data stored in the data source (e.g., data sources 160) of the user or entity. For example, in some implementations, the data sources 160 can host or otherwise support a search or discovery engine for Internet-connected devices. The search or discovery engine may provide data, via the data acquisition engine 180, to the linking system 130. In some implementations, the data sources 160 can be scanned to provide additional data. The additional data can include newsfeed data (e.g., articles, breaking news, and television content), social media data (e.g., Facebook, Twitter, Snapchat, and TikTok), geolocation data of users on the Internet (e.g., GPS, triangulation, and IP addresses), governmental databases (e.g., FBI databases, CIA databases, COVID-19 databases, No Fly List databases, terrorist databases, vulnerability database, cyber threat intelligence databases, and certificate databases), and/or any other data associated with the user and link up request.

The system 100 can include a data acquisition engine 180. In various implementations, the linking system 130 can be communicatively and operatively coupled to the linking system 130. The linking system 130 can include one or more processing circuits configured to execute various instructions. In various implementations, the linking system 130 can be configured to facilitate communication (e.g., via network 120) between the linking system 130 and systems described herein. The facilitation of communication can be implemented as an application programming interface (API) (e.g., REST API, Web API, customized API), batch files, and/or queries. In various implementations, the data acquisition engine 180 can also be configured to control access to resources of the linking system 130 and database 140.

The API can be used by the data acquisition engine 180 and/or computing systems to exchange data and make function calls in a structured format. The API may be configured to specify an appropriate communication protocol using a suitable electronic data interchange (EDI) standard or technology. The EDI standard (e.g., messaging standard and/or supporting technology) may include any of a SQL data set, a protocol buffer message stream, an instantiated class implemented in a suitable object-oriented programming language (e.g., Java, Ruby, C#), an XML file, a text file, an Excel file, a web service message in a suitable web service message format (e.g., representational state transfer (REST), simple object access protocol (SOAP), web service definition language (WSDL), JavaScript object notation (JSON), XML remote procedure call (XML RPC)). As such, EDI messages may be implemented in any of the above or using another suitable technology.

In some implementations, data is exchanged by components of the data acquisition engine 180 using web services. Where data is exchanged using an API configured to exchange web service messages, some or all components of the computing environment may include or may be associated with (e.g., as a client device) one or more web service node(s). The web service may be identifiable using a unique network address, such as an IP address, and/or a URL. Some or all components of the computing environment may include circuits structured to access and exchange data using one or more remote procedure call protocols, such as Java remote method invocation (RMI), Windows distributed component object model (DCOM). The web service node(s) may include a web service library including callable code functions. The callable code functions may be structured according to a predefined format, which may include a service name (interface name), an operation name (e.g., read, write, initialize a class), operation input parameters and data type, operation return values and data type, service message format, etc. In some implementations, the callable code functions may include an API structured to access on-demand and/or receive a data feed from a search or discovery engine for Internet-connected devices. Further examples of callable code functions are provided further herein as embodied in various components of the data acquisition engine 180.

The data sources 160 can provide data to the linking system 130 based on the data acquisition engine 180 scanning the Internet (e.g., various data sources and/or data feeds) for data associated with a user or link up request. That is, the data acquisition engine 180 can hold (e.g., in non-transitory memory, in cache memory, and/or in database 140) the executables for performing the scanning activities on the data sources 160. Further, the linking system 130 can initiate the scanning operations. For example, the linking system 130 can initiate the scanning operations by retrieving domain identifiers or other user/entity identifiers from a computer-implemented DBMS or queue. In various implementations, the data sources 160 can facilitate the communication of data between the client devices 110 (e.g., 110a and 110b), such that the data sources 160 receive data (e.g., over network 120) from the client devices 110a and client device 110b before sending the data other systems described herein (e.g., linking system 130). In other implementations and as described herein, the client devices 110, and the data sources 160 can send data directly, over the network 120, to any system described herein and the data sources 160 may provide information not provided by any of the client devices 110.

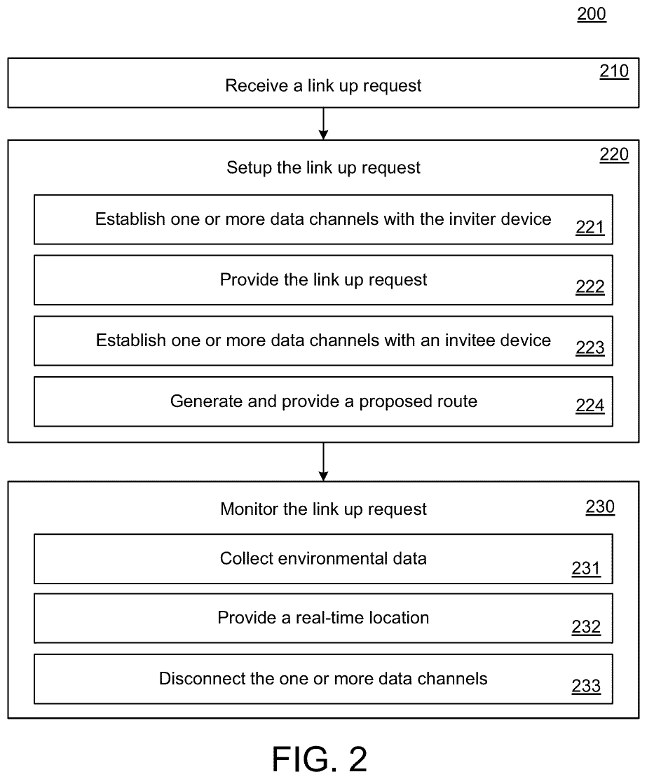

Referring now to FIG. 2, a flowchart for a method 200 for linking devices and protecting data is shown, according to some embodiments. Linking system 130 can be configured to perform method 200. Further, any computing device described herein can be configured to perform method 200.

In broad overview of method 200, at block 210, the one or more processing circuits (e.g., linking system 130 in FIG. 1) can receive a link up request. At block 220, the one or more processing circuits can setup the link up request. At block 230, the one or more processing circuits can monitor the link up request. Additional, fewer, or different operations may be performed depending on the particular arrangement. In some embodiments, some, or all operations of method 200 may be performed by one or more processors executing on one or more computing devices, systems, or servers. In various embodiments, each operation may be re-ordered, added, removed, or repeated.

At block 210, the one or more processing circuits can receive, from an inviter device, a link up request associated with a link up location. The inviter device can be the facilitator of the link up and the link up request can include metadata of the link up request including invitee information, potential intermediation stops, the link up location, and various other data of the link up. In some implementations, the link up request is associated with a predetermined link up with predetermined invitee devices. Furthermore, the one or more processing circuits can determine the predetermined link up based on social media data, wherein the predetermined link up is determined based on identifying trends in the social media data. For example, a preconfigured link up can be established based on a group of individuals meeting up the first Friday of the month at the arcade (e.g., shown in posts on a social media website). In another example, a link up request can be tailored for educational groups aiming to organize study sessions at local libraries, using social media platforms to coordinate times and locations. In some implementations, the one or more processing circuits can receive (e.g., from the inviter device) a list of items associated with the link up request. In some implementations, the link up request is a public link up request configured to share the link up request to a link up marketplace. For example, a public link up in the community can be established by an event center or location (e.g., football game, movie theater, political rally, etc.) such that a link up request can be shared in a link up marketplace or online. In particular, the link up marketplace can be another application (online or mobile) configured to provide public or private link ups to user accounts or un-registered users and allow the users to select one or more link ups. For example, a user might discover a local art exhibit link up through the marketplace, enabling a more engaging cultural experience.

In some implementations, public link ups can be created and shared through a link up marketplace, allowing users to discover and participate in various events such as football games, movie theaters, or political rallies. For example, a local community center might post an open invitation for a volunteer cleanup event at a nearby park. To enhance the user experience, the system can intelligently identify sub-groups of link up participants within the public event, enabling users to connect and interact with people they know or have shared interests with, such as friends or acquaintances. For example, at a public link up for a tailgating party, the system can analyze the participants' data, such as their social connections, previous link ups, and interests, to identify potential sub-groups. In another example, a concert link up might use attendees' music preferences to suggest meet-ups with fans of similar genres. This information can be used to create a more personalized experience by suggesting a smaller gathering within the larger public event, where users can engage with familiar faces or those with similar preferences. The link up marketplace can be integrated into another application, either online or mobile, that offers both public and private link ups to registered users and unregistered guests. For example, an app dedicated to local community engagement might incorporate the link up marketplace feature, encouraging residents to participate in a variety of activities and events tailored to their interests and social circles. Users can browse and select from various link ups, further customizing their experiences to suit their preferences and comfort levels. This approach facilitates more meaningful and enjoyable interactions at public events while also preserving user privacy and autonomy.

At block 220, the one or more processing circuits can setup the link up request. Setup of the link up request can include establishing one or more data channels with the inviter device (block 221), providing the link up request (block 222), establishing one or more data channels with an invitee device (block 223), and generating and providing a proposed route (block 224). At block 221, the one or more processing circuits can establish one or more data channels with the inviter device. For example, the one or more processing circuits can establish a secure wireless connection with the inviter device, ensuring a reliable communication channel for transmitting the link up details. Each data channel may include a network connection (e.g., wired, wireless, cloud) between the one or more processing circuits and the linking system 130. In general, each data channel of the plurality of data channels may be communicatively connected to the one or more processors via a data channel communication network such that each device or system connected to the data channel can be a computing device that can store, generate, and collect data.

At block 222, the one or more processing circuits can provide the link up request to each of a plurality of invitee devices, the link up request including the link up location. In some implementations, the one or more processing circuits can determine one or more stops within a geographic area of the link up request that includes one or more of the list of items in stock. For example, the link up circuit 135 can analyze data source 160 (e.g., local grocery stores and online). In some implementations, each invitee and inviter can be associated with a user account (sometimes referred to as a “profile”) of the application. For example, the first invitee device can be associated with a profile of the application, and wherein the first proposed route is based on a default location of the profile. In another example, a proposed route may consider historical traffic data and current road conditions to optimize travel time for each invitee.

At block 223, the one or more processing circuits can, in response to receiving a first acceptance of the link up request from a first invitee device of the plurality of invitee devices, establish the one or more data channels with the first invitee device. For example, the processing circuits may use Bluetooth or Wi-Fi Direct to establish a secure connection for sharing link up details and updates in real-time. In some implementations, in response to receiving the first acceptance, the one or more processing circuits can offer the one or more stops as selectable elements via the first GUI of the application, wherein determining the stop and providing the intermediate location are in response to receiving a selection of one of the selectable elements. For example, a stop at a local café that offers a discount for participants of the link up might be proposed, enhancing the overall experience and providing a relaxed setting for participants to meet before the main event. Furthermore, the one or more processing circuits can update the list of items indicating at least one item of the list of items is attributed to the first inviter device. Additionally, each of the one or more stops offered further include an incentive (e.g., configured by the inviter or set by the one or more processing circuits) presented with a selectable element of the selectable elements (e.g., offer best seat at the game, offer first selection of one or more food items, offer a better parking spot, offer a free or food item drink associated with the link up location, etc.). For example, a special access code for a VIP area at a concert could be offered as an incentive for participants who choose to meet at a pre-determined promotional event spot.

At block 224, the one or more processing circuits can generate and provide, to the first invitee device via a first graphical user interface (GUI) of an application, a first proposed route to the link up location and at least one first real-time location of one of the plurality of invitee devices or the inviter device, wherein the first proposed route is based on a first geographic location of the first invitee device. For example, the processing circuits might dynamically update the route in real-time to avoid traffic congestion, ensuring the fastest possible arrival time. In some implementations, the one or more processing circuits can generate and present, to the second invitee device via a second GUI of the application, a second proposed route to the link up location, wherein the second proposed route is based on a second geographic location of the second invitee device. For example, the application could suggest a scenic route for the second invitee device, offering an enjoyable journey if time allows.

In some implementations, the first proposed route is presented on the first invitee device, and wherein the presentation includes an estimated time of arrival (ETA) for each of the inviter device, the first invitee device, and the second invitee device. For example, everyone or certain client devices that accepted the link up request can be provided the ETA of each other. In another example, adjustments can be made for those arriving by different modes of transport, such as public transit routes for those without cars. In some implementations, the one or more processing circuits can update the one or more stops based on either the first proposed route or the second proposed route. In some implementations, for a public link up, the one or more processing circuits can generate and provide, via the application, the link up request to a plurality of public invitee devices, the link up request including the link up location, wherein the plurality of public invitee devices are determined based on an enrollment dataset. In particular, the enrollment dataset can be determined from data sources 160 or provided by the inviter (e.g., customer list). For example, the link up request for a large-scale community clean-up event could be broadcast to local residents who have previously participated in similar events, encouraging a larger turnout and fostering community engagement.

In some implementations, the first acceptance includes privacy parameters for sharing data of the first invitee device, and wherein the privacy parameters include a plurality of data sharing levels associated with a type and amount of the data shared. For example, users can be allowed to set their individual privacy settings. In some implementations, the one or more processing circuits can allow the inviter or invitees to set their individual privacy settings based on a plurality of levels related to who can see the data. For example, a first level of the plurality of data sharing levels configures the one or more processors to share the data of the first invitee device with at most the inviter device, and a second level of the plurality of data sharing levels configures the one or more processors to share the data of the first invitee device with at most the inviter device and one of the plurality of invitee devices, and a third level of the plurality of data sharing levels configures the one or more processors to share the data of the first invitee device with the inviter device and one of the plurality of invitee devices. Specifically, the third level allows for sharing of both location and contact information only with those directly involved in the meetup.

In another example, a first level of the plurality of data sharing levels configures the one or more processors to share unprotected data of the data of the first invitee device with at most the inviter device, and a second level of the plurality of data sharing levels configures the one or more processors to share the unprotected data of the data of the first invitee device with the inviter device and one of the plurality of invitee devices, and a third level of the plurality of data sharing levels configures the one or more processors to share the unprotected data and protected data of the data of the first invitee device with the inviter device and one of the plurality of invitee devices. That is, the processing circuits can enable users to fine-tune their privacy preferences, allowing for a mix of public and private data sharing depending on the user's comfort level with each participant. For example, users can choose to share their live location with close friends while only sharing their estimated time of arrival with acquaintances.

In some implementations, the system enables the invitee to opt-in and have greater control over their privacy by allowing them to choose from various privacy parameters for each link up session. For example, an invitee can select to share their precise location only with friends while attending a large music festival, enhancing safety without compromising privacy. In one aspect, the system allows the invitee to customize the sharing of protected and unprotected data based on the nature of the link up session. In another example, a user attending a professional networking event can opt to share their business contact information but keep their personal phone number private. This enables users to differentiate between trusted link ups, such as those with familiar participants, and untrusted link ups, like public events where users may prefer to maintain a higher level of privacy. For example, during a trusted link up, an invitee may feel comfortable sharing both protected and unprotected data, knowing that the other participants are people they have interacted with before. On the other hand, in an untrusted or public event, the invitee may opt for more restrictive settings, like sharing only unprotected data or choosing to be completely incognito. For example, someone attending a large convention might share their location with all attendees in the official app but choose to be invisible on the broader social media feed. The ability to customize privacy parameters for each session empowers users to maintain control over their data, ensuring that their privacy preferences are respected across different types of link up events.

At block 230, the one or more processing circuits can monitor the link up request. Monitoring the link up request can include collecting environmental data (block 231), providing a real-time location (block 232), and disconnecting the one or more data channels (block 233). At block 231, the one or more processing circuits can collect (e.g., continuously, at designated times, or during a time period), via the one or more data channels, environmental data of the inviter device and the plurality of invitee devices. The environmental data can include device data such as, but not limited to, current location of the device, interactions with the device, information of the link up location, cancelation or completion of the link up, etc. In some implementations, the one or more processing circuits can determine a stop along the first proposed route or the second proposed route and provide an intermediate location to at least one of the first invitee device or the second invitee device. For example, the one or more processing circuits can establish stops for individuals of the link up request to stop at prior to arriving at the link up (e.g., inviter forgot to bring ketchup to the tailgate).

At block 232, the one or more processing circuits can provide, to the inviter device via a third GUI of the application, a real-time location (or near real-time, delayed location based on delayed data) of the first invitee device and the second invitee device based on the environmental data, wherein the real-time location of the first invitee device and the second invitee device is presented on the third GUI of the application. For example, the processing circuits can highlight the paths of each participant as they converge on the meetup location, offering the inviter a visual representation of all arriving parties. In another example, the processing circuits might alert the inviter when an invitee is within a certain distance of the link up location, allowing for better timing of activities. In yet another example, the processing circuits can provide updates on the invitee's ETA adjustments due to traffic conditions, keeping the inviter informed in real-time.

At block 233, the one or more processing circuits can, in response to determining at least one of the first invitee device or the second invitee device completed the link up request at the link up location, disconnect the one or more data channels connecting the one or more processors and the at least one of the first invitee device or the second invitee device. In some implementations, the one or more processing circuits can in response to determining at least one of the first invitee device or the second invitee device arrived at the link up location, share a geographic location of the inviter device to the at least one of the first invitee device or the second invitee device. For example, the inviter (or the invitee) can share a pinned location after arrival, such as in a large parking lot. In some implementations, upon confirmation of an invitee's arrival, the processing circuits could enable a feature for the inviter to send a welcome message or instructions on where exactly inside the location they can meet, further facilitating a smooth link up process. For example, this could be particularly used in crowded events where finding each other could be challenging, and sharing a specific meeting point could significantly enhance the experience.

In some implementations, when the processing circuits determines that at least one of the invitee devices has arrived at the link up location, it enables a feature for users to privately message or notify other invitees or the inviter of their presence. In various implementations, the private messaging feature can be enabled for the entirety of the link up. This can be particularly helpful in scenarios where participants are gathered in large or crowded areas, such as big parking lots, concerts, or festivals. Upon arrival at the link up location, the invitee can choose to share their precise geographic location, such as a pinned location on a map, with the inviter and other attendees. This sharing of location data can be done through private messages or notifications, allowing participants to easily locate one another without broadcasting their whereabouts to the entire group or event. Additionally, once the link up request is complete, the system can automatically disconnect the data channels connecting the invitee devices and the processing circuits. This ensures that the users' location information is shared when necessary, preserving their privacy and minimizing potential security risks.

In some implementations, the processing circuits can employ a “home safe” feature that can alert parents, guardians, or significant others if their child (or another user) is not following the link up location route back home (or a location returning form the link up location). For example, if a child deviates from the prescribed route after a school event, the system could send an alert to the parent's device. This can allow the parents, guardians, or significant other to check on the user and receive assurance. That is, the feature could offer real-time tracking options so guardians can see the child's current location. For example, the processing circuits can send a notification if the child's device stops moving for a certain period or if it detects an unusual pattern of movement.

In some implementations, during the setup of the link up request at block 220, the processing circuits can determine and suggest a central location of a link up based on geographic locations of all or some of the participants. For example, if the participants are evenly spread across a city, the system might suggest a popular central café that is equidistant (or substantially equidistant) for all attendees, maximizing convenience and reducing travel time. In another example, if the link up involves an outdoor activity preference among participants, the system could suggest a well-rated park located centrally to everyone's locations. In some implementations, the processing circuits can determine and suggest the central location based on real-time traffic data and participants' current locations to ensure the most efficient routes for all. For example, a central museum that not only serves as a convenient meeting point but also offers an engaging activity for the group. In some implementations, the central location can be based on specific characteristics or profiles of the participants, such as a preference for vegan restaurants or interest in art galleries, ensuring the suggested location aligns with the group's interests.

In some implementations, the application presenting the GUI provided by the processing circuits can further include links to other applications. That is, during a link up the GUI can present audio book applications, music applications, podcast applications, and so on to allow the link up participants to receive similar audio or content (e.g., music from a particular band or artist if going to a music festival with the particular band or artist) or the same audio or content (e.g., the same podcast about planning a wedding when the link up participants are meeting at a wedding planning conference). That is, the GUI can facilitate seamless switching between different audio sources, depending on individual preferences or group consensus. For example, as users approach the location of a book festival (e.g., at block 231, collecting environmental data), the processing circuits can suggest starting a popular author's latest audiobook. In another example, the GUI could display a notification when a significant portion of the group starts playing a pre-game hype playlist, prompting others to join in. In some arrangements, the processing circuits can provide recommended playlists or audiobook chapters that will conclude right (or closely around) as the participants arrive at the link up location. For example, a playlist with a duration matching the estimated travel time might be automatically generated. Additionally, one or more link up participants can share a favorite podcast episode, initiating simultaneous playback across devices. For example, one participant might push a “share and play” button so that all participants begin listening to the same podcast at the same point. In another example, a link up member might share a curated playlist that dynamically updates based on the group's progress towards the destination. Additionally, other individuals can receive real-time updates of the progress of other participants of the audio being listened to, such as a live indicator of which song from a shared playlist is currently playing. For example, the GUI could show that most participants are listening to the third chapter of a shared audiobook, allowing others to sync their playback.

In some implementations, the processing circuits the first GUI and second GUI can include to a look and feel (LF) theme based on the link up request or the link up location. For example, the GUI themes could automatically adjust to feature pumpkins and ghost motifs, creating a festive user interface for Halloween-themed link ups. In some implementations, the link up request provided to the plurality of invitee devices can include a customized invitation including content corresponding with the link up request or link up location. For example, the customized invitation could be adorned with floral designs and elegant script fonts, suitable for a wedding-themed gathering.

In some implementations, the first location of one of the plurality of invitee devices or the inviter device can be a first visual indicator when the one of the plurality of invitee devices or the inviter device is location sharing and the first location of one of the plurality of invitee devices or the inviter device can be a second visual indicator when the one of the plurality of invitee devices or the inviter device is not location sharing. For example, the first visual indicator could be a vibrant pink when location sharing is active to signify presence, and turn to a subtle gray when location sharing is turned off, indicating privacy.

In some implementations, in response to receiving the first acceptance, the processing circuits can activate one or more safety features on the first invitee device, wherein the one or more safety features include enabling a third-party device to track the first invitee device and establishing another data channel between the third-party device and the first invitee device to exchange communicates or messages. For example, a home safe feature could allow a designated contact, such as a family member, to monitor the user's journey back home after the event, enhancing safety and peace of mind.

In some implementations, the received link up location is a general location, the processing circuits can in response to receiving the first acceptance of the link up request, determine a central location for the link up location based on the first geographic location of the first invitee device and a geographic location of the inviter device, wherein the first proposed route to the link up location is to the central location. For example, central link up locations based on users' individual locations could involve calculating a midpoint that minimizes overall travel time for all participants, facilitating a convenient meeting place.

In some implementations, generating and providing, via the first GUI of the application, the first proposed route to the link up location includes at least one of (1) a first selectable element including a request a rideshare or carpool for the link up, (2) a second selectable element including an offer for pick up by the inviter device or the plurality of invitee devices, or (3) a third selectable element including a media recommendation the first invitee device can output as audio during the first proposed route to the link up location. For example, the first selectable element can include options to select a rideshare service based on the quickest arrival time or the most cost-effective option. For example, the second selectable element can offer coordination of a pick-up schedule among the invitees, optimizing the route to pick up each person based on their location. For example, the third selectable element can suggest playlists or podcasts that are popular or trending within the group's shared interests. In another example, the third selectable element can curate a playlist of music relevant to the theme of the link up or select a podcast episode matched with the estimated time to the destination, ensuring entertainment is perfectly timed for the journey's duration.

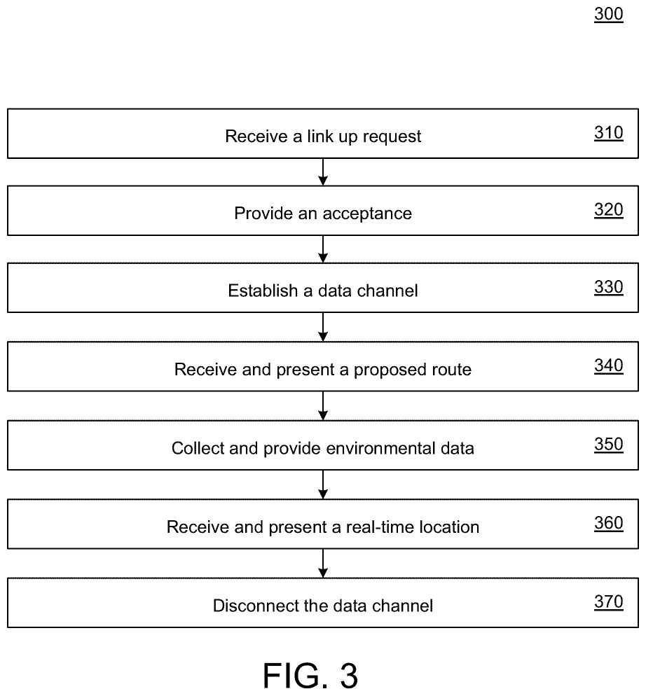

Referring now to FIG. 3, a flowchart for a method 300 for linking devices and protecting data is shown, according to some embodiments. Client devices 110 (e.g., 110a and 110b) can be configured to perform method 300. Further, any computing device described herein can be configured to perform method 300.

In a broad overview of method 300, at block 310, the one or more processing circuits (e.g., client devices 110 in FIG. 1) can receive a link up request including a link up location. For example, the request could come from a user planning a meet-up with friends at a football game, indicating the specific entrance gate as the link up location. In some arrangements, the link up request can include identifiers for the invitee devices expected to join. For example, the request may specify the mobile device IDs of all attendees, facilitating a more secure and targeted connection.

At block 320, the one or more processing circuits can provide, to a protection system, an acceptance of the link up request. For example, the devices of the attendees may send back a confirmation message with their current location data. In some arrangements, the acceptance can include verification tokens to authenticate the response. For example, each device might include a unique QR code or digital signature in their acceptance to ensure security and verify the identity of the attendees.

At block 330, the one or more processing circuits can, in response to the acceptance, establish a data channel with the protection system. For example, a secured connection is set up to share location updates and notifications. In some arrangements, establishing a data channel can include setting up encrypted communication to protect the privacy of the participants. The protection system can facilitate the link up, and the user device (e.g., processing circuits) can monitor the real-time locations of all participants. For example, the app could display the live location of all attendees on a map, updating their positions as they move.

At block 340, the one or more processing circuits can receive and present, via a graphical user interface (GUI) of an application, a proposed route to the link up location and at least one real-time location (or near real-time location, or past location) of one of a plurality of invitee devices or an inviter device, wherein the proposed route is based on a first geographic location of the user device. For example, the app may suggest the most efficient route for each attendee to reach the designated meetup point. In some arrangements, the proposed route can adjust in real-time based on changes in the attendees' locations and traffic conditions. For example, if a road closure occurs, the app could immediately suggest alternative routes to the meetup point.

At block 350, the one or more processing circuits can collect and provide, via the data channel, environmental data. For example, this could include weather updates, crowd density information, or event-specific alerts. In some arrangements, collecting environmental data and providing the environmental data can include integrating with external APIs for live updates. For example, the app could pull data from weather services and social media feeds to give attendees a comprehensive view of conditions at the link up location. In another example, the processing circuits might alert users to leave earlier due to a forecasted storm.

At block 360, the one or more processing circuits can receive and present, via the GUI of the application, a real-time location of at least one of the plurality of invitee devices or the inviter device. For example, attendees can see how far away their friends are from the meetup point. For example, the host could monitor when each guest is likely to arrive and coordinate accordingly. The real-time location can be displayed on an interactive map within the app. In some arrangements, presenting can include options for attendees to communicate directly through the app, allowing them to coordinate or adjust meetup details as needed. For example, attendees could send messages or share updates on their estimated time of arrival directly through the app.

At block 370, the one or more processing circuits can, in response to determining the one or more processors completed the link up request at the link up location, disconnect the data channel connecting the one or more processors and the protection system. For example, once all attendees have arrived, the app could automatically close the link up event and cease location tracking to preserve battery life and privacy. In some arrangements, disconnecting the channel can include sending a final notification to all participants confirming the successful meetup. For example, when the link up request is completed, the app might send a “Link Up Successful” message and offer options for group photos or event check-ins to social media platforms.

Additional, fewer, or different operations may be performed depending on the particular arrangement. In some embodiments, some, or all operations of method 300 may be performed by one or more processors executing on one or more computing devices, systems, or servers. In various embodiments, each operation may be re-ordered, added, removed, or repeated.

In some embodiments, the one or more processing circuits can present real-time location data of invitees or the inviter device when the one or more processing circuits are not geographically moving. In one aspect, this location sharing may only be activated when the processing circuits determine that the device is stationary. For example, if a user is at the designated link up location and not moving, the real-time location data will be available to other participants. Conversely, if a user is in transit or moving around, their real-time location data will not be shared to preserve their privacy. This dynamic location sharing feature provides users with a greater sense of control over their personal information while still enabling them to connect with others during link up events.

Referring generally to FIGS. 4A-5C, example illustrations of a graphical user interface, according to some embodiments. In general, FIGS. 4A-5C illustrate the graphical user interface that can be rendered at the client device 110 to execute and perform link ups. The graphical user interface can include a plurality of interfaces, objects, and selectable elements. For example, the client device 110 can execute to provide the graphical user interface with link up information (e.g., initiate a link up, ongoing link up data, historical link up data) based on events executed in application 112. The graphical user interface can include a plurality of interfaces, objects, and elements such that an individual (e.g., a user or human operator) can provide biological data (e.g., stress level, heart rate, hand geometry, facial geometry, psyche, and so on) and/or behavioral data (e.g., haptic feedback, gesture, speech pattern, movement pattern (e.g., hand, food, arm, facial, iris, and so on), intangible feedback (e.g., selection of intangible content displayed on client device 110, response to stimuli, etc.) to interact with the plurality of interfaces, objects, and/or elements. In various embodiments, the client device 110 may be of varying sizes, for example, a mobile phone, an IoT device, a smart watch, smart gear, a helmet, a virtual reality headset, an augmented reality headset, smart glasses, a hat, a headdress, and/or any type of mobile electronic device. Thus, the display and/or client device 110 is not limited to any specific combination of hardware circuitry and software.

In some implementations, the application 112 can modify the appearance and look of the graphical user interfaces (GUIs) (e.g., GUI 400 and GUI 500) based on the time of year (e.g., seasonal), particular day (e.g., 4th of July), user religion, user age, user location, or type of link up (e.g., going to Halloween party). That is, the GUI theme and functionality offerings can be modified to align with seasonal activities or holiday celebrations, thus enhancing the user's engagement and festive spirit. For example, during Halloween, the GUI might display a scary theme with interactive elements like pumpkins and ghosts, which, when tapped, reveal link up details or Halloween party locations. In another example, on Valentine's Day, the GUI could feature a romantic theme with hearts and roses, offering suggestions for couple's activities and events. In yet another example, the GUI could be updated to reflect a winter wonderland during the Christmas season, with snowflake touchpoints leading to holiday market meet-ups. In yet another example, the GUI could feature bright festive colors on Holi for a Hindu user. Accordingly, the graphical user interface provided by application 112 can dynamically adjust its presentation and content to improve the user's experience in context with the seasonal or celebratory theme of the link up. In an additional implementation, the application 112 may modify the appearance and look of a destination icon on the GUI. For example, upon selection of a destination for a link up, a destination-specific icon may appear. The destination-specific icon may include, for example, a large trademark icon of the destination. By way of example, if the link up destination is selected as Warner Brothers Studios, a Warner Brothers Studios logo may appear floating above the destination location on the map. In another example, if the link up destination is a coffee shop, a large cup of coffee may appear above the destination location. In this manner, the GUI may aid a user in navigating to a destination by displaying relevant pictorial information to the user.

In some implementations, application 112 can create or allow the creation of customized link up invites for events, such as stylized digital invitation cards. That is, the GUI (e.g., GUI 400 or GUI 500) can offer a suite of tools for an inviter to design personalized invitations, with thematic graphics, interactive elements, and link up information tailored to the nature of the event, like a birthday party or wedding. For example, for a birthday celebration, the GUI could provide templates that incorporate balloons and cakes, where tapping a balloon could reveal the time of the link up, and the cake might display the venue. In another example, for a wedding link up, the invitation could be styled with floral borders, and selecting a flower could allow guests to RSVP and link up to the destination. In yet another example, for a corporate event, the GUI could offer a template with the company's branding, where interactive elements might outline the agenda of the link up. Accordingly, the graphical user interface provided by application 112 can be adapted to enable users to customize event-specific invitations. For example, in preparation for a wedding, application 112 could be used to send out link up requests to all the guests with a wedding-themed interface. These requests can double as digital invitations and, once accepted, allow the couple to track the progress of invitees on the wedding day. The application 112 on the GUI could also play the couple's chosen wedding music for guests as they travel to the location. On the wedding day, everyone's location (or everyone that shared their location) could be visible in the GUI, providing real-time updates on who has arrived.

Referring now to FIGS. 4A-4K, example illustrations of a graphical user interface, according to some embodiments. FIGS. 4A-4K disclose a method to setup and perform a link up. The method includes setting a link up location (or destination), inviting friends or other individuals (by the inviter), adding any stops, and begin progressing towards the link up. For example, in FIG. 4A, the user can open application 112 to present a graphical user interface (GUI) 400. The GUI 400 can allow the user to interact with GUI 400 and select interactable element 402 to invite one or more individuals to link up. In FIG. 4B, the user can interact with GUI 400 and select interactable element 404 to search a link up location. In some arrangements, the link up location should be added prior to inviting an individual to link up. In FIG. 4C, after the user selects a link up location, the user can interact with GUI 400 and select interactable element 406 to invite one or more individuals to link up at the particular link up location. In FIG. 4D, a pop-up or another interactable element can be presented in GUI 400 allowing the user to interact the pop-up to invite an individual to link up. In some arrangements, the user can add 1 to n number of individuals to the link up. Additionally, another pop-up or interactable element can be presented in GUI which can be interacted with by the user to allow application 112 to access the contacts of the user.

In FIG. 4E, the user can interact with GUI 400 and select interactable element 408 to invite the entered individual or individuals. Additionally, another pop-up or interactable element can be presented in GUI 400 which can be interacted with by the user to allow application 112 to send/receive messages (e.g., SMS messages, emails, phone calls, push notifications) to/from the invitee devices. Additionally, once someone is invited, the individual can appear on GUI 400 under the link up content. In an embodiment in which the invitee device does not have a corresponding application 112 downloaded or otherwise available on device, the invitee device may receive an SMS message in response to the inviter device sending the link up request after interaction with the interactable element 408. The SMS message may include a link to a web browser to access the link up request and/or a link to an application distribution database (e.g., an application store) to download the application 112 on the invitee device and thereby access the link up invitation. In embodiments in which the invitee device has the application 112 downloaded or otherwise available, the link up invitation may be transmitted to the invitee device through a push notification or other method of notification that is visually and/or audibly presented on the invitee device. In FIG. 4F, the GUI 400 can indicate the link up request was sent and delivered, and the invited individual can receive text messages depicted in GUI 410 (e.g., a messaging application) of the invited individuals computing device. In FIG. 4G, after the invited individuals downloads the application or accesses a web portal, GUI 400 can allow the invited individual to interact with GUI 400 to accept the link up request by selecting interactable element 412. In some arrangements, various details of the link up can be presented in GUI 400.

In FIG. 4H, the user (invitee or inviter) can start the link up trip on GUI 400 by selecting interactable element 414. In some arrangements, upon acceptance of the link up request, the invitee or inviters GUI 400 of application 112 can automatically start the trip. After the trip is started, the GUI 400 can present their route to the link up location. In some arrangements, the GUI 400 can allow the trip to be paused and resumed. In FIG. 4I, the other individuals of the group can be notified an individual accepted the link up request by their avatar next to their name (e.g., John AndroidDev) having a check mark. In some arrangements, GUI 400 can allow the individual that accepted to trip to view the location of all users by selecting interactable element 416. In some arrangements, various details of the link up can be presented in GUI 400.

In FIG. 4I, the user (invitee or inviter) can view other users of the link up on GUI 400 by selecting interactable element 416 and in response, the application 112 can present additional selectable elements including the “View Link Up Map” selectable element, as shown in FIG. 4J. Upon selection, content item 420 of FIG. 4J can be presented on GUI 400 allowing one of the link up participant to view one or more locations of the other link up accepted individuals. In some arrangements, the content item can be colored, highlighted, or otherwise identified based on if the user is actively sharing their location. For example, a pink color can be presented on GUI 400 indicating the user is actively sharing their location with other link up participants. In another example, a gray color can be presented on GUI 400 indicating the user is not actively sharing their location with other link up participants. Accordingly, GUI 400 employs visual indicators such as color coding, highlighting, and icons to signify the location sharing status and other pertinent details of each participant, offering an overview that enhances group coordination and interaction during the link up. In FIG. 4K, the GUI 400 can allow an individual of the link up trip to complete the link up (or end the link up) by selecting interactable element 422. In some arrangements, the locations of the individual that completed the link up can be shared with the other individuals of the link up. For example, one location can be shared with the other individuals where the user ended the link up. In another example, a continuous location can be shared with the other individuals so that the other users of the link up can view prior to their completion of the link up.

Referring now to FIGS. 5A-5C, example illustrations of a graphical user interface, according to some embodiments. FIGS. 5A-5C disclose a method to setup and perform a link up. The method includes setting a link up location (or destination), inviting friends or other individuals (by the inviter), adding any stops, and begin progressing towards the link up. For example, in FIG. 5A, the user can open application 112 to present a graphical user interface (GUI) 500. GUI 500 can include similar features and functionalities of GUI 400 of FIGS. 4A-4K. In some arrangements, the GUI 500 can allow the individual to create a link up, invite individuals, and add one or more intermediate stops for the link up. Additionally, after the link up creator enters invitee information a pop up can be displayed of a messaging application GUI 510 allowing the creator to send the invite to one or more individuals to join the link up. In FIG. 5B, the invited individual can interact with GUI 500 to also invite additional individuals to the link up. In some arrangements, prior to the avatar having a check mark (e.g., indicating acceptance of the link up), the individuals name can be presented above an “invited” indication on GUI 500. In some arrangements, one or more of the individuals of the link up can review the route and any stops. In FIG. 5C, the GUI 500 can allow the user to select the mode of travel using the one or more interactive elements (e.g., car, bike, walk/run, public transportation). In some arrangements, the GUI 500 can offer or the application 112 can request a rideshare or carpool to pick up the link up user and get them to the link up location. Additionally, during the link up a user can be presented with a pop up on GUI 500 to modify the link up or adjust settings (e.g., route settings, alternate routing, add a stop, edit or end route, close, etc.). In some arrangements, the next stop and final stop can be presented on GUI 500.

In some arrangements, a link up participant can send a notification or request to another link up participant to pick them up (e.g., because the person is on the way to the link up location) or have the rideshare one link up participant is using pick-up another participant of the link up. For example, during their journey to the link up location, Sarah, who is part of the link up, finds herself delayed due to unexpected traffic. Realizing she will pass by another link up participant, Tom, who is still at home, Sarah uses the GUI 500 to send a notification to Tom, suggesting she can pick him up on her way. The GUI 500 can facilitate this interaction by allowing Sarah to send a direct request to Tom, streamlining their coordination and ensuring they both arrive at the link up location together. In another example, Mike is using a rideshare service to get to the link up location and realizes that his route passes by Jenna's location. Through the application's GUI 500, Mike sends a request to the rideshare driver, via the app's integration, to make an additional stop to pick up Jenna. This feature within GUI 500 ensures efficient route planning and enhances the user experience by facilitating easy coordination among link up participants. In some arrangements, one link up participant can send a request to pick up another individual that is walking. For example, Alex, who decided to walk to the link up location, finds the walk longer than anticipated. Observing this, Jordan, who is driving to the same location and is nearby, sends a pick-up request through GUI 500 to Alex, offering a ride for the remaining distance. This gesture is facilitated by the application 112's functionality to communicate between participants and offer real-time solutions to improve the group's overall experience and convenience.

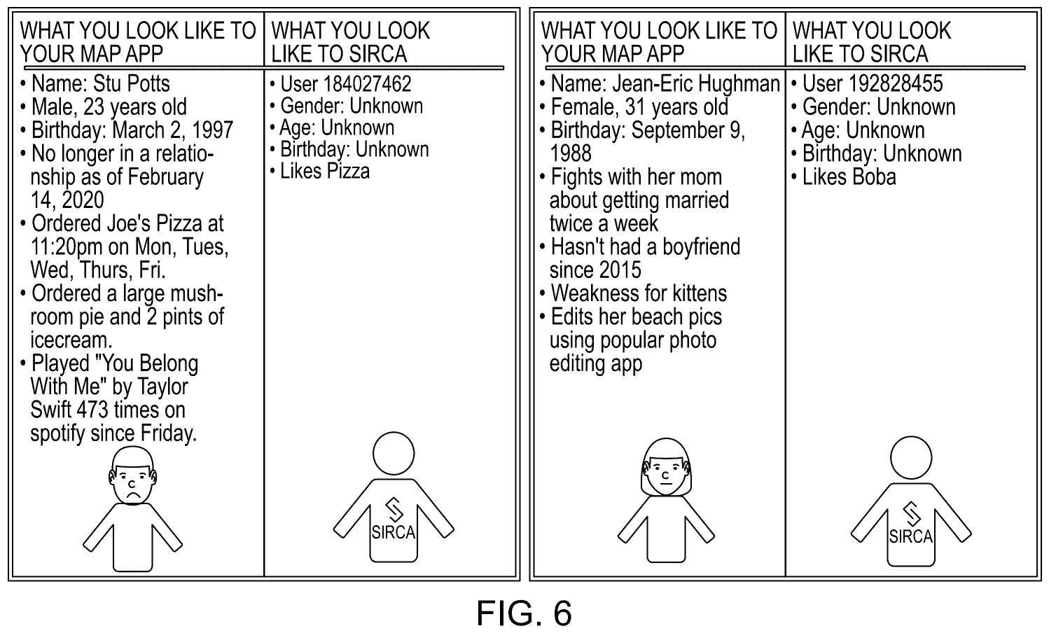

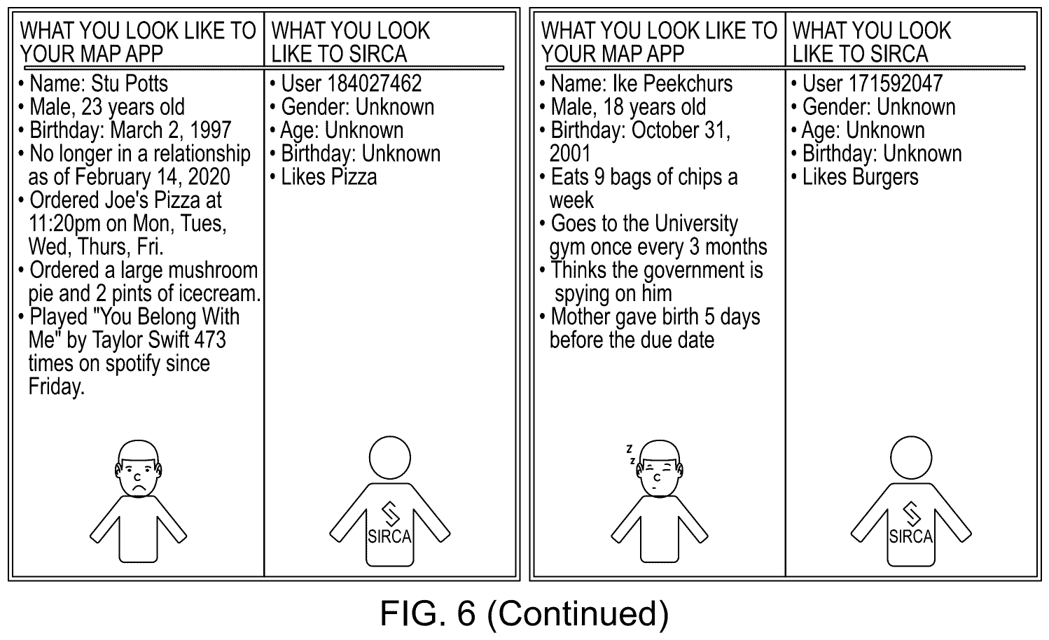

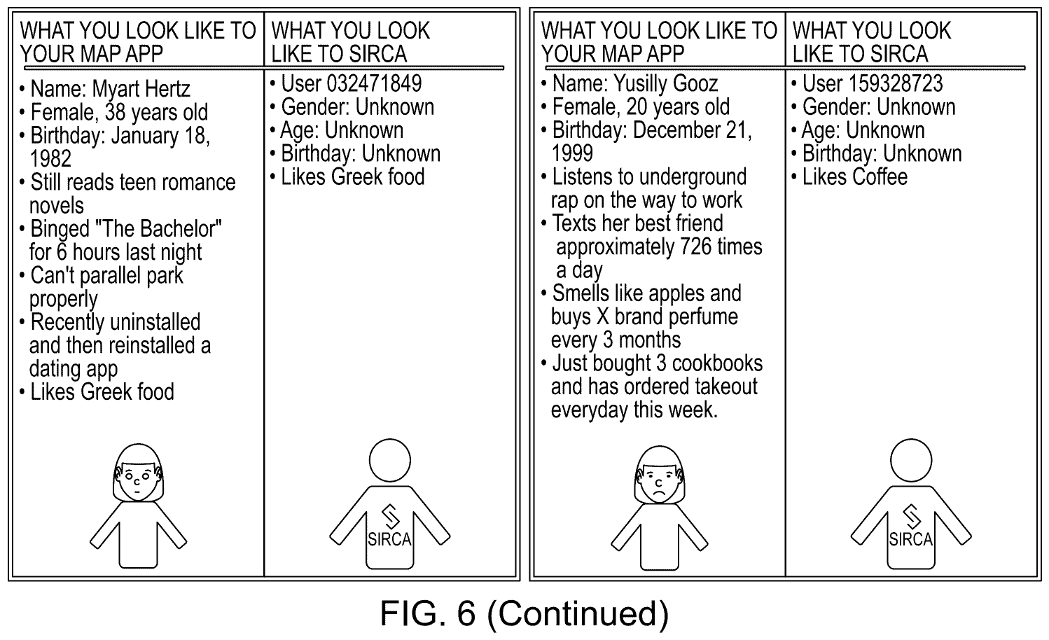

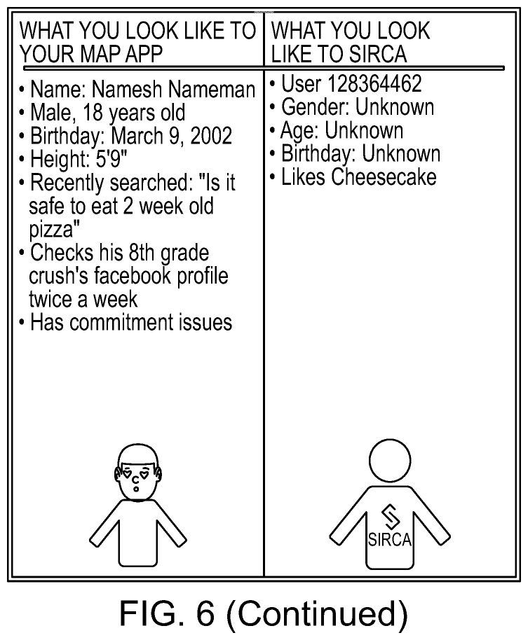

Referring now to FIG. 6, example illustrations of protecting data associated with link ups. As shown, information can be protected against other third-parties or other unknown parties when using link ups. The data protection framework allows individuals data to be protected and thereby improving security of mapping systems and collaboration applications. For example, typical map apps may include the user's name, gender, age, birthday, relationship status, previous actions (e.g., ordered pizza, type of pizza, other items order), previous music listed to, etc. However, the data protection framework described herein can anonymize or obscure the user, and protect various other data.

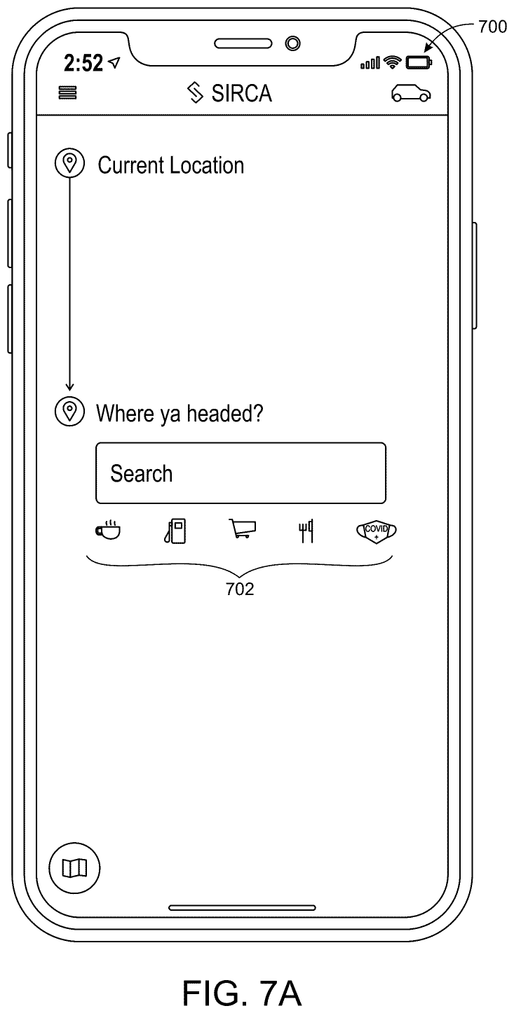

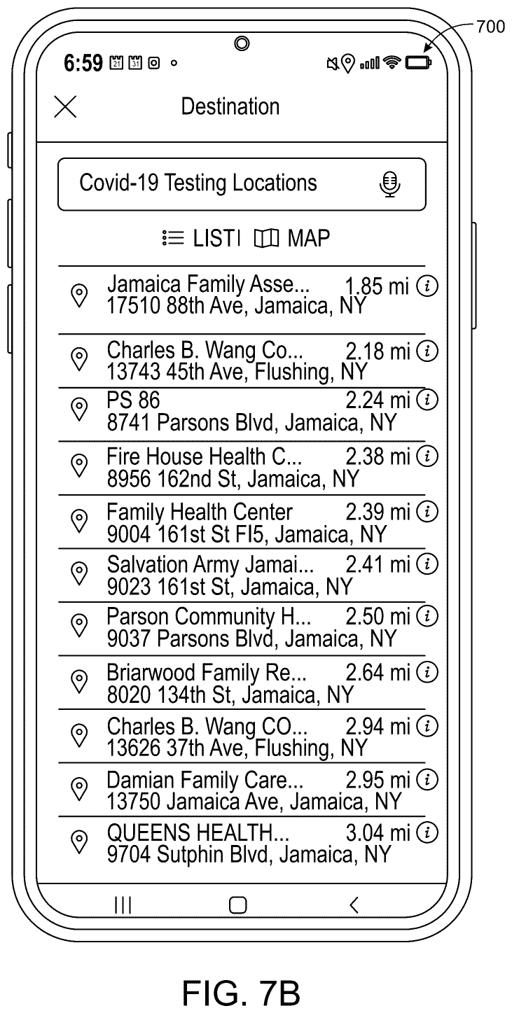

Referring now to FIGS. 7A-7B, example illustrations of a graphical user interface, according to some embodiments. FIGS. 7A-7B disclose a wildcard functionality of the link up application described herein. The graphical user interface 700 shown in FIGS. 7A-B can include a plurality of interactable elements 702 related to the various available wildcards. For example, in response to selecting a wildcard, the GUI 700 can be updated. For example, in FIG. 7B COVID-19 Testing Centers can be displayed. The wildcard functionality enables individuals to set locations of interest. For example, instead of general locations of interest including grocery stores and coffee shops, an individual can configure on their user account particular locations of interest such as COVID-19 testing sites, specific gas stations, specific grocery stores (e.g., a grocery store brand or groceries stores that sell a certain product, such as kombucha), specific coffee shops e.g., a coffee store brand or coffee shops that sell a certain drink, such as cortado), specific restaurants, specific type of beer (e.g., breweries that sells sours), etc. For each wildcard, the user can further configure populated results based on preferences. For example, stars of the locations (e.g., only above 4.5 stars), current wait time of the locations (e.g., present locations with an hour wait or less), locations that allow reservations, etc.

In some implementations, the wildcard functionality could extend to include time-sensitive events or availability, such as farmers' markets on weekends or happy hours at restaurants. That is, users could specify interest in events that occur only on certain days or at certain times, enabling the application to provide targeted recommendations that fit their schedules. For example, a user might configure their preferences to include outdoor concerts occurring on Friday evenings, ensuring they receive notifications or suggestions only for events that match this criterion. In another example, the functionality could allow users to set alerts for when a preferred location meets specific conditions, such as when a popular restaurant has no wait time or when a specific product is in stock at a nearby store. That is, the application could monitor these conditions in real-time and notify the user immediately, making the feature highly practical for time-sensitive or high-demand scenarios. For example, users could be alerted when a newly released book becomes available at their local library, enabling them to reserve it ahead of others.

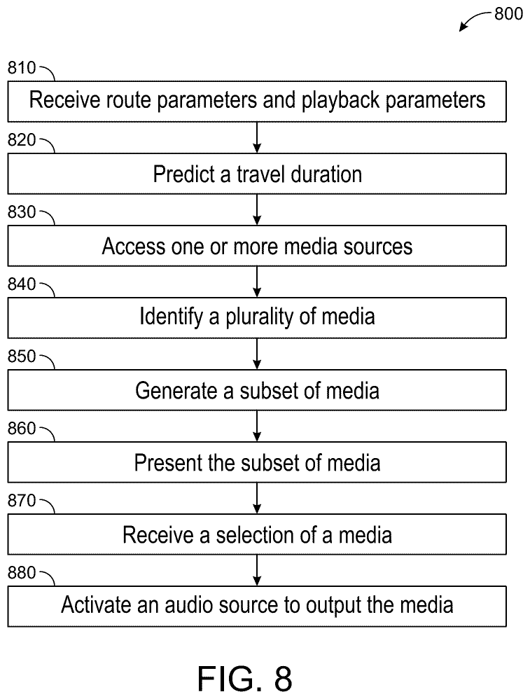

Referring now to FIG. 8, a flowchart illustrating a computer-implemented method 800 for recommending and/or playing media (e.g., audiovisual media) during navigation based on a predicted travel duration is shown, according to some embodiments. The system 100 may be configured to perform the method 800. Further, any computing device described herein can be configured to perform the method 800.

In broad overview of method 800, at step 810, one or more processors may receive route parameters and playback parameters. At step 820, the one or more processors predict a travel duration. At step 830, the one or more processors access one or more media sources. At step 840, the one or more processors identify a plurality of media. At step 850, the one or more processors generate a list of media. At step 860, the one or more processors present for display the list of media. At step 870, the one or more processors receive a selection of a media. At step 880, the one or more processors activate an audio source to output the media. Additional, fewer, or different operations may be performed depending on the particular arrangement. In some embodiments, some, or all operations of method 800 may be performed by one or more processors executing on one or more computing devices, systems, or servers. In various embodiments, each operation may be re-ordered, added, removed, or repeated.

At step 810, one or more processors of a user device receive route parameters and playback parameters. The route parameters may include a variety of data associated with a navigation route. Such data may include location information of the navigation route and a method of travel for the navigation route. Location data may include an initiation location of the navigation route, a destination location of the navigation route, an interim location for passing/stopping at between the initiation location and the destination location, and real-time (or near real-time) conditions of the navigation route (e.g., construction, tolls, traffic). The initiation location may be a current location, as determined by one or more positioning systems of the user's device (e.g., GPS). Additional information included in the location data may include additional stops along the navigation route, for example, the interim location may be a stop at a restaurant, a gas station, a tourist location, or a merchant. The location data may also include a time of day of travel and/or time of year of travel. For example, the location data may include a departure time or a desired arrival time. In some embodiments, the location data is received by the one or more processors as user input into the user device. In some embodiments, the location data is received from a standalone application running on the user device, such as a map or navigation application. The location data may be received through a network (e.g., the network 120 of FIG. 1). Returning to FIG. 8, the method of travel may be one or more modes of travel. For example, the method of travel may be, but is not limited to, by car, subway, walking, bike, public transportation, bus, airplane, ride-share, train, orbital vehicle, animal (e.g., a horse), ski, skate, sled, off-road vehicle, motorcycle, helicopter, ferry, tram, cable car, hot air balloon, personal transporter, jet ski, gondola, rickshaw, and/or boat.

The playback parameters received by the one or more processors may include one or more media attribute preferences and one or more playback rate thresholds. According to at least one embodiment, the media attribute preferences may be associated with a media history of the user or a user input and may include preferred media type (e.g., a podcast, a song, a music video, a movie, an audiobook, a spoken word file, a text-to-speech transcription, a voice recording, a voicemail, a lecture, a training video, a seminar, a presentation, a new broadcast, a sports commentary, a talk show, a predicted phone call, a radio broadcast), a preferred media content (e.g., sports, entertainment, music, science, engineering, art, a specific topic), authors/speakers (e.g., book authors, podcast hosts, news anchors, celebrities, sports players), length of media (e.g., less than 10 minutes, less than one hour, longer than 30 minutes), media source (e.g., music application, news application, a website, a video player application, a radio station), depth of content (e.g., broad overview of topics, deep dives into topics), time periods of media (e.g., the 1950's, the 2000's, contemporary, classical), genre of media (e.g., jazz, rock, classical), language of media (e.g., English, Spanish, Latin, ASL), closed captioning (e.g., media with closed captioning or media without closed captioning), amongst others. These preferences may be based on previously played audio/multimedia and may be stored in a user profile automatically. The media attribute preferences may additionally or alternatively be received from a user input or historical user preferences as determined by previous selections and adjustments received during media playback of different content. Historical user preferences, selections, and/or adjustments may be stored in a user profile in a remote electronic storage location or locally on the user device. Media attribute preferences may be associated with the initiation location, the destination location, and/or an interim location. In some embodiments, the media attributes are associated with a time of day of navigation. For example, a user's history stored in the user profile may include data that the user listens to financial updates in the morning when navigating from home to work and classical music in the evening when navigating from work to home. This bifurcated media preference may be used to recommend media based on the time of day and location of navigation.

According to some embodiment, the playback rate threshold(s) corresponds to a maximum media playback speed. For example, the playback rate threshold may be a 2× playback speed. In such embodiments, the maximum media playback speed would be 2×, or, in other words, played back at twice the default (e.g., non-adjusted) speed. Various types of media content may have varying playback rate thresholds. For example, music may have a playback rate threshold of 1× speed (e.g., the non-adjusted speed) to not interfere with the listening experience of the music. Podcast media, on the other hand, may have a playback rate threshold of 1.5× speed because the user may be able to retain the information while listening at a rate faster than the non-adjusted speed. Seminars or lectures may have a playback rate threshold of 2× speed. In some embodiments, the playback rate threshold may be slower than the non-adjusted speed. For example, the user may set in their profile that informational content (e.g., a seminar) may be played at 0.75× speed, to allow the user to more fully absorb the material. The various playback rate thresholds (which in some instances, may form a range of playback thresholds, such as a playback range extending from a minimum adjusted playback rate to a maximum adjusted playback rate) may be received by user input or historical user preference as determined by previous adjustments received during media playback of audiovisual media content. Though the term audiovisual media content is used in the description of the systems and methods herein, it is understood that audiovisual media content (and similar terms) may encompass audio content, video content, and/or a combination thereof. In some embodiments, the one or more processors receive and/or select default playback rates for various media content types.

It should be understood that in some implementations of the methods and systems described herein, step 810 need not include receiving route parameters. For example, the systems and methods described in method 800 need not apply to navigational embodiments, as described in further detail below. Rather, in some embodiments, the route parameters may be replaced with “wait parameters.” For example, the wait parameters may include data associated with a wait time. For example, a user may input into an electronic device an amount of time the user must wait until a next activity. In another example, the one or more processors may query one or more calendars, messages, voicemail, etc. for event or activity information with associated locations and/or times. In an example, a mother may be waiting to pick up her son from school. The activity “pick up son” may be in the mother's calendar at 4:00 μm. The one or more processors may receive the current time (e.g., 3:39 pm) and the calendar event time (e.g., 4:00 pm). These two times may be included in the received wait parameters. Likewise, the mother may input into the electronic device (e.g., through a stand-alone application not associated with navigation) how much time she has left before an activity (e.g., 21 minutes) without the processors accessing event information from a calendar or the like. This wait time may be included in the wait parameters. Thus, any discussion related to travel parameters/duration herein may also be applied to wait parameters/duration.

At step 820, the one or more processors predict a travel duration for the navigation route based on at least the method of travel. In some embodiments, the one or more processors estimate a time to travel from the initiation location to the destination location while traversing any additional interim locations. The one or more processors take into account the received mode of travel to determine the length of time to travel. In some embodiments, the one or more processors predict the travel duration based on real-time traffic data or route information (areas of high and low congestion with corresponding delays), construction data (e.g., road closures, detours, etc.), and toll data (e.g., toll amounts and options).

While in some embodiments the one or more processors predict the travel duration, it should be understood that one or more additional processors may also predict the travel duration and transmit the predicted travel duration to the one or more processors. For example, a remote server may execute one or more prediction protocols to predict the travel duration and transmit the predicted travel duration to the one or more processors of the user device. Indeed, the methods described herein may be executed by one or more processors that are located on the user device, on a remote server, distributed across multiple devices or servers, or any combination therein. In some embodiments, the predicted travel duration is a range of time (e.g., 30-40 minutes). The predicted travel duration may be based on real-time route information received from one or more traffic data sources. For example, the real-time route information may include detours, traffic, closures, congestion, etc.

In an embodiment, the mode of travel may be a commercial means of travel (e.g., a commercial airplane, a bus, a train, a subway, etc.). In such embodiments, the predicted travel duration may be additionally, or alternatively, based at least in part on the scheduled departure time and/or the scheduled arrival time.

As discussed above, in some embodiments, the method 800 is not associated with a travel time, but rather a wait time. In such embodiments, the one or more processors determine a wait duration in place of a travel duration. For example, in the example provided above in which the current time is 3:39 pm and the mother is picking up her son at 4:00 μm, the wait duration (as opposed to the travel duration) may be determined (e.g., 21 minutes). This allows a user (e.g., the mother) to take advantage of the methods and systems described herein in situations beyond traveling (e.g., when sitting in a pick-up line at school).

At step 830, the one or more processors may access one or more media sources. The media sources may be associated with one or more media content platforms, such as Netflix®, YouTube®, Hulu®, Amazon Prime Video®, Disney+®, Spotify®, Apple Music®, and SoundCloud®. Additional media content platforms may include media databases (e.g., data sources 160 of FIG. 1) hosted remotely or local to the one or more processors. The media databases may host media files for access, retrieval, and/or playback by the one or more processors.

At step 840, the one or more processors identify from the one or more media sources, a plurality of media having one or more media attributes matching the one or more media attribute preferences. According to an embodiment, the one or more processors may run one or more computer comparison protocols to compare media attributes of individual or bulk media stored in the one or more media sources to the received media attribute preferences. Likewise, various filtering techniques may be used to filter the media within the one or more media sources based on the one or more media attributes. Upon a media having one or more media attributes that satisfy the received media attribute preferences, the one or more processors identify the satisfying media as having one or more media attributes matching the one or more received media attribute preferences. In one embodiment, the one or more processors identify media within the media sources that match a preferred media type. The media may be filtered based at least on access to the media by the user, such as through the use subscriptions or available content. For example, the processors identify content and/or audio that matches a genre preference and that the user has access to and permission to play (e.g., through a music subscription).

At step 850, the one or more processors generate, from the plurality of media, a subset or list of media. In one embodiment, each media within the list of media can share one or more common attributes. In an exemplary embodiment, each of the media within the generated list of media has a minimum playback duration (e.g., a minimum length of time to playback the media at a maximum playback rate) within a playback range, such as a playback range correlating to a trip listen duration and/or the predicted trip duration.

In some embodiments, the predicted trip duration corresponds to a temporal estimate for a navigational route, based on one or more travel-related parameters such as method of travel, departure time, and real-time route conditions including traffic or construction data. The predicted trip duration may be calculated by the system or received from a third-party source, and in some embodiments may comprise a range (e.g., 25-35 minutes). This prediction forms the basis for various downstream operations, including media identification and playback.

The trip listen duration may correlate or correspond to a playback interval within the predicted trip duration, and in various embodiments, the trip listen duration is derived from or correlates with the predicted trip duration. For example, in some embodiments, the trip listen duration is calculated by subtracting from the predicted trip duration one or more interruptions, such as scheduled advertisements, navigation instructions, or interspersed announcements, thereby resulting in a refined temporal window suitable for uninterrupted playback of audiovisual media. The trip listen duration may also be modified based on user preferences or system-imposed constraints, such as a user-specified minimum media length or a playback threshold.

In an exemplary embodiment, the system may predict a travel duration of 18 minutes based on route inputs and traffic data. If the system determines that 2 minutes will be occupied by turn-by-turn navigation prompts and/or sponsored content and an additional 1 minute by advertisements under a free-tier subscription, the remaining 15 minutes may define the trip listen duration. Media selection operations may be bounded by this trip listen duration, such that the playback duration of any selected media (e.g., an adjusted duration at a maximum allowable playback rate) does not exceed the trip listen duration. This ensures that selected media can be fully consumed within the confines of the adjusted playback window.

In some embodiments, each media has multiple playback durations. For example, a media may have a non-adjusted playback duration, a minimum playback duration, a maximum playback duration, and/or an adjusted playback duration. The non-adjusted playback duration may correspond to a playback length of the media at a non-adjusted (e.g., default) playback rate (e.g., a playback speed). In an exemplary embodiment, the non-adjusted playback rate is 1× speed. This may be considered the default speed that the media is output at, either by way of a playback setting or an attribute of the media file.

The media may also have a minimum playback duration. The minimum playback duration may correspond to a shortest playback length of the media, based on the media being output at a maximum playback rate (e.g., a maximum playback speed). In an exemplary embodiment, the maximum playback rate is 2× speed. In some embodiments, as discussed above, varying media types and/or contents may have varying maximum playback rates. In at least one embodiment, the maximum playback rate corresponds with the playback parameters received in step 810.

The maximum playback duration may correspond to a longest playback length of the media based on the media being output at a minimum playback rate (e.g., a minimum playback speed). In an exemplary embodiment, the minimum playback rate is 0.75× speed. In some embodiments, varying media types and/or contents may have varying minimum playback rates. The minimum playback rate may correspond with the playback rate threshold received in step 810.

The adjusted playback duration may correspond to an adjusted playback length based on the media being output at an adjusted playback rate (e.g., an adjusted playback speed). The adjusted playback rate may be any playback speed multiplier for increasing or decreasing the playback speed of media, but in an exemplary embodiment, the adjusted playback rate is within the minimum playback rate and the maximum playback rate. The one or more processors may determine the adjust playback duration based at least in part on adjusting the non-adjusted playback rate of the media to the adjusted playback rate. The adjusted playback rate may be equal to or less than the maximum playback rate threshold. The adjusted playback rate may be equal to or greater than the minimum playback rate threshold.

It should be understood that the media may have one or more playback durations that are the same length. For example, in some embodiments, the maximum playback rate of music may be the same as the non-adjusted playback rate (e.g., 1× speed multiplier) of music, as it may be preferable to not increase the playback rate of music. In such embodiments, the non-adjusted playback duration and the minimum playback duration may be the same. Likewise, the minimum playback rate may be the same as the non-adjusted playback rate and the maximum playback rate. In such embodiments, the maximum playback duration, the non-adjusted playback duration, and the minimum playback duration may be the same length.

In some embodiments, the playback range (e.g., the trip listen duration) extends from a lower limit to a higher limit. In various embodiments, the lower limit is 0 minutes, and the higher limit is the predicted travel duration (or the higher/lower predicted travel duration within the range of values). In some embodiments, the lower limit may be longer than 0 minutes and may be received by the one or more processors as a user input/preference (e.g., at least half the predicted travel duration).

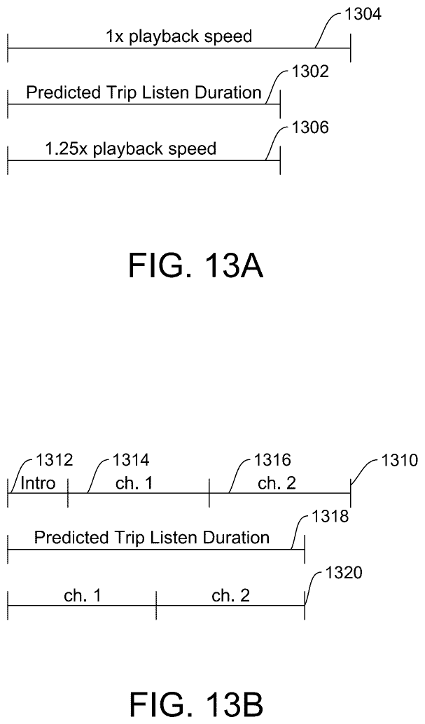

FIG. 13A illustrates, in at least one embodiment, the adjusted playback rate effect on playback duration. The one or more processors may predict a trip listen duration (which may correlate to a determined predicted travel duration 1302) based on the route parameters received for navigation and/or the length of sponsored media for output during navigation. A non-adjusted playback duration 1304 of a media when played at a 1× playback speed is shown as being longer than the predicted travel duration 1302. In other words, the media will not be able to be completely outputted during the predicted travel duration 1302. However, an adjusted playback duration 1306 at a playback speed of 1.25× may fit within the predicted travel duration 1302. As shown in FIG. 13A, the adjusted playback duration 1306 is equal to or less than the predicted travel duration 1302.

In some embodiments, the predicted trip listen duration is continually updated along a navigation route to adjust the playback rate of the audio to fit within the trip listen duration. For example, as the user proceeds along the navigation route, the one or more processors may predict a faster than originally planned travel duration which may additionally result in a shorter trip listen duration. In such embodiments, the one or more processors may further adjust (e.g., increase) the playback rate of the media up until the maximum playback rate threshold to account for the updated travel duration. In some embodiments, the one or more processors may present for display on the user device a selectable element to manually adjust the playback rate in response to change in the travel duration and/or the trip listen duration. Upon receiving a selection of the selectable element, the one or more processors may adjust the playback rate of the media to a speed multiplier that allows for the completion of the media (or segment of the media) within the trip listen duration. In some embodiments, the selection may indicate that the speed multiplier must exceed the maximum playback speed threshold to finish within the trip listen duration. In other embodiments, the speed multiplier is limited to the playback speed threshold. The one or more processors may receive a request to change the media based on the updated predicted travel duration and/or the updated trip listen duration. This may include changing the media from a first media (e.g., a podcast) to a second media (e.g. song).

In some embodiments, the one or more processors generate the list of media without first identifying a plurality of media having one or more media attributes. In such embodiments, the one or more processors may have not received any media attribute preferences and the one or more processors generate a list of media with each individual media within the list of media satisfying the minimum playback duration, regardless of the media attributes.

When determining minimum playback durations, the one or more processors may take into account predetermined segments of the individual media. For example, when determining whether a minimum playback duration of an audiobook fits within an estimated or predicted travel duration, the one or more processors may look to individual chapter lengths. Individual chapters may be considered predetermined segments of the media, likewise, author- or publisher-created chapters for podcasts, videos, performances, and/or lectures may be considered predetermined segments of the media. The one or more processors may consider individual chapter lengths (e.g., whether at the non-adjusted playback rate or the adjusted playback rate) as a “minimum playback duration” when determining whether the media can be played back during the predicted trip listen duration.

As shown in FIG. 13B, in some embodiments, the one or more processors remove one or more segments from playback to reduce the minimum playback duration. For example, a common introduction or outro for every episode of a podcast may be removed to reduce the minimum playback duration. Alternative examples include removing a preface/forward from an audiobook for a user that often skips the preface/forward. The one or more processors may access the user's listening history to extract trends (e.g., skipping the preface) to cause the removal of certain segments from playback. As shown in FIG. 13B, duration 1310 of a portion of an audiobook is shown comprised of an introduction 1312, a chapter 1314, and a chapter 1316. As shown by the predicted trip listen duration 1318, the duration 1310 is longer than the predicted trip listen duration 1318. To reduce the duration 1310, the system removes the introduction 1312 (based on past trends by the user) from being outputted and a resulting duration 1320 (without the introduction 1312) is within the predicted trip listen duration 1318. The one or more processors, in response at least in part to adjusting the playback duration of the media to within the predicted trip listen duration 1318, presents for display (or otherwise causes the display) of the media on the user's device for selection. In some embodiments, the system removes segments or portions (e.g., as shown in FIG. 13B) in combination with adjusting the playback speed of the media (e.g., as shown in FIG. 13A).

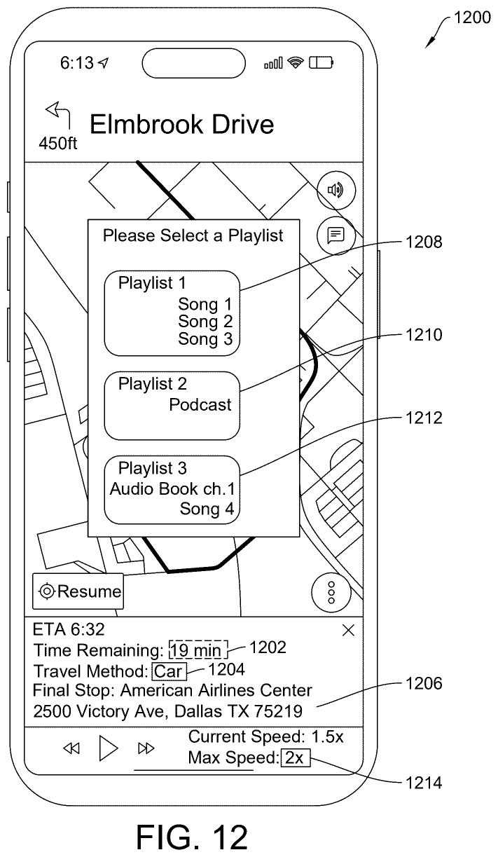

At step 860, the one or more processors present for display on the user device, the list of media via a GUI or AUI (auditory user interface) of an application executed by the one or more processors. In one embodiment, the list of media is presented on the GUI as selectable graphical components. The list of media may be presented for display with various media attributes associated with the media. For example, the media attributes may include the various playback durations (with corresponding playback rates), genre, title, author, host, description, etc. Referring now to FIG. 12, a GUI 1200 for presenting the generated list of media during navigation is illustrated, according to some embodiments. The GUI 1200 includes media cards, shown as media card 1208, 1210, 1212 each representing a distinct list of content that has a total playback duration (whether adjusted or non-adjusted) within a predicted trip listen duration. Each media card 1208, 1210, 1212 may include a title, a playback duration (e.g., “15 min at 1.25×”), and a corresponding icon representing the type of content (e.g., podcast, audiobook). The GUI 1200 further includes a playback rate selector 1214, allowing the user to adjust/set a maximum (or minimum) playback rate preference before or during playback of content. In some embodiments, the user may set different playback thresholds for different formats of content. The GUI 1200 also presents route parameter 1206 (e.g., the destination location) and/or the predicted travel duration 1202 (e.g., “19 minutes remaining”), which provides the user with context to determine which media may be completed during the trip. The GUI 1200 may include one or more selectable elements for setting one or more of the route parameters (e.g., the destination location) and/or the playback parameters (e.g., the travel method 1204). The GUI 1200 is dynamically responsive to changes in trip duration or user input, updating the media list in real-time to reflect the most relevant playback options. The media cards may include one or more individual media or segments thereof. For example, the media card 1208 includes three songs, the media card 1210 includes a single podcast, and the media card 1212 includes an audio book chapter and song.

At step 870, the one or more processors receive a selection of a media (e.g., the media card 1208 of FIG. 12) from the list of media. The selection may be made and received as a user input by the one or more processors. At step 880, in response to receiving the selection of the media from the list of media, the one or more processors activate an audio source of the user device or an external device to output the media from the list of media. The user device may be the client device 110a of FIG. 1. The external device may be a vehicle or other audio playback device, such as an audio transducer (e.g., a speaker, headphones, etc.). In various embodiments, the one or more processors activate the audio source to output the media at a playback rate equal to or less than the playback rate threshold, thereby reproducing the entire media file within the predicted travel duration at a speed within the playback rate threshold.

By way of a non-limiting example, the one or more processors may receive a user input of a playback rate threshold of 1.5× speed for playing podcast episodes (a preferred media attribute of a user associated with the one or more processors). After receiving a method of travel (e.g., travel by car) and an initiation location and a destination location, the one or more processors determine a navigation route between the initiation location and the destination location. The one or more processors predict the duration of travel to be 1 hour, based on real-time traffic conditions, length of navigation route, and average speeds of a car (or historical speeds of the user). The one or more processors access various media sources associated with a user profile associated with the one or more processors. Upon accessing the various media sources, the one or more processors identify various media files satisfying the preferred media attribute (e.g., podcast episodes). Upon identifying various media files satisfying the preferred media attribute, the one or more processors then determine a minimum playback duration of each of the various media files satisfying the preferred media attribute by adjusting a non-adjusted playback duration of each media file to the playback rate threshold of 1.5× speed and determining a resulting playback duration.

The one or more processors then generate and present for display a list of the media files that have a minimum playback duration equal to or less than the predicted travel duration. In presenting media files that have a minimum playback duration less than the predicted travel duration, any of the presented media files may be chosen and completely reproduced within the predicted trip listen duration. The system, may also provide a combination of media that in the aggregate sum to equal to or less than then predicted trip listen duration. Once a selection of one or more of the presented media files is received by the one or more processors, the one or more processors cause the media file to be acoustically and/or visually output at a playback rate. In some embodiments, the one or more processors reproduce the media file at the non-adjusted (or other default) playback rate if the non-adjusted (or other default) playback duration is within the predicted travel duration. If the non-adjusted playback duration is longer than the predicted trip listen duration, the one or more processors may reproduce the media file at an adjusted playback rate, the adjusted playback rate being the minimally increased rate such that the adjusted playback duration is equal to or less than the predicted trip duration. In some embodiments, the predicted trip listen duration is continually updated (e.g., at periodic intervals) during the user's navigation along the navigation route (as determined by the one or more processors) and the one or more processors continually adjust the adjusted playback rate of the media file (up to the playback rate threshold) such that the adjusted playback duration is maintained within the updated predicted travel duration while remaining under the maximum media playback speed. Some embodiments utilize a filtering of the predicted travel duration to avoid jumps in playback rate adjustments. Likewise, the playback parameters may include one or more attributes of the playback adjustments to not allow the one or more processors to adjust the playback rate above a certain rate of change of the playback rate (i.e., increasing or decreasing the playback rate too fast).

In some embodiments, the system provides for display on the user device an alternative media (e.g., a different playlist, song, podcast, etc.) based at least in part on the updated predicted trip listen duration. For example, if the predicted trip listen duration is longer than the original predication (e.g., based on traffic), the system may present for display an option for the user to add an additional chapter to the selected media to output. Similar playback rate adjustments may be made to the added media, as described above. The user is able to select an interactive element displayed on the user device associated with the new media. A selection of the interactive element may transmit an indication to the system to include or change the media associated with the interactive element (e.g., the additional media described above).

Additionally, the systems and methods described here allow for improved sharing of audiovisual content to parties within a group by providing multiple users within a group with a single audiovisual media to consume during travel to a common destination while ensuring that each of the users is able to completely consume the audiovisual media during their respective navigations to the common destination.

In such embodiments, the one or more processors are configured to receive a plurality of route parameters and a plurality of playback parameters associated with users within a group. The one or more processors determine a predicted travel duration for each of the users within the group to travel to the common destination. The predicted travel duration for each user is based on the received plurality of route parameters and plurality of playback parameters associated with each individual user within the group. Upon identifying the predicted travel duration of all the users within the group, the one or more processors determine a minimum predicted travel duration corresponding to the user who has the shortest predicted travel duration. The one or more processors then generate a list of media with an associated minimum playback duration within a second playback range. The second playback range may correspond to the minimum predicted travel duration, as described above. This list of media is transmitted to an electronic device of each user within the group, thus allowing each in the group to completely listen to the same media prior to arriving at the common destination. In some embodiments, one of the users in the group selects a media to share with all of the users in the group. In some embodiments, the one or more processors may access a calendar or schedule to determine a meeting and suggest media for playback to all participants in the meeting based on the systems and methods described herein. In some embodiments, the list of media is transmitted to a single user (e.g., an inviter device that initiates a link up, as described herein). The user may select the list of media on the user's device. Upon receipt of the selection of the list of the media, the one or more processors may transmit the list of media to the one or more of the plurality of users (e.g., the link up invitee devices). The one or more of the plurality of invitee devices to which the list of media is transmitted may then select to output the transmitted list of media, after which the list of media is outputted to one or more output devices associated with the one or more plurality of users.

In additional embodiments, the methods and systems discussed herein may include recommendation and/or outputting corporate-sponsored media content (also referred to herein as directed media) to recommend and present to a user through one or more electronic devices configured for audio/media playback. By way of a non-limiting example, a user selects a destination location to which to travel. The user may select the location on a standalone navigation application, a standalone media playback application, or an integrated navigation/media playback application. The user may use gestures, voice commands, hardware input, etc. to select the destination location. In addition to the destination location, the user may select an initiation location (e.g., a location from where to initiate travel), an interim location (e.g., a location to pass from the initiation location to the destination location), and a mode of travel. As described above, a system may receive these selections and determine a navigational route (and corresponding estimated travel duration) from the initiation location to the destination location while passing through any interim locations. The navigational route may be chosen and proposed based on a minimum travel duration, a minimum travel distance, a minimum carbon output, a minimum elevation change, and/or may include several sponsored locations between the initiation location and the destination location (e.g., the system may alter the navigation route to pass by sponsored locations or location with sponsored content/media).

Upon or after determining the navigational route, the system determines whether or not the navigation route is associated with any sponsored media. In other words, the system determines whether the route passes by any locations associated with sponsored media. The locations may include the initiation location, the destination location, the interim location, and/or any location along (or near) the path. In an example, the user may select a theatre for a destination location. An entity associated with the chosen theatre (e.g., an owner of the theatre, an owner of a production being performed at the theatre, a director of a production being performed at the theatre) may create and post content associated with the theatre or the production being performed. The system may transmit a request for, and receive a response of, an indication from a server or electronic storage location of a list of events (with corresponding times and locations) occurring at the theatre and identify sponsored media corresponding to an event occurring at a time near an estimated arrival or departure time. Alternatively, the system may automatically receive the sponsored media upon transmitting the navigation route to a second server.

The sponsored media may be any media, but in an embodiment, it may contain historical or informational data related to the location. In the embodiment in which the user is navigating to the theatre, the sponsored media may include information about the production being put on at the theatre. This data may include audio or audiovisual information about the director, author, cast, history, schedule, and/or sponsors of the production. Thus, allowing a user to listen and/or view relevant background information prior to arriving at the destination. While a theatre is used in the exemplary embodiment, it should be understood that the sponsored media may relate to any location or event, including a movie theatre, a sporting event, a seminar, a meeting, a symposium, a restaurant, a banquet, an awards event, a business, etc. Likewise, the sponsored media may include advertisements of locations along the route of the user.

In some embodiments, the system may access the user's calendar or schedule to determine an event to which the user is navigating. The system may search for sponsored media associated with the event and present for selection any identified sponsored media on the user device.

Upon receiving the sponsored media, the system determines if a minimum playback duration of the sponsored media falls within a playback range (e.g., the trip listen duration). The minimum playback duration may, as described herein, relate to a playback duration at a maximum playback speed, as determined by the user's playback parameters and/or preferences. Responsive to the sponsored media having a minimum playback duration within the playback threshold (the playback threshold corresponding to the estimated travel duration to travel along the navigation route), the system presents the sponsored media for selection. The system may present the sponsored media (with or without an indication of its sponsored status) as an interactive graphical component on a display of the user device, configured for selection by the user. Additionally or alternatively, the system may access one or more user attributes in a user profile associated with the user to determine whether or not to automatically select to play the sponsored media. For example, the user may pay for a subscription tier to not receive sponsored content/media, in which case the user may have a subscription attribute related to the chosen subscription service. In such embodiments in which the user selects the subscription service (and has a corresponding subscription attribute), the system receives the indication of the subscription attribute and does not automatically select the sponsored content for playback. In such embodiments, the system may still present the sponsored media for the user to select. In other embodiments, the user is not presented with the sponsored media if the user has a subscription attribute. If the user profile does not have the subscription attribute, the system may automatically select the sponsored media for playback.

Upon receiving the selection (either automatically by the system or from the user device), the system activates an audio source of the sponsored media of the user device or an external device (e.g., a speaker or automobile sound system) to output the sponsored media. In some embodiments, the system activates the audio source upon receiving an indication that the user has begun travel along the navigation route. This indication may come from a user selection of a “Begin Navigation” graphical element on the user device, a vehicle that begins traveling along the navigation trajectory, or from the user device determining that it is traveling along the navigation route. The sponsored media may be played at an adjusted playback rate as described herein, while ensuring that the playback rate does not exceed the maximum playback rate (e.g., a user preference associated with the fastest playback rate allowed).

In various embodiments, the sponsored media is corporation-sponsored content or media. Additional embodiments may include a restaurant sponsoring a directed media related to its menu and/or specials, the Emmy's sponsoring a directed media related to the nominees, a corporation sponsoring a directed media related to its business offerings, a university sponsoring a directed media related to its different programs, a sports team sponsoring a directed media related to the team's performance during the season; a developer sponsoring a sponsored media related to a new property development nearby, etc.

It is understood that while the destination location may be associated with sponsored media, locations along the navigation route may also be associated with sponsored media. For example, when driving by a new property development, the system may automatically play a sponsored media related to the upcoming offerings in the new property development (e.g., a price and square feet of a new home for sale). In some embodiments, the systems and methods herein may include directional information as well. For example, the processors may determine a direction of travel based on the route parameters, current and/or past location data, or sensor data (e.g., image data from one or more cameras). In such embodiments, the system may automatically play a sponsored media related to the upcoming offerings in the new property development but include directional information (e.g., “If you look to your right, you will see the new property development Shady Acres with new builds for sale and starting at $300,000.”).

In some embodiments, the sponsored media (e.g., directed media) received and output by the one or more processors may be associated with a location within a specified range of the navigation route, wherein the range is defined in terms of time or distance relative to the user's current or projected position along the route. For example, the range may correspond to a predetermined distance radius (e.g., 0.5 miles) from a geographic point along the route, or alternatively, a temporal threshold (e.g., within the next five minutes of travel, within five minutes of the navigation route, etc.). The one or more processors may compare the user's real-time location or predicted arrival time to the range associated with the directed media to determine whether to trigger playback. In this manner, the system dynamically presents contextually relevant media (e.g., promotional audio for a nearby business or informational content about an upcoming landmark) at the appropriate time or location during the trip, enhancing engagement and ensuring temporal or spatial alignment between the directed media and the user's progression along the route.

In some embodiments, the sponsored media may be content that is contextually linked to one or more of the initiation location, destination location, interim location, or to specific events occurring at or near those locations. The event may correspond to one or more of an emergency event, a sporting event, an arts event, an educational event, a business event, a traffic event, or a personal event For example, the directed media may include promotional or informational content related to a business, attraction, or event situated at the destination or along the navigation route. In particular, the system may utilize geofencing logic to establish virtual perimeters around the initiation, interim, or destination locations and to monitor when the user device enters, exits, or remains within such virtual perimeters. Upon entering a geofence boundary, the system may trigger the delivery of a directed media file, such as an audio advertisement or event announcement, and may further cause a user interface to present a related coupon, discount, or offer associated with the geofenced location. In some embodiments, the geofence may be defined in real-time based on user preferences or subscription parameters, and the directed media may be filtered or prioritized according to predicted arrival times or location-based relevance. The system may ensure that the associated media is played within an optimized playback window such that the media is completed before the user reaches the geofenced location and/or while the user is within the geofenced location.

For example, a user navigating to a downtown area for a food festival may pass by an interim location that includes a participating restaurant. As the vehicle approaches the geofenced boundary surrounding that restaurant, the system may identify a corresponding directed media file containing an audio message from the restaurant offering event-specific promotions. Upon determining that the restaurant is within range and that the audio playback duration fits within the trip listen duration, the system may activate the user's audio device to output the promotional message. Simultaneously or thereafter, the user's device may present a visual coupon-such as a digital voucher for a free appetizer—that may be redeemed upon arrival. This allows businesses to engage travelers with timely, location-aware promotions and allows users to receive context-specific offers that are automatically aligned with their route and predicted arrival window. In some embodiments, the system takes into account the length of the audio when determining the trip listen duration so as to account for the length of the sponsored media when identifying media to include in the list of media to present to the user at the beginning of the trip.

In some embodiments, the systems and methods described herein may be implemented by an event organizer (e.g., a sports team, a theatre, a governing entity, a restaurant, etc.) to enhance the travel and media experience of individuals en route to a shared destination. In one example embodiment, a sports team organizing a home game may serve as the central entity (“organizer”) and utilize an inviter organizer device (also referred to herein as an organizer device). The inviter device plans a link up request (as described in greater detail herein) to provide curated audiovisual content (e.g., coupons, advertisements, information, navigation instructions, etc.) to patrons traveling to, and within, the sporting venue. The organizer may define a destination location corresponding to the event venue and transmit a digital invitation (e.g., a link up) to a plurality of user devices (e.g., invitee devices), prompting each user to initiate navigation to the destination via a preferred route. In some embodiments, the inviter device accesses a database of user preferences associated with the invitee devices. For example, the database may have data showing invitee devices associated with users who follow or like the sports team, or have previously visited the sporting venue. The system may use this information to target the link up request transmission to those invitee devices that have the above-mentioned connections to the sports team or sporting venue. The organizer may further define one or more interim locations or suggest specific travel paths for routing fans past sponsored zones or promotional stops. As users begin their trip, the system receives route parameters and playback parameters from each device and predicts a travel duration for each attendee. In response, the organizer may generate a list of directed media—such as a pre-game commentary, player interviews, or promotional partner content—and cause the system to deliver that media to user devices in a manner that fits within the users' respective trip listen durations, utilizing, for example, playback rate thresholds of the invitee devices.

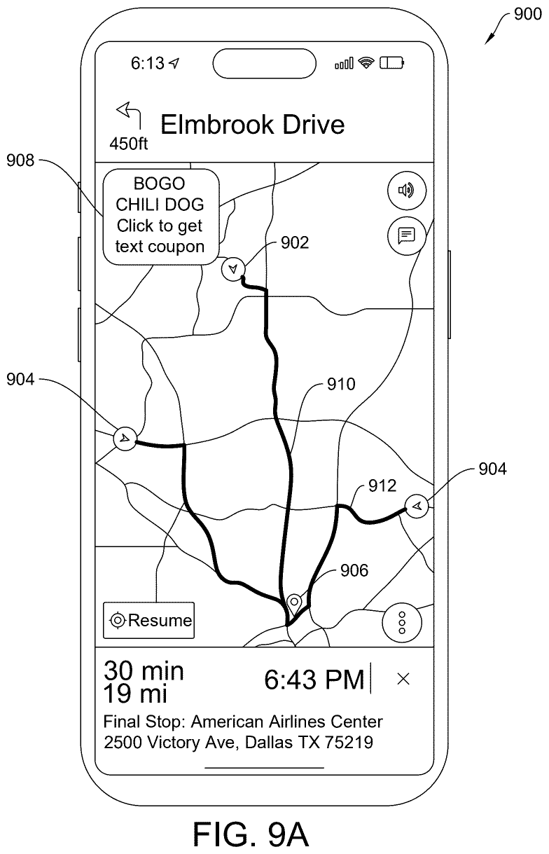

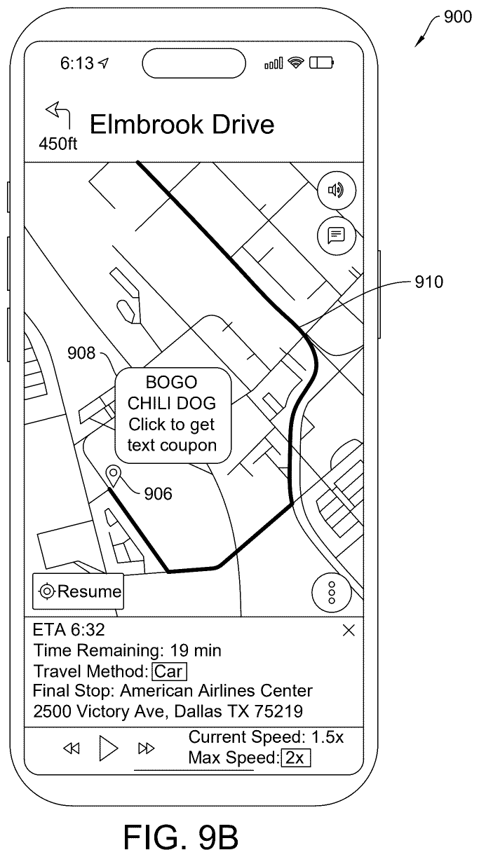

Referring now to FIG. 9A, an illustration of an example graphical user interface (GUI) 900 is shown in which a directed media (also referred to herein as sponsored media) is presented on the user device based at least in part on the route parameters and/or proposed navigation route. The GUI 900 may be presented on a display of a user device (e.g., the inviter device and/or the invitee device) and is configured to facilitate navigation and media interaction within a group session associated with the link up session. In the embodiment illustrated, the GUI 900 presents navigation information in a map-based format and includes a navigation route 910, 912, as well as participant details for one or both of the organizer/inviter device 902 and invitee devices 904 navigating to a common link up location 906.

The map display includes a visual indication of the organizer device 902 and one or more invitee devices 904. The devices are represented as distinct icons on the map, each showing real-time or predicted positions of participants in the navigation session. The link up location 906 is displayed near the bottom of the screen (though it is understood that the link up location may be located at a position on the GUI 900) and corresponds to a common destination point—in this example, the American Airlines Center in Dallas, TX—as shown in the trip summary panel.

A directed media element 908 is presented. This directed media may include time- or location-sensitive promotions, such as a buy-one-get-one (BOGO) offer for chili dogs at the link up location 906. The message in the directed media element 908 includes a call-to-action (e.g., “Click to get text coupon”), allowing the user to redeem the offer or receive additional details. The directed media may be triggered based on proximity to a specific venue or sponsor along the route.

Two distinct navigation paths are shown: an organizer navigation route 910, which indicates the planned path of travel for the organizer device 902, and an invitee navigation route 912, which corresponds to the predicted or actual path taken by an invitee device 904. These routes may be calculated independently based on each participant's starting location, mode of travel, and environmental conditions such as traffic or road closures.

At the bottom of the interface 900, a trip summary panel displays estimated travel metrics including time remaining (“30 min”), distance remaining (“19 mi”), and an estimated time of arrival (“6:43 PM”). The panel also includes the final stop location in textual format. In some embodiments, the GUI 900 may update dynamically during travel, adjusting route paths, participant positions, and media display elements in response to changes in traffic, location, or user preferences. The interface may also support interaction, such as tapping on a participant icon to view additional details or initiating communication between group members.

While the GUI 900 is shown in FIG. 9A for a group navigation to the link up location, it is understood that the methods described in FIG. 9A may be applied to instances where a single user is navigating to a location, such as shown in GUI 900 of FIG. 9B.

In some embodiments, the systems and methods described herein may include a tiered subscription model in which users can selectively avoid the presentation and/or playback of sponsored media based on a subscription level associated with their user profile. In such embodiments, the system may associate each user with one of a plurality of subscription tiers, each tier conferring certain entitlements and playback preferences, including whether or not sponsored media is presented during a navigational or wait-based media session.

In an exemplary embodiment, a base (or free) tier may be associated with automatic presentation of sponsored media. In such a configuration, sponsored media may be selected and output by the system during playback windows, subject to the same playback rate constraints and duration fitting as other media selections. For example, when the system determines a predicted travel duration and identifies a sponsored media file whose minimum playback duration fits within that duration, the system may automatically select and activate an audio source to output the sponsored content during the trip. However, in other embodiments, the adjusted playback rate applied to selected media is not applied to sponsored media, thereby ensuring that the sponsoring entity has control over how the sponsored content is presented (e.g., at a non-adjusted playback rate).

In contrast, a premium tier, which may be paid for by the user, may be associated with an opt-out attribute that suppresses the automatic presentation of sponsored media. In some embodiments, this opt-out attribute is stored as a subscription attribute in a user profile and may be referenced by the one or more processors when evaluating media options during playback planning. Upon detecting the opt-out attribute, the system omits sponsored media from consideration, including from display and playback queues, as well as the determination of trip listen duration. In some embodiments, the system may continue to access sponsored media metadata but will not present such content to the user unless explicitly requested.

In other embodiments, a mid-tier subscription may include conditional access to sponsored media, such as the ability to preview, filter, or selectively opt in to playback. For example, a user associated with a mid-tier subscription may be presented with a notification that sponsored media is available for the current trip, but the user must manually select the media for playback. In such implementations, the system may distinguish between automatic selection and user-initiated selection based on the subscription tier.

In additional embodiments, the directed media element 908 may be presented with a visual indicator identifying its nature (e.g., “sponsored” badge or overlay), and the system may enforce tier-specific rules governing whether such media is played, displayed, or bypassed. For instance, the system may detect that a user has a premium-tier subscription, determine that sponsored media is available and fits within the predicted travel duration, and in response to the premium tier attribute, suppress both the automatic playback and the graphical representation of that sponsored media within the media selection GUI.

Accordingly, the subscription tier system enables users to control their exposure to sponsored content during navigational or idle periods, aligning media playback experiences with user expectations, subscription value, and monetization strategies of the platform.

In some embodiments, the duration of additional content may be taken into account when determining the playback duration allotted for media playback. Additional content to be outputted with the media may include, but is not limited to advertisements, navigation directions, travel updates, etc. In an example embodiment, the one or more processors determine that a predicted travel duration is 15 minutes between the initiation location and the destination location. Because the travel duration is 15 minutes, in some embodiments the playback range for media is 15 minutes. However, in other embodiments, the system may determine that within the 15 minutes of travel, there will be 2 minutes of advertisements (e.g., in a free subscription tier) with 30 seconds of navigation instructions (e.g., in embodiments in which the outputted media is paused during navigation instructions). The system takes into account the 2 minutes and 30 seconds of interruptions to the media to decrease the possible playback length (e.g., the trip listen duration) to 12 minutes 30 seconds. With this updated playback length, the system proceeds to determine a list of media to present to the user as described above.

In some embodiments, the systems and methods described herein may be extended to support a coordinated media playback experience across a group of users navigating to a common destination (e.g., a group of users linked through a link up as described herein). In such embodiments, the one or more processors receive a plurality of playback durations derived from a corresponding plurality of route parameters and playback parameters, wherein each set of parameters is associated with an individual user device in the group. The system may predict a travel duration for each user in the group based on the respective route parameters and determine a shared playback range-referred to as a second playback range-corresponding to a minimum travel duration among the group. For example, the minimum travel duration among the group may apply to the user within the plurality of users that has the shortest predicted travel duration or trip listen duration. The one or more processors then generate, from the plurality of available media, a list of media having a playback duration that fits within the second playback range when played at a specified playback rate threshold. This list of synchronized media options is suitable for collective consumption by all group members en route to the common destination, regardless of differing travel times or methods of travel. The list of media is chosen with the various playback thresholds of the plurality of users taken into account.

Once the shared list of media is generated, the system transmits instructions to display the list of media to one or more of the group's user devices. In various embodiments, the list may be transmitted to all user devices simultaneously or to a designated primary device (e.g., that of an organizer or host) for selection. In response to a media selection from the list, the system generates and transmits instructions to activate output of the selected media on the one or more user devices associated with the group. The output may be synchronized across user devices, or individually adapted to each user's predicted travel duration and playback rate constraints, while still ensuring complete consumption of the media before arrival at the destination. This functionality supports a shared experience for events such as group meetups, carpools, or conference attendance, enabling all participants to listen to or view the same content during travel, thereby fostering engagement, consistency, and context-aware preparation.

By way of example, a group of colleagues is scheduled to attend a team meeting at a central office location at 9:00 a.m. Each colleague begins their commute from a different part of the city, using different modes of transportation-some traveling by car, others by public transit. An organizer or inviter device transmits to one or more invitee devices associated with the colleagues a link up request, as described herein. Upon an acceptance of the link up request by one or more of the invitee devices, the invitee devices are linked to the organizer device in a link up. In response at least in part to the linking of the devices, the system receives route parameters and playback parameters from each of their respective user devices and calculates a predicted travel duration for each individual user.

The system determines that the shortest travel duration among the group is 22 minutes. Based on this minimum duration, the system defines a second playback range and identifies media that can be fully consumed within that window. For example, the system may generate a list of media files such as a 20-minute industry podcast or a company news update recorded at 1.25× speed to fit the playback constraints of one of the invitees. This list is transmitted to one or more of the invitee devices, with an optional recommendation for shared playback. The system may adjust the playback rate for the 20-minute media for each individual invitee device and/or organizer device based at least in part on the playback preferences by the devices/users associated with the devices.

Once one of the devices (e.g., the organizer device or invitee device) selects the podcast episode, the system transmits playback instructions to each device, activating audio output such that each user hears the same content during their commute. In one embodiment, playback may be synchronized to start simultaneously or staggered based on each user's route, ensuring completion by arrival. Upon arriving at the office, the team enters the meeting already familiar with the same contextual information or talking points, having consumed the shared content during their individual commutes. In some embodiments, each invitee device accepts the recommended media to output the recommended media. In other embodiments, a single device may select to output the media for the group. The methods and systems described herein may be applied in any navigation system, and may be executed by a third-party server/processors to be embedded within or transmitted to a first-party navigation system.

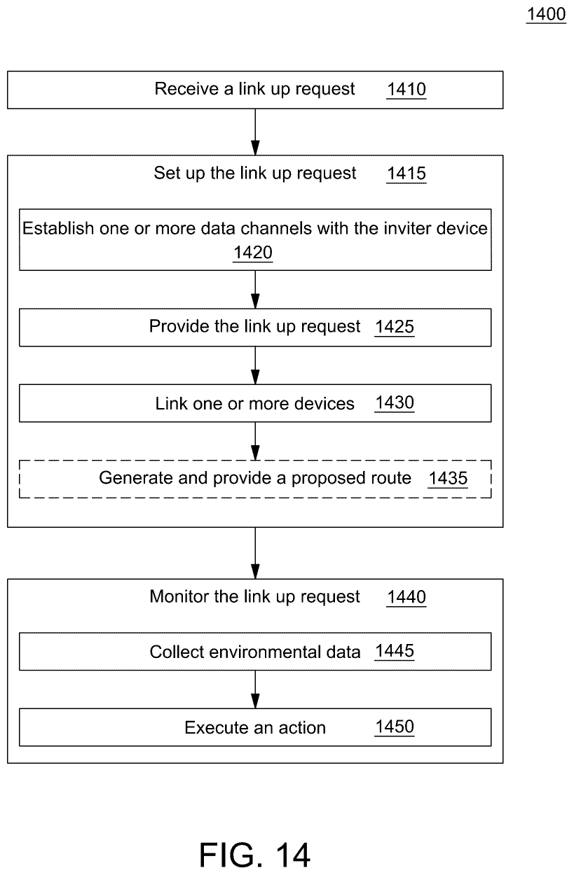

Referring now to FIG. 14, a flowchart is shown illustrating an example computer-implemented method 1400 for linking devices and protecting data during group navigation, according to some embodiments. In some embodiments, the system 100 may be configured to perform the one or more portions of the method 1400. In other embodiments, one or more alternative computing devices described herein may be configured to perform the method 1400. As shown in FIG. 14, the method 1400 may include receiving, establishing, providing, linking, generating, collecting, and executing operations for coordinating navigation among a group of users. Additional/alternative features and embodiments of method 1400 are described beyond the the steps explicitly illustrated within FIG. 14.

At block 1410, the one or more processors receive, from an inviter device, a link up request associated with a link up location. In various embodiments, the link up request may include metadata associated with the intended destination, a time of arrival, or access permissions to join the session. For example, a user planning a group meetup at a coffee shop may initiate a link up session (through the inviter device) with the coffee shop as the designated location and send that request from their smartphone. In another example, the inviter device may be associated with an event organizer-such as a city official coordinating a public festival or a sports team managing entry to, and participation at, a stadium-who transmits a link up request to attendees' mobile devices (e.g., invitee devices) to assist with coordinated arrival times, navigation to designated parking zones, entry gate assignments, and/or patron flow within the event. Upon receiving the link up request, the one or more processors set up the link up request at block 1415, which may include block 1420, 1425, 1430, and/or 1435.

At block 1420, the one or more processors establish one or more data channels with the inviter device. These data channels may support communication between the inviter device and the one or more processors for managing the session, exchanging navigation data, or updating routing conditions. For example, the inviter's mobile application may open a persistent or semi-permanent connection to a server backend to facilitate real-time coordination and updates with linked participants.

At block 1425, the one or more processors provide, via one or more data channels, the link up request to a plurality of invitee devices. The link up request includes the link up location and any supplemental information required for invitees to consider or respond to the request. For example, the system may push notifications containing the link up request and destination details to each invitee device of contacts that the inviter selected for participation.

At block 1430, in response to receiving a first acceptance of the link up request from a first invitee device of the plurality of invitee devices, the one or more processors link the inviter device and the first invitee device. The linking may form a shared session state and allow for synchronized navigation, sharing of data, and communication. For example, when a first invitee device accepts the invitation to join a sporting event link up, the first invitee device is joined into the live navigation/tracking/link up session. In some embodiments, estimated time of arrival (ETA), route information, and environmental data (e.g., live location tracking) are shared by the first invitee device to the inviter device. In this manner, the inviter device is able to accurately track the location and movement of invitee devices (and by extension, patrons) within the event or geographical location. Likewise, data may flow from the inviter device directly or indirectly to the first invitee device. For example, and as described further herein, directed media (e.g., sponsored media) such as navigational instructions, promotions, information, etc. may be shared by the inviter device to the invitee device.

In response to receiving a second acceptance of the link up request from a second invitee device of the plurality of invitee devices, the one or more processors link the inviter device and the second invitee device. In some embodiments, the linking may also connect the first and second invitee devices for inter-device coordination. For example, when a second participant confirms attendance or accepts a link up request, the second invitee device is added to the same link up session as the inviter and the first participant, enabling, in some embodiments, mutual location visibility.

At block 1435, the one or more processors may optionally generate and present to the first invitee device, via a first graphical user interface (GUI) of an application, a first proposed route to the link up location. The first proposed route may be based on a first geographic location of the first invitee device, and may account for real-time traffic, user preferences, or safety conditions. For example, a user located across town may receive a recommended route avoiding construction delays, tailored to their current location and travel method. In some instances, the one or more processors do not generate and present a proposed route to the link up location. For example, as described herein, in some embodiments, a link up request is sent to the first invitee device upon the first invitee device crossing a geofence location that marks the location of the link up request. For example, an invitee device may receive the link up request upon entry into a sporting arena. In such instances, the user is already at the link up location and there is no need to provide navigational directions thereto. In such embodiments, the link up request may be used to facilitate navigation within the event (e.g., the sporting arena, such as directions to a seat), communication between an organizer/sponsor with participants of the event, facilitate adjustments in traffic flow within the event, and/or provide recommendations for locations to visit after the event.

In some embodiments, sub link ups may be generated within a primary or event-based link up session to facilitate smaller, interest-specific gatherings among participants. The primary link up session may correspond to a larger event-such as a music festival, sporting event, conference, or city-sponsored activity—where a broad set of users are joined in a shared navigation or coordination experience. Within this larger session, the system may analyze user profiles, preferences, behaviors, or current locations to identify opportunities for sub link ups based on commonalities. These sub link ups may then be recommended to subsets of users to encourage micro-gatherings around shared interests, activities, or goals, enhancing social discovery and contextual engagement within the broader experience.

For example, during a multi-day music festival, several users within the primary link up session may have “frisbee” listed as a preference in their user profiles. Although these users are not in each other's contact lists, the system identifies the shared interest and their overlapping presence at the venue. Based on this information, the system may generate a sub link up request inviting them to meet at a designated open space within the festival grounds to play frisbee. The system may present the recommendation as a contextual prompt on the users' devices (e.g., “Meet other festivalgoers who love frisbee-Field 3, 2:00 PM”), complete with directions and an option to accept or decline the sub link up. Upon acceptance, the users may be temporarily linked within the session for location sharing, navigation, or chat related to the activity.

At block 1440, the one or more processors can monitor the link up request, and can include collecting environmental data (block 1445) and/or executing actions based on the link up session and/or the collected environmental data (block 1450). At block 1445, the one or more processors collect environmental data of the plurality of invitee devices. This data may include location information, speed, device orientation, or other sensor-derived data that informs navigation status or user behavior. For example, the system may detect that one user has stopped moving or entered a low-signal area and flag that information for session coordination. Environmental data may also include, in some embodiments, personal preference data from a user profile that includes user-provided information, including activity interests (e.g., sports, games, music), preferred communication styles (e.g., voice, text), privacy preferences, and previously visited locations. This user preference data may be utilized to refine routing recommendations, suggest sub link up opportunities, or provide individualized prompts during the group navigation session.

At block 1450, the one or more processors execute an action based at least in part on the environmental data from the plurality of invitee devices. The action may include updating routes, triggering notifications, adjusting timing of the link up, or generating emergency alerts, depending on the specific environmental context or group dynamics. For example, if several users are shown to be delayed by traffic, the system may prompt the group to delay the start time of an activity or suggest an alternative meeting location. Additional or alternative actions that may be executed by the one or more processors are described below and elsewhere within this disclosure.

It should be understood that the method 1400 of FIG. 14 is provided by way of example only and is not intended to be limiting. The steps of method 1400 may be performed in any suitable order, including in an order different from that shown and described. In various embodiments, one or more steps may be omitted, combined, or performed simultaneously. Likewise, additional or alternative steps may be included without departing from the scope of the disclosure, including the methods and systems described herein. The steps of method 1400 may be combined with any step, feature, and/or method described herein, including other methods without departing from the scope of this disclosure. Furthermore, the described operations may be implemented by one or more processors executing on a single device, across multiple devices, or in a distributed computing environment.

In some embodiments, the system includes a privacy feature that allows the inviter device—such as an organizer, host, or initiating user—to request anonymization of invitee data for one or more participants in a link up session. To safeguard user privacy, the inviter device may transmit a privacy request to the system instructing that invitee data associated with at least one of the first or second invitee devices be anonymized.

In response to receiving this privacy request, the system anonymizes personally identifiable information (PII) of the relevant invitee devices before any such data is stored, processed, or displayed. For example, instead of transmitting specific names, contact information, or precise locations, the system may replace such data with pseudonymous identifiers, generalized locations (e.g., “north of downtown”), or entirely abstracted user profiles. This ensures that participation in a shared navigation or media session does not require public exposure of a user's (or inviter device's) identity, location, or behavioral data unless explicitly authorized.

In some embodiments, the system may include an enterprise-facing graphical user interface, or “dashboard,” that enables inviter device—such as an event organizer, municipal authority, or corporate host—to monitor the navigational progress (e.g., environmental data), historical behavior, and predicted future behaviors of invitees participating in a group navigation session (e.g., the link up session). Upon receiving route participation from a plurality of invitee devices, the system may collect and aggregate geolocation data including a first location of a first invitee device and a second location of a second invitee device. This location data may be presented in real time or as part of a historical or predictive visualization on the inviter's device through an interactive GUI.

The enterprise dashboard may include features for displaying the live positions of individual users (whether anonymized or personally identifiable), estimated time of arrival for each device, and route trajectories overlaid on a digital map. In addition to current locations, the dashboard may provide historical location trends showing movement patterns (e.g., frequent route deviations or known traffic bottlenecks) as well as predictive analytics, such as expected arrival windows or potential delays based on real-time traffic or environmental data. This empowers the inviter to monitor attendance or participation in real time, make informed decisions (such as delaying an event start time or issuing updated travel guidance), and tailor media delivery or engagement strategies based on user movement. In some embodiments, the system generates working instructions for staff to be located at one or more locations to account for updated traffic flows as monitored or predicted.

In an example, a logistics coordinator managing transportation to a citywide emergency shelter during a weather event may use the dashboard to track citizen arrival patterns and determine whether additional resources should be deployed. Alternatively, a stadium operator may use the dashboard during a game day to observe fan arrival flows and proactively push venue announcements, parking instructions, staffing, and/or or partner promotions based on real-time and predictive user distribution. In each case, the enterprise dashboard centralizes travel and behavioral insights into an actionable interface, enhancing visibility, responsiveness, and coordination in multi-user navigation environments.

In some embodiments, the system is configured to receive, by one or more processors, an indication of an event occurring within a threshold range of one or more invitee devices participating in a group navigation session. Upon identifying such an event-such as a localized crowding condition, a promotion, or an activity relevant to the navigation route—the system may transmit a recommendation to one or more of the invitee devices. The recommendation may include navigation guidance, promotional content, or a contextual incentive, such as a coupon, and is tailored to influence user behavior in a manner that aligns with logistical or experiential goals set by the organizer.

For example, a sporting event organizer managing crowd flow outside a stadium may detect that a large number of invitees (i.e., fans) are congregated at a heavily trafficked entrance gate or merchandise kiosk. In response, the system may identify an adjacent concession area or less-trafficked entrance that is within a reasonable walking distance (i.e., within the threshold range) and trigger a recommendation to redirect a subset of users. This recommendation may be presented in the form of a push notification on users' mobile devices, such as: “Skip the line-get 15% off at Gate C concessions, just a 3-minute walk away.” By offering a coupon valid only at the alternate location, the system incentivizes behavioral redistribution while improving user satisfaction and reducing localized congestion.

In another example, following the conclusion of a sporting event, the system may monitor crowd dispersal patterns through positional data from invitee devices and determine which exit portals users are passing through. Based on the specific exit used, the system may generate individualized dining or entertainment recommendations that are geographically optimized to the user's real-time trajectory. For instance, a user exiting from the south portal of the arena may receive a notification such as, “Heading out Gate 4? Grab dinner at TexMex Grill-just two blocks south with happy hour extended for fans.” Meanwhile, a different user leaving through the east portal may be directed toward a pizza shop or sponsored venue located along their most likely post-event route. These recommendations may also account for user preferences stored in their profiles-such as cuisine type or dietary restrictions-providing relevant, location-aware suggestions that enhance the post-event experience while enabling localized promotions for nearby businesses.

In this embodiment, the system not only monitors real-time location data and events but also dynamically generates and delivers actionable recommendations that optimize the physical flow of attendees and enhance the overall event experience. This proactive and location-aware communication approach allows organizers to react to shifting crowd patterns, drive sponsor engagement, and improve venue safety and efficiency, all through the same navigation and media playback platform used for the trip itself.

In some embodiments, the system enables enhanced social visibility during group navigation sessions by presenting, for display on a first invitee device, the location of a second invitee device when the second invitee device is determined to be associated with the first. This association may be derived from shared contact information (e.g., mutual inclusion in a user's contact list), social network connections, or historical co-participation in prior events. The display of the second invitee's location may further be conditioned on environmental data, such as the devices being within a shared geofenced region (e.g., a stadium or event venue), or a signal strength threshold that validates relative proximity. In some embodiments, the social visibility may be available when both user devices have accepted a common link up request.

For example, a first user attends a professional football game and either automatically joins a link up session upon entering the stadium's geofence or accepts an invitation from the event organizer via a notification or event app. The system recognizes the user's participation and, based on shared contact information, determines that a second user-who is also attending the event and has joined the same link up session—is associated with the first user. The system may receive environmental data such as GPS coordinates, BLE beacons, or Wi-Fi triangulation to estimate the location of the second user within the venue.

In response, the system presents the location of the second user as a visual marker on the first user's event map interface, possibly along with proximity details such as “150 feet away near Gate B.” This visibility allows the first user to more easily locate friends, family, or colleagues in crowded event settings, whether the users knew of each other's intention to visit the same location beforehand or not. The feature also supports privacy controls-such as requiring mutual consent or invitation acceptance—while still enabling users to benefit from spatial awareness of their social circle during dynamic, high-traffic environments. In some embodiments, a sub link up request may be generated and transmitted to one or more of the invitee devices, as described herein.

In this embodiment, the system enables the sports team not only to enhance fan engagement during travel but also to deliver sponsored content in a time- and location-relevant format. For example, if a user passes a geofenced sponsor location, such as a partnered restaurant or retail outlet, the system may output directed media specific to that location and optionally deliver a digital coupon. In some embodiments, all users within a specific seating section may receive the coupon based at least in part on their presence within the seating section. This creates an immersive pre-arrival experience while providing measurable marketing value to sponsors. In another embodiment, a municipality may adopt the same framework to support emergency response efforts. For example, during an evacuation or severe weather alert, the municipality may serve as the organizer and broadcast a link up invitation to devices of citizens, wherein the link up invitation is to an evacuation location or route. Upon user engagement, the system provides real-time navigation updates, government-issued audio instructions, and safety-related media (e.g., evacuation guidelines or first aid advice), which are delivered in a manner adapted to each user's predicted travel duration and travel method.

As described above, the system may transmit a link up request automatically to an invitee device. For example, the system may generate and transmit the link up request at least in response to the first invitee device breaking a geofenced location (e.g., upon entering the sports arena). In other embodiments, the system may transmit the link up request in response, at least in part, to the invitee device performing an actions, such as scanning a QR code.

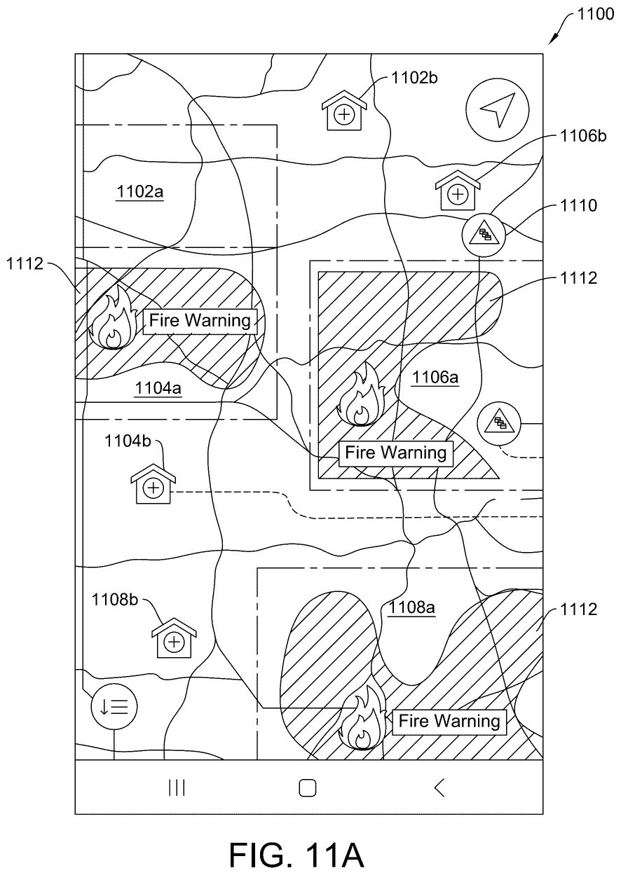

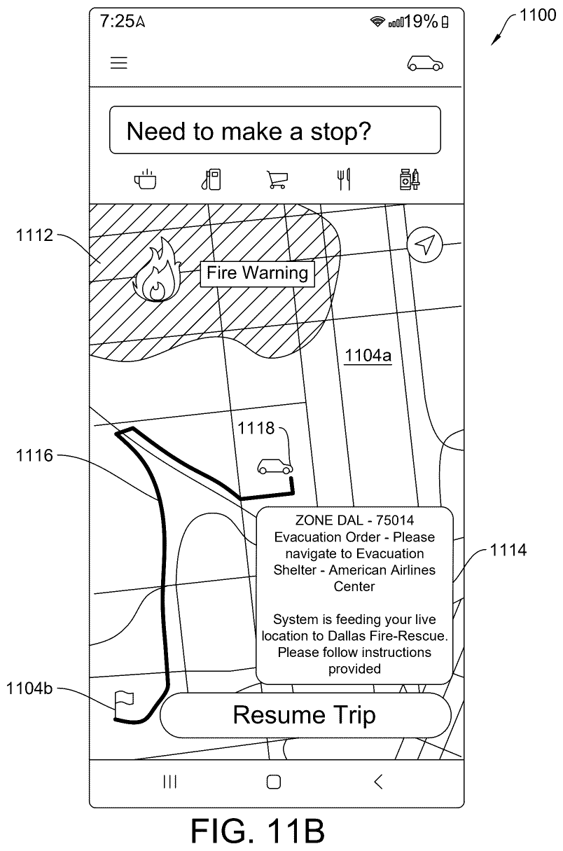

In some embodiments, the system includes emergency response capabilities that enable the one or more processors to transmit instructions to user devices within a group navigation session for the purpose of displaying an emergency evacuation route, such as shown in FIGS. 11A-11B. The evacuation route is generated based at least in part on environmental data, which may include geolocation information, crowd density analytics, sensor inputs (e.g., from cameras, BLE beacons, or public infrastructure), weather conditions, and real-time incident reports such as fire alarms, road closures, or security alerts.

For example, if a crowd-related hazard, such as a fire or structural emergency, occurs during a large-scale event like a sports game or concert, the system may determine that certain areas of the venue or surrounding infrastructure have become unsafe. Based on environmental data indicating hazard location, egress point availability, and current crowd distribution, the system dynamically generates personalized evacuation routes tailored to the user's current position. These routes are then transmitted as graphical overlays or turn-by-turn directions (e.g., within the event) to invitee devices, including the first and second invitee devices in the link up session.

This functionality enables real-time, location-aware safety guidance for individuals within a coordinated group session, improving evacuation efficiency while minimizing confusion. The system may also prioritize routes based on accessibility needs or proximity to emergency services and update the guidance as conditions evolve. This embodiment demonstrates how the same platform that enables social and media-linked navigation can be repurposed for public safety, providing a unified interface for both routine and critical navigation experiences.

Referring now to FIG. 11A, an illustration of an example emergency response user interface 1100 is shown, according to some embodiments. In the illustrated embodiment, the system is employed by a municipality or emergency management authority to coordinate evacuation efforts in response to a wildfire affecting a geographically diverse suburban region. The user interface 1100 may be presented on a user device, such as a smartphone or tablet, and is configured to provide real-time situational awareness and navigation assistance to individuals located within or near an emergency zone (e.g., within a predetermined range threshold).

In the embodiment shown, the system identifies multiple fire warning zones 1112, each visually distinguished with hatching, color gradient, bounding boxes, etc. (optionally labeled “Fire Warning). The fire warning zones 1112 may be determined based on environmental data, such as wildfire perimeter information, predictive fire spread modeling, wind patterns, or thermal imaging inputs. A plurality of user devices (e.g., invitee devices) may be located within one or more evacuation zones, shown as evacuation zone 1102a, 1104a, 1106a, 1108a. The system may automatically generate and transmit a link up request to these devices, prompting users to join a coordinated evacuation session.

Shelter or evacuation centers 1102b, 1104b, 1106b, 1108b are distributed across the map, representing safe locations to which users may be routed. The evacuation center 1102b is the evacuation center for the evacuation zone 1102a. The evacuation center 1104b is the evacuation center for the evacuation zone 1104a. The evacuation center 1106b is the evacuation center for the evacuation zone 1106a. The evacuation center 1108b is the evacuation center for the evacuation zone 1108a. In this embodiment, different zones are defined by their proximity to particular shelters and associated evacuation routes. For example, a first user located within the evacuation zone 1104a may be directed toward evacuation center 1104b, while another user located within zone 1108a is routed away from an area of active fire activity to the evacuation center 1108b.

Based on real-time environmental inputs and congestion data, the system dynamically assigns safe evacuation routes to each user and may reroute individuals away from overcrowded or hazardous zones. For example, if traffic congestion is detected along a major artery out of zone 1106a to the evacuation center 1106b (e.g., shown as traffic event 1110), the system may update routing for an invitee device in that region to avoid the bottleneck and instead utilize alternate corridors to route the invitee device to the evacuation center 1104b. The traffic event 1110 may include a crash, stalled vehicle, road closure, lane closure, emergency vehicle barricade, environmental hazard, etc.

In some embodiments, the user interface 1100 may present real-time alerts, including directional guidance, hazard proximity notifications, and shelter availability, as shown in FIG. 11B. Additionally, the municipality's emergency operations center may monitor user locations across all zones to detect whether individuals remain in high-risk areas. In such cases, first responders may be dispatched or additional electronic messages may be issued to prompt evacuation or offer alternative routing. As more users engage with the system, the aggregated data enhances situational intelligence, enabling dynamic, real-time adjustments to evacuation strategies and supporting life-saving coordination at scale.

Referring now to FIG. 11B, an illustration of an example interface 1100 is shown, providing a detailed view of an individual proposed evacuation route for an invitee device participating in the link up session, according to some embodiments. As described with respect to FIG. 11A, once the municipality has issued an emergency alert and initiated the emergency evacuation link up session, the system may begin generating personalized evacuation guidance for each user based on their respective location, zone designation, and prevailing environmental conditions.

In the illustrated embodiment, the invitee device is located within evacuation zone 1104a, which overlaps with a designated fire warning region. The interface 1100 includes a proposed navigation route 1116 extending from the current position 1118 of the invitee device (represented by a vehicle icon) toward the evacuation1104b. This route avoids the hatched fire warning area and is calculated by the system as the safest and most efficient path based on environmental data, including traffic congestion, topography, and proximity to hazards.

An emergency message overlay 1114 is displayed prominently on the interface and corresponds to zone-specific evacuation instructions. In this example, the system has identified the user's current location as falling within “ZONE DAL-75014” and has issued an evacuation order directing the user to the evacuation center 1104b: the American Airlines Center. The message further informs the user that their live location is being fed in real time to Dallas Fire-Rescue, enabling emergency responders to monitor progress and intervene if necessary. The interface may further support voice navigation, audible alerts, or accessibility-enhanced messaging to ensure effective communication under emergency conditions.

In some embodiments, the system may determine when one or more invitee devices that have accepted a link up request are en route to the link up destination (whether in a group, to an event, or during an evacuation) and transmit updated or supplemental media in real time based on changes to the user's predicted travel durations, arrival times, or geolocation. For instance, if traffic congestion delays a fan's arrival to the sports arena, the system may adjust the playback rate of the selected pre-game podcast or insert a supplementary media segment (e.g., a highlight reel or a message from the coach) to maintain engagement during the extended trip. Alternatively, the system may re-prioritize media delivery based on proximity to specific interim locations, such as a merchandise kiosk or a parking structure, enabling the organizer to deliver localized promotions or logistical updates, such as changes in parking availability. The system may also identify upcoming travel constraints (e.g., road closures) and dynamically modify the user's route while preserving the integrity of the curated media experience, thereby ensuring both arrival and enjoyment are optimized.

In yet another embodiment, the system may be utilized to facilitate time-sensitive coordination for a scheduled event, such as a wedding ceremony. In this scenario, the event organizer-such as the wedding planner or host-initiates a link up session through the system and transmits invitations to all invitee devices associated with expected participants, including guests, vendors, and key individuals such as the officiant and members of the wedding party. As each participant accepts the link up request (or upon initiation of navigation), the system receives route parameters from one or more of the invitee devices and predicts individual travel durations to the wedding venue.

As the event start time approaches, the system continually monitors real-time travel conditions for all linked participants and updates their respective predicted travel durations. Upon determining that one or more critical users—such as the officiant or a parent of the bride—will not arrive at the destination by the scheduled start time due to unexpected traffic congestion or a detour, the system may generate a recommendation to delay the commencement of the ceremony. This recommendation may be presented to the host or organizer via a notification on their device, along with context indicating the reason for the delay and an estimated arrival window for the delayed party.

For instance, if the officiant is predicted to arrive at 4:18 p.m. for a wedding scheduled at 4:00 p.m., the system may recommend adjusting the ceremony start time to 4:20 p.m. The host can accept the recommendation, and in response, the system may broadcast an updated schedule to all linked participants, optionally accompanied by supplemental media to fill the extended wait time. This ensures that key individuals are present for the ceremony without requiring ad hoc communication or disrupting the event timeline. Additionally, the system may suggest adjustments to the playback of any shared media-such as delaying the output of pre-ceremony audio messages—to maintain temporal alignment with the rescheduled start.

The system may be implemented such that the link up request is initiated not by an external organizer but by a user within a group intending to travel to the shared common location. In such embodiments, a user may create a link up session through the use of an organizer device and transmit the link up request to the invitee devices of others to invite other users (e.g., friends, family members, or colleagues) to participate. One or more of the invitee devices share route parameters and/or playback parameters, and the system predicts travel durations to the common destination for each participant.

In some embodiments, the system is configured to predict, using the one or more processors, an estimated arrival time to a link up location for participants in a group navigation session. The estimated arrival time may be calculated based on environmental data collected by one or more of the invitee devices (or organizer device) such as current traffic conditions, road closures, public transportation delays, or weather disruptions. The system then transmits this estimated arrival time to one or more devices involved in the session-such as the organizer device, the first invitee device, or the second invitee device—to inform users of timing expectations in real time.

If the estimated arrival time satisfies a defined threshold—such as indicating that one or more users will be late by a certain margin—the system may automatically initiate an action to update a reservation associated with the group. This reservation may include a restaurant booking, ticketed entry time, event registration, or similar scheduled activity. The system may access a reservation API or send a structured communication (e.g., to a dining platform, concierge system, or ticketing service) to adjust the time slot, hold the reservation, or notify the host entity of the delay.

For example, a group of friends are navigating separately to a dinner reservation at a restaurant downtown and are all linked through an acceptance to a link up request. One of the invitees is delayed due to a traffic accident that has caused congestion on their route. The system detects that the predicted arrival time of this invitee now exceeds the reservation time by 15 minutes, which meets or exceeds the defined lateness threshold. In response, the system transmits a request to the restaurant's reservation system to update the arrival time and hold the group's table for an additional 20 minutes. Simultaneously, the organizer device and/or the other invitee devices receive a notification informing them of the delay and updated reservation status. This automation reduces the need for manual coordination, preserves the group's booking, and ensures that the user experience remains uninterrupted despite environmental disruptions, all while reducing the risk of unsafe communication methods during navigation (e.g., texting, calling, emailing, etc.).

In some embodiments, the system utilizes historical environmental data to generate personalized recommendations for participants in a group navigation session. The one or more processors may receive historical data such as past locations visited by the invitee devices, previously traveled routes, durations of stay, media playback history, and contextual behaviors (e.g., time of day, mode of transport, or stop patterns). Based on this data and the current link up location, the system generates a recommendation relevant to the group's typical behavior and interests, and transmits the recommendation to one or more of the invitee devices or the organizer device.

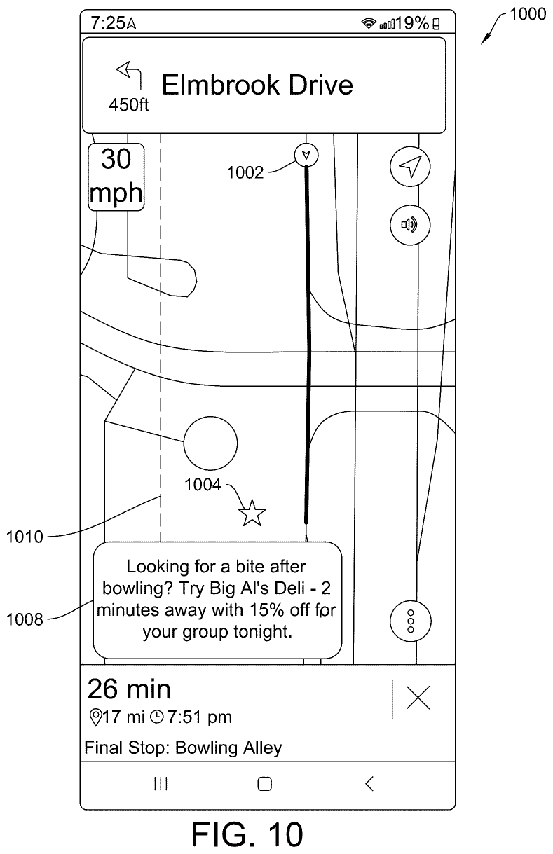

For example, consider a group of friends who routinely link up to go bowling every Friday evening. Over time, the system observes that the group frequently navigates from a local bowling alley to a nearby sandwich shop after their games. The system stores this behavioral pattern as historical environmental data. On a subsequent Friday, when the same group initiates a link up session to the bowling alley, the system identifies this recurring pattern and proactively generates a recommendation (e.g., a directed media 1008 on a GUI 1000 of FIG. 10) for a sandwich shop visit following the bowling event. The recommendation may suggest the same sandwich shop they've previously visited or may introduce a new nearby sandwich shop 1004 that offers similar menu items, improved ratings, or less crowding.

In some embodiments, sandwich shops or other local businesses may participate in a sponsorship program, allowing them to promote their locations through directed media recommendations. For instance, the new nearby sandwich shop 1004 near the bowling alley and/or navigation route of one or more of the invitee devices (e.g., within a threshold range 1010, such as within a distance or time of the destination or route) may pay to have its location sponsored in the system, triggering a prioritized recommendation such as: “Looking for a bite after bowling? Try Big Al's Deli—2 minutes away with 15% off for your group tonight.” This sponsored recommendation may be transmitted to one or more of the invitee devices or to the organizer device, creating personalized post-event suggestion while offering monetization opportunities for local vendors. The system thus blends personalization, historical trends, and promotional content to enhance the group's experience beyond the original link up destination.

In some embodiments, the system may further generate and transmit a polling or voting element to one or more of the invitee devices and/or the organizer device that allows users within the link up session to collaboratively select among one or more directed media recommendations. For example, upon receiving multiple directed media options (e.g., recommendations for different sandwich shops displayed as directed media 1008 on GUI 1000 of FIG. 10), the system may present an interactive voting interface on each invitee device. Each user may cast a vote for their preferred destination, coupon, or post-event activity. The system may collect these votes in real-time and, based on a threshold voting rule (e.g., majority, plurality, or organizer override), determine which directed media option is selected for the group. In some embodiments, the winning recommendation is then confirmed to all group members and incorporated into the proposed navigation routes, updating the destination accordingly.

Upon receiving an acceptance of a recommendation (such as the directed media 1008 in FIG. 10) from at least one of the invitee devices, the system may dynamically update the navigational route of the accepting device(s) to incorporate a stop at the recommended location. Continuing with the sandwich shop example, if one or more members of the bowling group selects the recommendation to visit “Big Al's Deli” after the bowling session, the system updates the proposed routes accordingly. For instance, the route from the bowling alley or device 1002 to the sandwich shop is generated as an updated navigation path and transmitted back to the first invitee device, the second invitee device, or any other participating device in the group.

In some embodiments, if multiple invitees accept the recommendation, the system may also coordinate their arrival to the new location by factoring in current positions and estimated travel durations. Additionally, the system may notify other group members of the selected destination to encourage coordinated participation or offer to generate shared media content (e.g., a group playlist) for the next segment of the trip.

In yet another embodiment, the system enables advanced scheduling and route prediction for a future group navigation session by utilizing historical traffic data, which may be referred to as a “Tomorrow Trip Planner.” Specifically, the one or more processors predict a proposed route—such as the first proposed route—for a specified link up time based at least in part on known traffic trends, congestion patterns, and recurring environmental factors (e.g., school zones, rush hour delays, or scheduled road work). This prediction supports early planning and optimized coordination for users intending to navigate to a common destination at a future point in time.

For example, an organizer may schedule a link up session for a birthday party at a local park to begin at 2:00 PM on Saturday. In advance of the event, the organizer uses the system to initiate the link up request, specifying the link up time and destination. Upon receiving the request, the system accesses historical traffic data for the relevant day and time—such as previous Saturday afternoon traffic patterns—and predicts the best route for each invitee. The first proposed route, for instance, may be tailored to avoid typical congestion hotspots or account for seasonal detours known to occur during that time.

This future-facing capability allows users to receive early guidance and time-to-depart notifications, reducing the risk of late arrivals and enabling better coordination among group members. It also gives the organizer confidence that the group will arrive on time and follow efficient paths, even in the absence of real-time data at the time of planning. In certain embodiments, the system may continue to update these predictions as the link up time approaches, replacing historical predictions with real-time data when available, to ensure the best possible guidance at all stages of the planned outing.

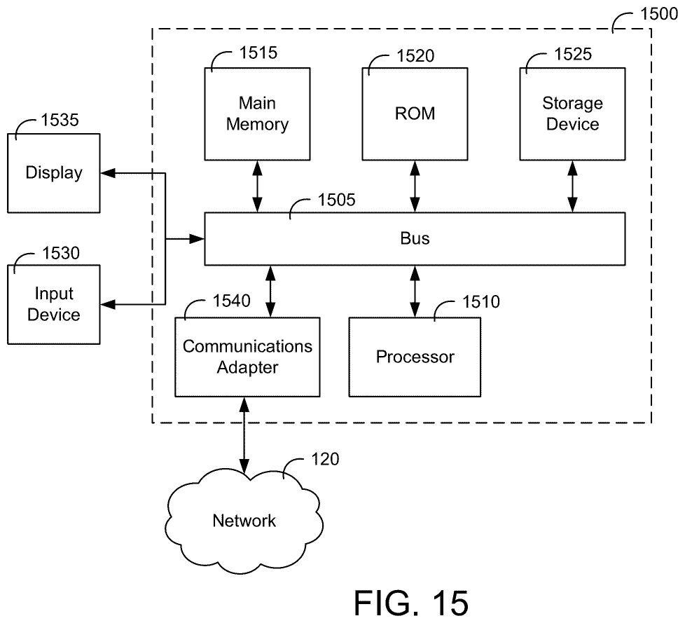

FIG. 15 illustrates a depiction of a computing system 1500 that can be used, for example, to implement an illustrative client device 110, an illustrative linking system 130, and/or various other illustrative systems described in the present disclosure. The computing system 1500 includes a bus 1505 or other communication component for communicating information and a processor 1510 coupled to the bus 1505 for processing information. The computing system 1500 also includes main memory 1515, such as a random-access memory (RAM) or other dynamic storage device, coupled to the bus 1505 for storing information, and instructions to be executed by the processor 1510. Main memory 1515 can also be used for storing position information, temporary variables, or other intermediate information during execution of instructions by the processor 1510. The computing system 1500 may further include a read only memory (ROM) 1520 or other static storage device coupled to the bus 1505 for storing static information and instructions for the processor 1510. A storage device 1525, such as a solid-state device, magnetic disk or optical disk, is coupled to the bus 1505 for persistently storing information and instructions.

The computing system 1500 may be coupled via the bus 1505 to a display 1535, such as a liquid crystal display, or active matrix display, for displaying information to a user. An input device 1530, such as a keyboard including alphanumeric and other keys, may be coupled to the bus 1505 for communicating information, and command selections to the processor 1510. In another implementation, the input device 1530 has a touch screen display 1535. The input device 1530 can include a cursor control, such as a mouse, a trackball, or cursor direction keys, for communicating direction information and command selections to the processor 1510 and for controlling cursor movement on the display 1535.

In some implementations, the computing system 1500 may include a communications adapter 1540, such as a networking adapter. Communications adapter 1540 may be coupled to bus 1505 and may be configured to enable communications with a computing or communications network 120 and/or other computing systems. In various illustrative implementations, any type of networking configuration may be achieved using communications adapter 1540, such as wired (e.g., via Ethernet), wireless (e.g., via Wi-Fi, Bluetooth, etc.), pre-configured, ad-hoc, LAN, WAN, etc.

According to various implementations, the processes that effectuate illustrative implementations that are described herein can be achieved by the computing system 1500 in response to the processor 1510 executing an arrangement of instructions contained in main memory 1515. Such instructions can be read into main memory 1515 from another computer-readable medium, such as the storage device 1525. Execution of the arrangement of instructions contained in main memory 1515 causes the computing system 1500 to perform the illustrative processes described herein. One or more processors in a multi-processing arrangement may also be employed to execute the instructions contained in main memory 1515. In alternative implementations, hard-wired circuitry may be used in place of or in combination with software instructions to implement illustrative implementations. Thus, implementations are not limited to any specific combination of hardware circuitry and software.

Although an example processing system has been described in FIG. 15, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer-readable storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks, distributed ledger networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TELEVISION channel, on a satellite TELEVISION channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, Disney+, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a smart watch, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for linking devices and protecting data during group navigation, the computer-implemented method comprising:
receiving, by one or more processors from an inviter device, a link up request associated with a link up location;
establishing, by the one or more processors, one or more data channels with the inviter device;
providing, by the one or more processors, the link up request to a plurality of invitee devices, the link up request comprising the link up location;
in response to receiving a first acceptance of the link up request from a first invitee device of the plurality of invitee devices, linking, by the one or more processors, the inviter device and the first invitee device;
in response to receiving a second acceptance of the link up request from a second invitee device of the plurality of invitee devices, linking, by the one or more processors, the inviter device and the second invitee device;
collecting, by the one or more processors via the one or more data channels, environmental data from one or more of the plurality of invitee devices; and
executing, by the one or more processors, an action based at least in part on the environmental data from the one or more of the plurality of invitee devices.

2. The computer-implemented method for linking devices and protecting data during group navigation of claim 1, further comprising:
receiving, by the one or more processors from the inviter device, a privacy request to anonymize invitee data of at least one of the first invitee device or the second invitee device such that personally identifiable information of the first invitee device or the second invitee device are anonymized.

3. The computer-implemented method for linking devices and protecting data during group navigation of claim 1, further comprising:
receiving, by the one or more processors, a first location of the first invitee device and a second location of the second invitee device; and
presenting, by the one or more processors, for display on the inviter device as a graphical user interface, at least one of the first location of the first invitee device, the second location of the second invitee device, a historical location trend of one or more of the plurality of invitee devices, or a predicted location of one or more of the plurality of invitee devices.

4. The computer-implemented method for linking devices and protecting data during group navigation of claim 1, further comprising:
receiving, by the one or more processors, an indication of an event within a threshold range of the first invitee device and the second invitee device; and
transmitting, by the one or more processors, a recommendation associated with the event to one or more of the first invitee device or the second invitee device.

5. The computer-implemented method for linking devices and protecting data during group navigation of claim 4, further comprising:
in response at least to the second invitee device being associated with the first invitee device, presenting, by the one or more processors, for display on the first invitee device, a location of the second invitee device based at least on the environmental data.

6. The computer-implemented method for linking devices and protecting data during group navigation method of claim 1, wherein the action comprises:
transmitting, by the one or more processors to the first invitee device and the second invitee device, instructions to display on a user device, an emergency evacuation route based at least in part on the environmental data.

7. The computer-implemented method for linking devices and protecting data during group navigation method of claim 1, further comprising:
providing, by the one or more processors, the link up request to the first invitee device based at least in part on a first location of the first invitee device satisfying a geographical threshold.

8. The computer-implemented method for linking devices and protecting data during group navigation method of claim 1, wherein the action comprises:
based at least in part on the environmental data, transmitting, by the one or more processors, an electronic message to the first invitee device, wherein the electronic message includes content configured to facilitate an adjustment of a navigation flow of the plurality of invitee devices within a geographical range.

9. The computer-implemented method for linking devices and protecting data during group navigation method of claim 8, wherein the content comprises one or more of an offer, a notification, or a navigational route.

10. A computer-implemented method for linking devices and protecting data during group navigation, the computer-implemented method comprising:
receiving, by one or more processors from an inviter device, a link up request associated with a link up location;
establishing, by the one or more processors, one or more data channels with the inviter device;
providing, by the one or more processors via one or more data channels, the link up request to a plurality of invitee devices, the link up request comprising the link up location;
in response to receiving a first acceptance of the link up request from a first invitee device of the plurality of invitee devices, linking, by the one or more processors, the inviter device and the first invitee device;
generating and presenting, by the one or more processors to the first invitee device via a first graphical user interface (GUI) of an application, a first proposed route to the link up location, wherein the first proposed route is based on a first geographic location of the first invitee device;
in response to receiving a second acceptance of the link up request from a second invitee device of the plurality of invitee devices, linking, by the one or more processors, the inviter device and the second invitee device;
generating and presenting, by the one or more processors to the second invitee device via a second GUI of the application, a second proposed route to the link up location, wherein the second proposed route is based on a second geographic location of the second invitee device;
collecting, by the one or more processors, environmental data of the plurality of invitee devices; and
executing, by the one or more processors, an action based at least in part on the environmental data from the plurality of invitee devices.

11. The computer-implemented method for linking devices and protecting data during group navigation of claim 10, further comprising:
providing, by the one or more processors, a first location of the first invitee device and a second location of the second invitee device to the inviter device based on the environmental data via a third GUI of the application.

12. The computer-implemented method for linking devices and protecting data during group navigation of claim 10, further comprising:
receiving, by the one or more processors from the inviter device, a privacy request to anonymize invitee data of the first invitee device or the second invitee device such that personally identifiable information of the first invitee device or the second invitee device are anonymized.

13. The computer-implemented method for linking devices and protecting data during group navigation of claim 10, further comprising:
transmitting, by the one or more processors to one or more of the first invitee device or the second invitee device, an electronic message associated with a geographical location within a range of the first proposed route or the second proposed route, based at least in part on the environmental data.

14. The computer-implemented method for linking devices and protecting data during group navigation of claim 13, wherein the electronic message comprises directed content sponsored by an entity, wherein the entity is associated with the inviter device.

15. The computer-implemented method for linking devices and protecting data during group navigation of claim 10, further comprising:
receiving, by the one or more processors, navigation data associated with one or more of the first proposed route or the second proposed route, wherein the navigation data comprises at least traffic data;
updating, by the one or more processors, one or more of the first proposed route or the second proposed route based at least in part on the navigation data;
transmitting, by the one or more processors, the updated first proposed route to the first invitee device or the updated second proposed route to the second invitee device;
predicting, by the one or more processors, an estimated arrival time to the link up location of one or more of the first invitee device or the second invitee device based at least in part on the updated first proposed route or the updated second proposed route; and
generating, by the one or more processors, a recommendation receivable by the inviter device to delay an event associated with the link up location based at least in part on the estimated arrival time to the link up location of the one or more of the first invitee device or the second invitee device.

16. A computer-implemented method for linking devices and protecting data during group navigation, the computer-implemented method comprising:
receiving, by one or more processors from an organizer device, a link up request associated with a link up location;
establishing, by the one or more processors, one or more data channels with the organizer device;
providing, by the one or more processors, the link up request to each of a plurality of invitee devices, the link up request comprising the link up location;
in response to receiving a first acceptance of the link up request from a first invitee device of the plurality of invitee devices, linking, by the one or more processors, the organizer device and the first invitee device;
generating and presenting, by the one or more processors to the first invitee device via a first graphical user interface (GUI) of an application, a first proposed route to the link up location, wherein the first proposed route is based on a first geographic location of the first invitee device;
in response to receiving a second acceptance of the link up request from a second invitee device of the plurality of invitee devices, linking, by the one or more processors, the organizer device and the second invitee device;
generating and presenting, by the one or more processors to the second invitee device via a second GUI of the application, a second proposed route to the link up location, wherein the second proposed route is based on a second geographic location of the second invitee device;
collecting, by the one or more processors, environmental data of one or more of the organizer device and one or more of the plurality of invitee devices; and
executing, by the one or more processors, an action based at least in part on the environmental data of the one or more of the organizer device and one or more of the plurality of invitee devices.

17. The computer-implemented method for linking devices and protecting data during group navigation of claim 16, further comprising:
predicting, by the one or more processors, an estimated arrival time to the link up location of one or more of the organizer device, the first invitee device, or the second invitee device based at least in part on the environmental data;
transmitting, by the one or more processors, to at least one of the organizer device, the first invitee device, or the second invitee device, the estimated arrival time; and
in response to at least the estimated arrival time satisfying a threshold, automatically updating, by the one or more processors, a reservation based at least on the estimated arrival time.

18. The computer-implemented method for linking devices and protecting data during group navigation of claim 16, further comprising:
receiving, by the one or more processors, historical environmental data of the plurality of invitee devices;
generating, by the one or more processors, a recommendation for the plurality of invitee devices based at least in part on the historical environmental data and the link up location; and
transmitting, by the one or more processors, the recommendation to at least one of the organizer device or one or more of the plurality of invitee devices.

19. The computer-implemented method for linking devices and protecting data during group navigation of claim 18, further comprising:
receiving, by the one or more processors from the at least one of the plurality of invitee devices, an acceptance of the recommendation;
updating, by the one or more processors, at least one of the first proposed route or the second proposed route to include navigation to a location associated with the recommendation; and
transmitting, by the one or more processors, the updated first proposed route to the first invitee device or the updated second proposed route to the second invitee device.

20. The computer-implemented method for linking devices and protecting data during group navigation of claim 16, further comprising:
predicting, by the one or more processors, the first proposed route at a link up time based at least in part on historical traffic conditions, wherein the link up request is scheduled for the link up time.
